(19) United States
(12) Patent Application Publication
(10) Pub. No.: US 2026/0249804 A1
(43) Pub. Date: Aug. 27, 2026

(54) COMPONENT FOR VEHICLE INTERIOR

(71) Applicant: Yanfeng International Automotive Technology Co. Ltd., Novi, MI (US)

(72) Inventors: Jennifer A. Stroebe, Holland, MI (US); Dale Todd Glynn, Holland, MI (US); Michael Gerard Zimmer, Holland, MI (US); Michael E. Phillips, Holland, MI (US)

(21) Appl. No.: 19/647,875

(22) Filed: Apr. 15, 2026

Related U.S. Application Data
(63) Continuation-in-part of application No. 18/981,375, filed on Dec. 13, 2024.
Application No. 18/981,375 is a continuation of application No. PCT/US2023/027262, filed on Jul. 10, 2023.
(60) Provisional application No. 63/368,115, filed on Jul. 11, 2022.
(60) Provisional application No. 63/427,088, filed on Nov. 21, 2022.

(51) Int. Cl. B60R 21/215; B60R 21/205

(52) U.S. Cl. CPC B60R 21/215; B60R 21/205

(57) ABSTRACT

A component for a vehicle interior configured to facilitate deployment of an airbag is disclosed. The component comprises a structural substrate comprising a fiber panel comprising a base area and weakened area; the weakened area comprises a recess comprising a profile configured to direct the formation of an opening for deployment of the airbag door; the body of fibers of the fiber panel comprises a generally aligned/laterally aligned arrangement of fibers at/across the weakened area. The generally aligned arrangement of fibers across the weakened area is configured to enhance structural rigidity for the composite structure at the weakened area. The structural substrate of the composite structure is formed by compression forming of the fiber panel; the generally laterally aligned arrangement of fibers across the weakened area is maintained during compression forming of the fiber panel into the structural substrate. The profile may comprise a variable shape/form (e.g. depth, width, etc.).

### CROSS-REFERENCE TO RELATED APPLICATIONS

The present application is a continuation-in-part of U.S. Utility patent application Ser. No. 18/981,375 titled “COMPONENT FOR VEHICLE INTERIOR” filed Dec. 13, 2024, which is a continuation of PCT/International Patent Application No. PCT/US2023/027262 titled “COMPONENT FOR VEHICLE INTERIOR” filed Jul. 10, 2023, which claims priority to U.S. Provisional Patent Application No. 63/368,115 titled “COMPONENT FOR VEHICLE INTERIOR” filed Jul. 11, 2022, and U.S. Provisional Patent Application No. 63/427,088 titled “COMPONENT FOR VEHICLE INTERIOR” filed Nov. 21, 2022.

The present application claims priority to and incorporates by reference in full the following patent applications: (a) U.S. Provisional Patent Application No. 63/368,115 titled “COMPONENT FOR VEHICLE INTERIOR” filed Jul. 11, 2022; (b) U.S. Provisional Patent Application No. 63/427,088 titled “COMPONENT FOR VEHICLE INTERIOR” filed Nov. 21, 2022; (c) PCT/International Patent Application No. PCT/US2023/027262 titled “COMPONENT FOR VEHICLE INTERIOR” filed Jul. 10, 2023; (d) U.S. Utility patent application Ser. No. 18/981,375 titled “COMPONENT FOR VEHICLE INTERIOR” filed Dec. 13, 2024.

The present application is related to and incorporates by reference in full the following patent applications: (a) PCT/International Patent Application No. PCT/US2012/052534 titled “SYSTEM AND METHOD FOR MANUFACTURING A VEHICLE TRIM COMPONENT VIA CONCURRENT COMPRESSION FORMING AND INJECTION MOLDING” filed Aug. 27, 2012; (b) PCT/International Patent Application No. PCT/US2013/056751 titled “SYSTEM AND METHOD FOR MOUNTING AN AIRBAG CHUTE ASSEMBLY WITHIN A VEHICLE TRIM COMPONENT” filed Aug. 27, 2013; (c) PCT/International Patent Application No. PCT/US2017/038572 titled “TRIM COMPONENT FOR VEHICLE INTERIOR” filed Jun. 21, 2017.

### FIELD

The present invention relates to a component for a vehicle interior.

### BACKGROUND

It is known to provide a component for a vehicle interior configured to facilitate deployment of an airbag through an opening formed as an airbag door in the component.

It would be advantageous to provide an improved component comprising a structural substrate comprising a panel comprising a weakened area such as a recess configured to direct formation of an opening for deployment of the airbag through the component.

It would be advantageous to provide an improved component comprising a structural substrate comprising a panel formed from a fiber panel comprising a body of fibers comprising a weakened area such as a recess configured to direct formation of an opening for deployment of the airbag through the component.

It would be advantageous to provide an improved component comprising a structural substrate comprising a panel formed from a fiber panel comprising a weakened area such as a formed recess configured to direct formation of an opening for deployment of the airbag and comprising a body of fibers comprising a generally aligned arrangement of fibers configured to provide/maintain rigidity for the structural substrate at the weakened area.

### SUMMARY

The present invention relates to a component for a vehicle interior configured to facilitate deployment of an airbag through an airbag door comprising a structural substrate comprising a fiber panel comprising a body of fibers; the fiber panel may comprise a base area and weakened area for the structural substrate; the weakened area may comprise a recess comprising a profile; the profile of the recess may comprise a bottom and a set of walls; the structural substrate may comprise a reduced thickness in the recess at the bottom of the profile; the profile of the recess may be configured to direct the formation of the airbag door at the weakened area in the structural substrate during deployment of the airbag; the body of fibers of the fiber panel comprising the structural substrate may comprise a generally aligned arrangement of fibers; the generally aligned arrangement of fibers may be provided at the weakened area of the structural substrate. The generally aligned arrangement of fibers may comprise a generally laterally aligned arrangement of fibers across the weakened area of the structural substrate of the composite structure; the generally laterally aligned arrangement of fibers across the weakened area may be configured to enhance structural rigidity for the composite structure at the weakened area of the structural substrate of the composite structure; the structural substrate of the composite structure may be formed by compression forming of the fiber panel; the generally laterally aligned arrangement of fibers across the weakened area may be maintained during compression forming of the fiber panel into the structural substrate of the composite structure; the fiber panel may be formed from a fiber mat comprising the body of generally aligned fibers to provide the fiber panel with the body of generally aligned fibers; the fiber panel may be compression-formed into a compression-formed panel with the recess comprising a formed recess maintaining the body of generally aligned fibers in the compression-formed panel; the structural substrate may comprise the compression-formed panel with the recess and the body of generally aligned fibers across the compression-formed panel including at the recess to provide enhanced rigidity for the structural substrate; the structural substrate comprising the fiber panel may comprise an inner surface and an outer surface; the recess comprising the profile may be formed into the inner surface of the fiber panel; the recess may be configured to form a seam for an opening through the weakened area of the fiber panel for the airbag door; the profile may comprise a multi-side form; the multi-side form may comprise the bottom and the set of side walls; the multi-side form may comprise a generally trapezoidal form; the profile may comprise a variable depth and a transition area; the transition area may comprise a thickness greater than a nominal thickness of the base area of the fiber panel; the structural substrate may comprise a compression-formed fiber panel; the fiber panel of the structural substrate may comprise a nominal average thickness in the base area and the reduced thickness at the weakened area; the recess for the weakened area may comprise a center recess and a set of lateral recesses; the weakened area may comprise the set of lateral recesses connected by the center recess; the center recess may comprise a connector; the weakened area may comprise a set of segments; the recess may comprise a formed recess and/or an indentation and/or a groove and/or a groove formed in the fiber panel; the profile may comprise a multi-segmented form and/or the profile may be formed to provide the weakened area in the fiber panel; the component may further comprise a structure formed on the fiber panel of the structural substrate; the structure may comprise an injection-molded resin; the structure may comprise a reinforcement at the weakened area of the fiber panel.

The present invention relates to a component for a vehicle interior configured to facilitate deployment of an airbag through an airbag door comprising a structural substrate comprising a fiber panel comprising a base area and weakened area; the weakened area may comprise a recess comprising a multi-sided profile; the multi-sided profile of the recess may comprise a bottom and a set of walls; the fiber panel may have a reduced thickness in the recess at the bottom of the profile; the profile of the recess may be configured to direct the formation of the airbag door at the weakened area of the fiber panel during deployment of the airbag through the fiber panel; the structural substrate comprising the fiber panel may comprise a body of fibers; the body of fibers of the structural substrate may comprise a generally aligned arrangement of fibers; the generally aligned arrangement of fibers may be provided at the weakened area of the structural substrate. The component may further comprise a composite structure comprising the structural substrate and a cover on the structural substrate; the weakened area may comprise a generally H-shaped area and/or a generally U-shaped area; the composite structure may comprise a structure formed onto the fiber panel; the structure may comprise an injection-molded resin; the structure may be provided adjacent to the weakened area and configured to direct the formation of the airbag door.

The present invention relates to a component for a vehicle interior configured to facilitate deployment of an airbag through an airbag door comprising a composite structure comprising a structural substrate comprising a fiber panel comprising a body of fibers; the fiber panel may comprise a base area and weakened area for the structural substrate; the weakened area may comprise a recess comprising a profile; the profile of the recess may comprise a bottom and a set of walls; the structural substrate may comprise a reduced thickness in the recess at the bottom of the profile; the profile of the recess may be configured to direct the formation of the airbag door at the weakened area in the structural substrate during deployment of the airbag; the body of fibers of the fiber panel of the structural substrate of the composite structure may comprise a generally aligned arrangement of fibers; the generally aligned arrangement of fibers may be provided at the weakened area of the structural substrate of the composite structure. The generally aligned arrangement of fibers may comprise a generally laterally aligned arrangement of fibers across the weakened area of the structural substrate of the composite structure; the generally laterally aligned arrangement of fibers across the weakened area may be configured to enhance structural rigidity for the composite structure at the weakened area of the structural substrate of the composite structure; the structural substrate of the composite structure may be formed by compression forming of the fiber panel; the generally laterally aligned arrangement of fibers across the weakened area may be maintained during compression forming of the fiber panel into the structural substrate of the composite structure; the fiber panel may be formed from a fiber mat with the body of generally aligned fibers to provide the fiber panel with the body of generally aligned fibers; the fiber panel may be compression-formed into a compression-formed panel with the recess comprising a formed recess maintaining the body of generally aligned fibers in the panel; the structural substrate may comprise the compression-formed panel with the recess and the body of generally aligned fibers across the compression-formed panel including at the recess to provide enhanced rigidity for the structural substrate; the composite structure may comprise a cover on the structural substrate; the component may further comprise a structure formed on the fiber panel of the structural substrate; the structure may comprise an injection-molded resin; the structure may comprise a reinforcement at the weakened area of the fiber panel; the set of ribs may be configured to direct the formation of the airbag door; the component may further comprise at least one of a trim panel, an instrument panel, a door panel, a pillar, a panel, etc.

The present invention relates to a component for a vehicle interior configured to facilitate deployment of an airbag through an airbag door comprising a structural substrate comprising a fiber panel and a structure comprising an injection-molded resin formed on the fiber panel; the structural substrate comprising the fiber panel may comprise a base area and a weakened area; the weakened area may comprise a recess comprising a profile; the structural substrate comprising the fiber panel may have a reduced thickness in the recess of the profile; the profile of the recess may be configured to direct the formation of the airbag door at the weakened area of the structural substrate comprising the fiber panel during deployment of the airbag; the recess of the weakened area may comprise a generally varying form formed to provide the weakened area in the structural substrate comprising the fiber panel; the structure may be provided at the weakened area of the structural substrate comprising the fiber panel and configured to direct the formation of the airbag door; the structural substrate comprising the fiber panel may comprise an inner surface and an outer surface; the recess comprising the profile may be formed into the inner surface of the fiber panel and the structure may be formed onto the inner surface of the fiber panel; the recess may comprise a transition section and a sidewall and a bottom; material of the fiber panel may comprise a body of fibers; the body of fibers of the structural substrate may comprise a generally aligned arrangement of fibers; the generally aligned arrangement of fibers may be provided at the weakened area of the structural substrate; material of the structure may comprise resin; material of the structure and material of the fiber panel form an interface comprising intermixing of material of the structure with material of the fiber panel; forming of the structure on the fiber panel may comprise irregularities at the interface; irregularities at the interface may comprise intermixing of fibers of the fiber panel into resin of the structure at the interface. The structure may comprise a framework comprising a reinforcement formed on the fiber panel; the recess comprising the profile may be formed into the inner surface of the fiber panel as the structure comprising the set of ribs may be formed onto the inner surface of the fiber panel; the recess may be configured to form a seam for an opening through the weakened area of the fiber panel for the airbag door; the profile may comprise a curved form; injection-molded resin of the structure comprising injection-molded resin may be configured to mix with fibers of the fiber panel; injection-molded resin of the structure comprising injection-molded resin may be formed into the fiber panel; the profile may comprise a variable depth; the profile may comprise a transition area at the transition section of the recess; the transition area may comprise a thickness less than a nominal thickness of the base area of the fiber panel; the fiber panel may have a nominal average thickness in the base area and the reduced thickness at the weakened area; the recess for the weakened area may comprise a center recess; the weakened area may comprise the recess between the set of ribs comprising the structure comprising injection-molded resin on the fiber panel; the recess may comprise a formed recess and/or an indentation; the recess may comprise a groove; the groove may be formed in the fiber panel; the generally varying form of the recess of the weakened area of the fiber panel may comprise a wavy line; the set of ribs at the weakened area of the fiber panel may comprise a generally varying form comprising a wavy line; the weakened area may comprise a generally H-shaped area and/or a generally U-shaped area.

The present invention relates to a component for a vehicle interior configured to facilitate deployment of an airbag through an airbag door comprising a fiber panel comprising a base area and a weakened area, and a structure formed on the fiber panel; the structure may comprise a molded resin; the weakened area may comprise a recess; the fiber panel may have a reduced thickness in the recess at the bottom of the profile; the profile of the recess may be configured to direct the formation of the airbag door at the weakened area of the fiber panel during deployment of the airbag through the fiber panel; the recess of the weakened area may comprise a generally varying form formed to provide the weakened area in the fiber panel; the structure may comprise a set of ribs at the weakened area of the fiber panel configured to direct the formation of the airbag door; the fiber panel may comprise an inner surface and an outer surface; the recess comprising the profile may be formed into the inner surface of the fiber panel and the structure comprising the set of ribs may be formed onto the inner surface of the fiber panel; material of the fiber panel may comprise a body of fibers; the body of fibers of the fiber panel may comprise a generally aligned arrangement of fibers; the generally aligned arrangement of fibers may be provided at the weakened area of the fiber panel; material of the structure may comprise resin; material of the structure and material of the fiber panel form an interface comprising intermixing of material of the structure with material of the fiber panel; forming of the structure on the fiber panel may comprise irregularities at the interface; irregularities at the interface may comprise intermixing of fibers of the fiber panel into resin of the structure at the interface. The component may further comprise a cover on the fiber panel; the structure may comprise an injection-molded resin; the set of ribs at the weakened area of the fiber panel may comprise the varying form of the recess of the weakened area of the fiber panel; the component may further comprise a structure formed on the fiber panel; the structure may comprise an injection-molded resin; the structure may comprise a set of ribs at the weakened area of the fiber panel; the set of ribs may be configured to direct the formation of the airbag door.

The present invention relates to a component for a vehicle interior configured to facilitate deployment of an airbag through an airbag door comprising a structural substrate comprising a fiber panel; the fiber panel may comprise a base area and weakened area; the weakened area may comprise a recess comprising a profile; the profile of the recess may comprise a bottom and a set of walls; the fiber panel has a reduced thickness in the recess at the bottom of the profile; the profile of the recess is configured to direct the formation of the airbag door at the weakened area of the fiber panel during deployment of the airbag. The fiber panel may comprise an inner surface and an outer surface; the recess comprising the profile is formed into the inner surface of the fiber panel; the recess is configured to form a seam for an opening through the weakened area of the fiber panel for the airbag door. The profile may comprise a multi-side form. The multi-side form may comprise the bottom and the set of side walls. The multi-side form may comprise a generally trapezoidal form. The profile may comprise a variable depth. The profile may comprise a transition area. The transition area may comprise a thickness greater than a nominal thickness of the base area of the fiber panel. The fiber panel may have a nominal average thickness in the base area and the reduced thickness at the weakened area. The recess for the weakened area may comprise a center recess and a set of lateral recesses; the weakened area may comprise the set of lateral recesses connected by the center recess; the center recess may comprise a connector. The weakened area may comprise a set of segments. The recess may comprise a formed recess and/or an indentation. The recess may comprise a groove; the groove is formed in the fiber panel. The profile may comprise a multi-segmented form and/or the profile is formed to provide the weakened area in the fiber panel. A structure formed on the fiber panel may comprise an injection-molded resin; the structure may comprise a set of ribs at the weakened area of the fiber panel; the set of ribs is configured to direct the formation of the airbag door. The weakened area may comprise a generally H-shaped area and/or a generally U-shaped area. The component may comprise (a) a trim panel; (b) an instrument panel; (c) a door panel; (d) a pillar.

The present invention relates to a component for a vehicle interior configured to facilitate deployment of an airbag through an airbag door comprising a fiber panel comprising a base area and weakened area; the weakened area may comprise a recess comprising a multi-sided profile; the multi-sided profile of the recess may comprise a bottom and a set of walls; the fiber panel has a reduced thickness in the recess at the bottom of the profile; the profile of the recess is configured to direct the formation of the airbag door at the weakened area of the fiber panel during deployment of the airbag through the fiber panel. A component for a vehicle interior configured to facilitate deployment of an airbag through an airbag door may comprise a structural substrate comprising a fiber panel the fiber panel may comprise a base area and weakened area; the weakened area may comprise a recess comprising a profile; the profile of the recess may comprise a bottom and a set of walls; the fiber panel has a reduced thickness in the recess at the bottom of the profile; the profile of the recess is configured to direct the formation of the airbag door at the weakened area of the fiber panel during deployment of the airbag. The fiber panel may comprise an inner surface and an outer surface; the recess comprising the profile is formed into the inner surface of the fiber panel; the recess is configured to form a seam for an opening through the weakened area of the fiber panel for the airbag door. The profile may comprise a multi-side form. The multi-side form may comprise the bottom and the set of side walls. The multi-side form may comprise a generally trapezoidal form. The profile may comprise a variable depth. The profile may comprise a transition area. The transition area may comprise a thickness greater than a nominal thickness of the base area of the fiber panel. The fiber panel may have a nominal average thickness in the base area and the reduced thickness at the weakened area. The recess for the weakened area may comprise a center recess and a set of lateral recesses; the weakened area may comprise the set of lateral recesses connected by the center recess; the center recess may comprise a connector. The weakened area may comprise a set of segments. The recess may comprise a formed recess and/or an indentation. The recess may comprise a groove; the groove may be formed in the fiber panel. The profile may comprise a multi-segmented form and/or the profile is formed to provide the weakened area in the fiber panel. A structure formed on the fiber panel may comprise an injection-molded resin; the structure may comprise a set of ribs at the weakened area of the fiber panel; the set of ribs is configured to direct the formation of the airbag door. The weakened area may comprise a generally H-shaped area and/or a generally U-shaped area. The component may comprise (a) a trim panel; (b) an instrument panel; (c) a door panel; (d) a pillar.

The present invention relates to a component for a vehicle interior configured to facilitate deployment of an airbag through an airbag door comprising a fiber panel comprising a base area and weakened area; the weakened area may comprise a recess comprising a multi-sided profile; the multi-sided profile of the recess may comprise a bottom and a set of walls; the fiber panel has a reduced thickness in the recess at the bottom of the profile; the profile of the recess is configured to direct the formation of the airbag door at the weakened area of the fiber panel during deployment of the airbag through the fiber panel. The component may comprise a cover on the fiber panel. The component may comprise a structure formed onto the fiber panel; the structure may comprise an injection-molded resin; the structure may comprise a set of ribs at the weakened area of the fiber panel; the set of ribs is configured to direct the formation of the airbag door. The component may comprise a structure formed onto the fiber panel; the structure may comprise an injection-molded resin; the structure may comprise a set of ribs at the weakened area of the fiber panel; the set of ribs is configured to direct the formation of the airbag door. The groove may comprise a center groove and a set of lateral grooves; the weakened area may comprise the set of lateral grooves connected by the center groove; the center groove may comprise a connector. The rib may comprise a nominal height of between about 2.5 mm and about 3.5 mm. The rib may comprise a nominal width of between about 1.5 mm and about 2.0 mm. A distance between the set of ribs may comprise a nominal width of between about 5 mm and about 7 mm. The proportional relationship between a nominal reduced thickness at the bottom of the profile of the recess and a nominal width across the profile is in a range of between about 5 and about 12. the proportional relationship between a nominal reduced thickness at the bottom of the profile of the recess and a nominal thickness at the base area is in a range of between about 1.5 and 4; the proportional relationship between a nominal width at the bottom of the profile of the recess and a nominal width across the profile of the recess is in a range of between about 1.5 and about 12; the proportional relationship between a nominal thickness of the base area of the fiber panel and a nominal width across the profile of the recess is in a range of between about 1 and 5; the proportional relationship between a nominal thickness of the base area of the fiber panel and a nominal width across the profile of the recess is greater than 2; the proportional relationship of a nominal reduced thickness at the bottom of the profile of the recess divided by a nominal thickness at the base area is in a range of between about 1.5 and 4. The proportional relationship between a nominal width at the bottom of the profile of the recess and a nominal width across the profile of the recess is in a range of between about 1.5 and about 12; the proportional relationship between a nominal thickness of the base area of the fiber panel and a nominal width across the profile of the recess is in a range of between about 1 and 5; the proportional relationship between a nominal thickness of the base area of the fiber panel and a nominal width across the profile of the recess is greater than 2; the proportional relationship between a nominal width at the bottom of the profile of the recess and a nominal thickness at the bottom of the recess is in a range of about 1 to 2. The proportional relationship between a nominal width at the bottom of the profile of the recess and a nominal thickness at the bottom of the recess is in a range of about 0.5 to 3; the nominal width at the bottom of the profile of the recess is in a range of between about 0.5 and 3 times greater than a nominal thickness at the bottom of the recess; the nominal width across the profile of the recess is in a range of about 1 to 5 times greater than a nominal thickness of the base area of the fiber panel; the nominal thickness of the base area of the fiber panel is in a range of between about 1.5 and 3.5 times greater than a nominal thickness of the bottom of the recess; the nominal thickness of the base area of the fiber panel is in a range of between about 2 and 4 times greater than a nominal width of the bottom of the recess; the nominal width across the profile of the recess is in a range of about 1 to 12 times greater than a nominal thickness of the bottom of the recess; the nominal width of the bottom of the profile of the recess may comprise between about 0.2 mm and 2.0 mm. The reduced thickness at the bottom of the profile may be less than 0.85 mm; the reduced thickness may be greater than 0.4 mm; the fiber panel may comprise a thickness may be greater than about 1 mm; the nominal thickness at the base area may be less than 1.7 mm; the thickness may be greater than 1.5 mm. The component may comprise (a) a trim panel; (b) an instrument panel; (c) a door panel; (d) a pillar.

The present invention relates to a component for a vehicle interior configured to facilitate deployment of an airbag through an airbag door comprising a structural substrate comprising a fiber panel. The fiber panel may comprise a base area and weakened area. The weakened area may comprise a recess comprising a profile. The profile of the recess may comprise a bottom and a set of walls. The fiber panel has a reduced thickness in the recess at the bottom of the profile. The profile of the recess may be configured to direct the formation of the airbag door at the weakened area of the fiber panel during deployment of the airbag. The weakened area may comprise a generally H-shaped area. The weakened area may comprise a generally U-shaped area. The fiber panel may comprise an inner surface and an outer surface; the recess comprising the profile may be formed into the inner surface of the fiber panel. The recess may be configured to form a seam for an opening through the weakened area of the fiber panel for the airbag door. The profile may comprise a multi-side form. The multi-side form may comprise the bottom and the set of side walls. The multi-side form may comprise a generally trapezoidal form. The profile may comprise a variable depth. The profile may comprise a transition area. The transition area may comprise a transition into the profile. The transition area may comprise a transition into a generally trapezoidal section of the profile. The transition area may comprise a generally curved form. The transition area may comprise a feature formed adjacent to the recess; the feature may comprise a ridge segment. The transition area may comprise a thickness less than a nominal thickness of the base area of the fiber panel. The transition area may comprise a thickness greater than a nominal thickness of the base area of the fiber panel. The fiber panel may have a nominal average thickness in the base area and the reduced thickness at the weakened area. The recess for the weakened area may comprise a center recess and a set of lateral recesses; the weakened area may comprise the set of lateral recesses connected by the center recess; the center recess may comprise a connector. The weakened area may comprise a set of segments. The set of segments may comprise a set of lateral segments connected by a center line. The recess may comprise a formed recess. The recess may comprise an indentation. The recess may comprise a groove; the groove may be formed in the fiber panel. The groove may comprise a center groove and a set of lateral grooves; the weakened area may comprise the set of lateral grooves connected by the center groove; the center groove may comprise a connector. The profile may comprise a transition area into the groove. The groove may comprise a wavy line. The bottom may comprise a generally flat bottom. The set of walls may comprise a set of flat tapered walls adjacent to the bottom. The profile may comprise a generally curved form. The profile may comprise a rounded form comprising the bottom and a set of walls adjacent to the bottom. The profile may comprise a multi-segmented form. The profile may comprise a transition area from the base area into the weakened area. The profile may be formed to provide the weakened area in the fiber panel. The component may comprise a structure formed on the fiber panel; the structure may comprise an injection-molded resin; the structure may comprise a set of ribs at the weakened area of the fiber panel; the set of ribs may be configured to direct the formation of the airbag door. Fiber of the fiber panel may be at least partially intermingled with the resin of the structure. The fiber panel may comprise a compression-formed fiber panel. The component may comprise a panel comprising the fiber panel; the panel may comprise at least one of (a) a resin; (b) a thermoplastic resin; (c) at least one of (a) a tear line configured to establish an opening for deployment of the airbag; (b) a weakening line configured to establish an opening for deployment of the airbag. The component may comprise a cover on the fiber panel; the weakened area may not be generally visible at the cover. The reduced thickness at the bottom of the profile of the recess may comprise between above 0.4 mm and below 0.85 mm. A nominal width of the bottom of the profile of the recess may comprise between about 0.4 mm and 0.6 mm. A nominal width of the bottom of the profile of the recess may comprise between about 0.2 mm and 2.0 mm. The recess may comprise a width across the profile; the width across the profile may comprise between about 5 mm and about 6 mm. The recess may comprise a width across the profile; the width across the profile may comprise greater than 2 mm. The fiber panel may comprise a nominal thickness at the base area of between about 1.5 mm and 1.7 mm. The component may comprise a structure formed onto the fiber panel; the structure may comprise at least one rib; the at least one rib may comprise a set of ribs at the weakened area of the fiber panel. The at least one rib may comprise a nominal height of between about 2.5 mm and about 3.5 mm. The at least one rib may comprise a nominal width of between about 1.5 mm and about 2.0 mm. A distance between the set of ribs may comprise a nominal width of between about 5 mm and about 7 mm. A proportional relationship between a nominal reduced thickness at the bottom of the profile of the recess and a nominal width across the profile may be in a range of between about 5 and about 12. A proportional relationship between a nominal reduced thickness at the bottom of the profile of the recess and a nominal thickness at the base area may be in a range of between about 1.5 and 4. A proportional relationship between a nominal width at the bottom of the profile of the recess and a nominal width across the profile of the recess may be in a range of between about 1.5 and about 12. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be greater than 2. A proportional relationship of a nominal reduced thickness at the bottom of the profile of the recess divided by a nominal thickness at the base area may be in a range of between about 1.5 and 4. A proportional relationship between a nominal width at the bottom of the profile of the recess and a nominal width across the profile of the recess may be in a range of between about 1.5 and about 12. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be greater than 2. A proportional relationship between a nominal width at the bottom of the profile of the recess and a nominal thickness at the bottom of the recess may be in a range of about 1 to 2. A proportional relationship between a nominal width at the bottom of the profile of the recess and a nominal thickness at the bottom of the recess may be in a range of about 0.5 to 3. A nominal width at the bottom of the profile of the recess may be in a range of between about 0.5 and 3 times greater than a nominal thickness at the bottom of the recess. A nominal width across the profile of the recess may be in a range of about 1 to 5 times greater than a nominal thickness of the base area of the fiber panel. A nominal thickness of the base area of the fiber panel may be in a range of between about 1.5 and 3.5 times greater than a nominal thickness of the bottom of the recess. A nominal thickness of the base area of the fiber panel may be in a range of between about 2 and 4 times greater than a nominal width of the bottom of the recess. A nominal width across the profile of the recess may be in a range of about 1 to 12 times greater than a nominal thickness of the bottom of the recess. A nominal width of the bottom of the profile of the recess may comprise between about 0.2 mm and 2.0 mm. The component may comprise at least one of (a) a trim panel; (b) an instrument panel; (c) a door panel; (d) a pillar.

The present invention relates to a component for a vehicle interior configured to facilitate deployment of an airbag through an airbag door comprising a fiber panel comprising a base area and weakened area. The weakened area may comprise a recess comprising a multi-sided profile. The multi-sided profile of the recess may comprise a bottom and a set of walls. The fiber panel has a reduced thickness in the recess at the bottom of the profile. The profile of the recess may be configured to direct the formation of the airbag door at the weakened area of the fiber panel during deployment of the airbag through the fiber panel. The component may comprise a cover on the fiber panel. The component may comprise a structure formed onto the fiber panel; the structure may comprise an injection-molded resin. The structure may comprise a set of ribs at the weakened area of the fiber panel; the set of ribs may be configured to direct the formation of the airbag door.

The present invention relates to a component for a vehicle interior configured to facilitate deployment of an airbag comprising a panel comprising fibers. The panel may comprise a front side providing a surface and a rear side configured for contact from the airbag to establish an opening for deployment of the airbag. The panel may comprise a recess in the rear side of the panel to establish the opening for deployment of the airbag and direct deployment of the airbag through the panel. The front side of the panel may comprise a substantially planar surface opposite the recess. The panel comprising fibers may comprise a compressed fiber panel; the recess may be formed as a depression in the rear side of the panel or an indentation in the rear side of the panel. The recess may be formed in a mold by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side. The recess may comprise a path comprising at least one of (a) a continuous wave portion comprising a periodic function; (b) a sinusoidal shape. The panel may comprise at least one of (a) a resin; (b) a thermoplastic resin; (c) polypropylene; (d) acrylonitrile butadiene styrene; (e) polycarbonate. The panel may comprise a resin rib formed on the panel adjacent the recess at the rear side of the panel; the resin rib may be configured to direct deployment of the airbag through the panel. The resin rib may extend from the recess below the rear side of the panel. The recess may comprise a path comprising a connector between generally parallel segments; the connector may comprise a generally sinusoidal shape; the panel may comprise a rib adjacent the connector of the recess at the rear side of the panel; the rib may comprise a generally sinusoidal shape. The rib may comprise a first rib on a side of the connector and a second rib on an opposite side of the connector. The recess may comprise a cavity comprising a cross-sectional profile; the cross-sectional profile of the cavity may comprise a depth within the panel. The cross-sectional profile of the cavity may comprise a set of facets; the set of facets may comprise a first set of connected facets opposite a second set of connected facets. The set of facets may comprise a floor facet connecting the first set of connected facets and the second set of connected facets; the floor facet may comprise a surface generally parallel to the front side of the panel. The cross-sectional profile of cavity may comprise at least one of (a) a bevel; (b) a fillet; (c) a chamfer. The cross-sectional profile of the cavity may comprise a wall and a floor; the floor may be generally parallel to the surface of the front side of the panel. The cross-sectional profile of cavity may comprise at least one angled surface connecting the wall and the floor. The wall may comprise at least two generally planar surfaces. The wall may comprise a first surface and a second surface; the second surface may extend from the floor to the first surface; the first surface may extend from the second surface to the rear side of the panel. The wall may comprise a first generally planar wall connected to a second generally planar wall at a radius. The recess may comprise a width at the rear side of the panel; the floor may comprise a width less than the width of the recess at the rear side of the panel.

The present invention relates to a component for a vehicle interior configured to facilitate deployment of an airbag and comprising a panel comprising fibers. The panel may comprise a front side providing a surface and a rear side configured for contact from the airbag to establish an opening for deployment of the airbag. The panel may comprise a recess formed as a depression in the rear side of the panel to establish the opening for deployment of the airbag and direct deployment of the airbag through the panel. The front side of the panel may comprise a substantially planar surface opposite the recess. The recess may be formed as an indentation in the rear side of the panel; the recess may comprise a depth within the panel. The recess may comprise a set of facets; the set of facets may comprise a floor facet connecting a first set of connected facets and a second set of connected facets; the floor facet may comprise a surface generally parallel to the front side of the panel. The recess may comprise a wall and a floor and at least one angled surface connecting the wall and the floor.

The present invention relates to a vehicle interior component formed in a mold and configured to facilitate deployment of an airbag from an airbag module comprising a panel comprising a fiber panel. The fiber panel may comprise a base area and weakened area. The weakened area may comprise a recess. The recess may comprise a multi-sided profile. The multi-sided profile of the recess may comprise a bottom and a set of walls. The fiber panel has a reduced thickness in the recess at the bottom of the profile. The profile of the recess may be configured to direct the formation of the airbag door at the weakened area of the fiber panel during deployment of the airbag through the fiber panel. The recess may be formed by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side; and (c) filling a depression of the mold with material of the fiber panel to form a protrusion at the rear side. The panel may comprise at least one of (a) a resin; (b) a thermoplastic resin; (c) polypropylene; (d) acrylonitrile butadiene styrene; (e) polycarbonate. The recess may comprise a notch configured to direct deployment of the airbag through the panel. The feature may comprise a protrusion configured to provide a relief for the notch.

The present invention relates to a method of manufacturing a vehicle interior component comprising (a) providing a mold comprising a first surface and a second surface comprising a protrusion and a depression; (b) disposing a fiber panel comprising a first side and a second side onto the first surface of a mold; (c) compressing at least a first portion of the fiber panel between the first surface and the second surface of the mold; (d) penetrating material of the fiber panel at the first side of the panel with the protrusion of the second surface of the mold to push material of the fiber panel aside to form a notch in the first side of the fiber panel and maintain a continuous surface at the second side of the fiber panel; and (e) filling the depression of the second surface of the mold with material of the fiber panel to form a protrusion at the first side of the fiber panel. The fiber panel may comprise a base area and weakened area. The weakened area may comprise the notch. The notch may comprise a recess. The recess may comprise a multi-sided profile. The multi-sided profile of the recess may comprise a bottom and a set of walls. The fiber panel has a reduced thickness in the recess at the bottom of the profile. The profile of the recess may be configured to direct the formation of the airbag door at the weakened area of the fiber panel during deployment of the airbag through the fiber panel. The method may comprise a step of injecting resin into the mold at the depression of the second surface of the mold to form a rib.

The present invention relates to a component for a vehicle interior configured to facilitate deployment of an airbag and comprising a panel comprising fibers. The panel may comprise a front side providing a surface and a rear side configured for contact from the airbag to establish an opening for deployment of the airbag. The panel may comprise a recess formed as a depression in the rear side of the panel to establish the opening for deployment of the airbag and direct deployment of the airbag through the panel. The front side of the panel may comprise a substantially planar surface opposite the recess. The recess may be formed as an indentation in the rear side of the panel. The recess may be formed in a mold by compressing at least a first portion of the fiber panel between a first surface and a second surface of the mold, and penetrating material of the fiber panel at the rear side with a protrusion of the mold to push material of the fiber panel aside to form the recess in the rear side and maintain a continuous surface at the front side. The recess may comprise a generally H-shaped arrangement comprising a connector between generally parallel segments; the connector may comprise a generally sinusoidal shape. The recess may comprise a generally U-shaped arrangement comprising a connector between generally parallel segments; the connector may comprise a generally sinusoidal shape. The recess may comprise a path comprising a continuous wave portion comprising a periodic function. The recess may comprise a path comprising a sinusoidal shape. The panel may comprise at least one of a resin; a thermoplastic resin; polypropylene; acrylonitrile butadiene styrene; polycarbonate. The panel may comprise a rib adjacent the recess at the rear side of the panel. The rib may be configured to direct deployment of the airbag through the panel. The rib may be formed on the panel. The rib may comprise a resin material. The rib may extend from the recess. The rib may comprise a height below the rear side of the panel; the recess may comprise a cavity in the panel comprising a depth. The recess may comprise a path comprising a connector between generally parallel segments; the connector may comprise a generally sinusoidal shape; the panel may comprise a rib adjacent the connector of the recess at the rear side of the panel; the rib may comprise a generally sinusoidal shape. The component may comprise a first rib on a side of the connector and a second rib on an opposite side of the connector. The rib may comprise a resin material and the rib may extend from the recess. The recess may comprise a cavity comprising a cross-sectional profile. The profile of the cavity may comprise a depth within the panel. The profile of the cavity may comprise a set of facets. The set of facets may comprise a first set of connected facets opposite a second set of connected facets. The set of facets may comprise a floor facet connecting the first set of connected facets and the second set of connected facets. The floor facet may comprise a surface generally parallel to the front side of the panel. The profile of the cavity may comprise an angled surface. The profile of the cavity may comprise a multi-faceted shape. The profile of cavity may comprise at least one of (a) a bevel; (b) a fillet; (c) a chamfer. The profile of the cavity may comprise a wall and a floor. The profile of cavity may comprise at least one angled surface connecting the wall and the floor. The floor may be generally parallel to the surface of the front side of the panel. The wall may comprise at least two generally planar surfaces. The wall may comprise a first surface and a second surface; the second surface may extend from the floor to the first surface. The first surface may extend from the second surface to the rear side of the panel. The wall may comprise a first generally planar wall connected to a second generally planar wall. The recess may comprise a width at the rear side of the panel; the floor may comprise a width less than the width of the recess at the rear side of the panel. The recess may comprise at least one of (a) a tear line configured to establish an opening for deployment of the airbag; (b) a weakening line configured to establish an opening for deployment of the airbag. The component may comprise at least one of (a) a trim panel; (b) an instrument panel; (c) a door panel; (d) a pillar.

The present invention also relates to a method of manufacturing the component may comprise providing a mold comprising a first surface and a second surface comprising a protrusion, disposing a fiber panel comprising a first side and a second side onto the first surface of a mold, compressing at least a first portion of the fiber panel between the first surface and the second surface of the mold, and penetrating material of the fiber panel at the first side of the panel with the protrusion of the second surface of the mold to push material of the fiber panel aside to form the recess in the first side of the fiber panel and maintain a continuous surface at the second side of the fiber panel. The method may comprise a step of injecting resin into the mold at a depression of the second surface of the mold to form a rib. The recess may be configured to establish an opening in the vehicle interior component for deployment of an airbag through the vehicle interior component.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIG. 2A is a schematic perspective view of a component for a vehicle interior shown as an instrument panel according to an exemplary embodiment.

FIG. 2B is a schematic partial perspective view of a component for a vehicle interior shown as an instrument panel according to an exemplary embodiment.

FIG. 2C is a schematic partial perspective view of a component for a vehicle interior shown as an instrument panel according to an exemplary embodiment.

FIGS. 3A and 3B are schematic partial section views of an airbag deployment according to an exemplary embodiment.

FIGS. 4A-4C are schematic partial perspective views of an airbag deployment according to an exemplary embodiment.

FIGS. 4D-4F are schematic partial perspective views of an airbag deployment according to an exemplary embodiment.

FIGS. 4G-4I are schematic partial perspective views of an airbag deployment according to an exemplary embodiment.

FIGS. 4J-4L are schematic partial perspective views of an airbag deployment according to an exemplary embodiment.

FIG. 5A is a schematic perspective view of a component for a vehicle interior shown as an instrument panel according to an exemplary embodiment.

FIG. 5B is a schematic section view of a component for a vehicle interior shown as an instrument panel according to an exemplary embodiment.

FIG. 5C is a schematic partial section perspective view of a component for a vehicle interior shown as an instrument panel according to an exemplary embodiment.

FIG. 5D is a schematic partial section view of a component for a vehicle interior shown as an instrument panel according to an exemplary embodiment.

FIG. 6A is a schematic perspective view of a component for a vehicle interior shown as an instrument panel according to an exemplary embodiment.

FIG. 6B is a schematic exploded perspective view of a component for a vehicle interior shown as an instrument panel according to an exemplary embodiment.

FIG. 6C is a schematic section view of a component for a vehicle interior shown as an instrument panel according to an exemplary embodiment.

FIG. 7A is a schematic perspective view of a fiber mat according to an exemplary embodiment.

FIG. 7B is a schematic partial section view of a fiber mat according to an exemplary embodiment.

FIG. 8 is a schematic perspective view of a trimmed fiber mat according to an exemplary embodiment.

FIG. 9A is a schematic perspective view of a consolidated fiber mat according to an exemplary embodiment.

FIG. 9B is a schematic partial section view of a consolidated fiber mat according to an exemplary embodiment.

FIGS. 10A through 10C are schematic perspective views of a compressed fiber mat formed into an instrument panel according to an exemplary embodiment.

FIG. 10D is a schematic cutaway perspective view of a component for a vehicle interior according to an exemplary embodiment.

FIG. 10E is a schematic cutaway perspective view of a component for a vehicle interior according to an exemplary embodiment.

FIG. 10F is a schematic cutaway perspective view of a component for a vehicle interior according to an exemplary embodiment.

FIG. 10G is a schematic partial section perspective view of a component for a vehicle interior according to an exemplary embodiment.

FIG. 11A is a schematic partial perspective view of a component for a vehicle interior according to an exemplary embodiment.

FIG. 11B is a schematic perspective view of an airbag chute for a component for a vehicle interior according to an exemplary embodiment.

FIG. 12A is a schematic partial perspective view of a component for a vehicle interior according to an exemplary embodiment.

FIG. 12B is a schematic perspective view of an airbag chute for a component for a vehicle interior according to an exemplary embodiment.

FIG. 13A is a schematic cross-section view of a component for a vehicle interior according to an exemplary embodiment.

FIG. 13B is a schematic partial section perspective view of a component for a vehicle interior according to an exemplary embodiment.

FIG. 13C is a schematic partial section view of a component for a vehicle interior according to an exemplary embodiment.

FIG. 14A is a schematic section view of a component for a vehicle interior according to an exemplary embodiment.

FIG. 14B is a schematic partial section perspective view of a component for a vehicle interior according to an exemplary embodiment.

FIG. 14C is a schematic partial section view of a component for a vehicle interior according to an exemplary embodiment.

FIG. 15A is a schematic cross-section view of a component for a vehicle interior according to an exemplary embodiment.

FIG. 15B is a schematic partial section perspective view of a component for a vehicle interior according to an exemplary embodiment.

FIG. 15C is a schematic partial section view of a component for a vehicle interior according to an exemplary embodiment.

FIG. 16A is a schematic cross-section view of a component for a vehicle interior according to an exemplary embodiment.

FIG. 16B is a schematic partial section perspective view of a component for a vehicle interior according to an exemplary embodiment.

FIG. 16C is a schematic partial section view of a component for a vehicle interior according to an exemplary embodiment.

FIG. 17 is a schematic partial section perspective view of a component for a vehicle interior according to an exemplary embodiment.

FIG. 18A is a schematic partial section view of a component for a vehicle interior according to an exemplary embodiment.

FIG. 18B is a schematic partial section view of a component for a vehicle interior according to an exemplary embodiment.

FIG. 19 is a schematic partial section view of a component for a vehicle interior according to an exemplary embodiment.

FIG. 20A is a schematic partial section view of a component for a vehicle interior according to an exemplary embodiment.

FIG. 20B is a schematic partial section view of a component for a vehicle interior according to an exemplary embodiment.

FIG. 21 is a schematic partial section view of a component for a vehicle interior according to an exemplary embodiment.

FIG. 22A is a schematic partial perspective view of a component for a vehicle interior according to an exemplary embodiment.

FIG. 22B is a schematic cutaway perspective view of a component for a vehicle interior according to an exemplary embodiment.

FIG. 23A is a schematic partial perspective view of a component for a vehicle interior according to an exemplary embodiment.

FIG. 23B is a schematic cutaway perspective view of a component for a vehicle interior according to an exemplary embodiment.

FIG. 24A is a schematic cutaway perspective view of a component for a vehicle interior according to an exemplary embodiment.

FIGS. 24B through 24D are schematic cutaway section perspective views of a component for a vehicle interior according to an exemplary embodiment.

FIG. 25A is a schematic cutaway perspective view of a component for a vehicle interior according to an exemplary embodiment.

FIGS. 25B through 25D are schematic cutaway section perspective views of a component for a vehicle interior according to an exemplary embodiment.

FIG. 26A is a schematic cutaway perspective view of a component for a vehicle interior according to an exemplary embodiment.

FIGS. 26B through 26C are schematic cutaway section perspective views of a component for a vehicle interior according to an exemplary embodiment.

FIG. 27A is a schematic cutaway perspective view of a component for a vehicle interior according to an exemplary embodiment.

FIGS. 27B through 27C are schematic cutaway section perspective views of a component for a vehicle interior according to an exemplary embodiment.

FIG. 28A is a schematic perspective view of a component for a vehicle interior according to an exemplary embodiment.

FIG. 28B is a schematic partial perspective view of a component for a vehicle interior according to an exemplary embodiment.

FIGS. 28C through 28D are schematic cutaway perspective views of a component for a vehicle interior according to an exemplary embodiment.

FIG. 29A is a schematic cutaway perspective view of a component for a vehicle interior according to an exemplary embodiment.

FIGS. 29B through 29C are schematic cutaway section perspective views of a component for a vehicle interior according to an exemplary embodiment.

FIG. 29D is a schematic cutaway perspective view of a component for a vehicle interior according to an exemplary embodiment.

FIGS. 29E through 29F are schematic cutaway section perspective views of a component for a vehicle interior according to an exemplary embodiment.

FIGS. 30A through 30E are schematic cross-section views of a forming process for a vehicle interior trim component according to an exemplary embodiment.

FIGS. 31A through 31E are schematic cross-section views of a forming process for a vehicle interior trim component according to an exemplary embodiment.

FIG. 32A is a schematic partial perspective view of a mold for forming a vehicle interior trim component according to an exemplary embodiment.

FIG. 32B is a schematic partial perspective section view of a mold for forming a vehicle interior trim component according to an exemplary embodiment.

FIGS. 33A through 33F are schematic partial cross-section views of a forming process for a vehicle interior trim component according to an exemplary embodiment.

FIG. 34A is a schematic partial perspective view of a component for a vehicle interior according to an exemplary embodiment.

FIG. 34B is a schematic partial section view of a component for a vehicle interior according to an exemplary embodiment.

FIG. 35A is a schematic partial perspective view of a component for a vehicle interior according to an exemplary embodiment.

FIG. 35B is a schematic cross-section view of a conventional vehicle interior trim component according to an exemplary embodiment.

FIG. 35C is a schematic cutaway cross-section view of a conventional vehicle interior trim component according to an exemplary embodiment.

FIGS. 36A through 36C are schematic partial section views of a component for a vehicle interior according to an exemplary embodiment.

FIG. 36D is a schematic partial section diagram of a component for a vehicle interior according to an exemplary embodiment.

FIG. 37A is a schematic perspective view of a component for a vehicle interior according to an exemplary embodiment.

FIG. 37B is a schematic side elevation view of a component for a vehicle interior according to an exemplary embodiment.

FIG. 37C is a schematic partial section view of a component for a vehicle interior according to an exemplary embodiment.

FIG. 37D is a schematic side elevation section view of a component for a vehicle interior according to an exemplary embodiment.

FIG. 38A is a schematic perspective view of a component for a vehicle interior according to an exemplary embodiment.

FIG. 38B is a schematic partial side elevation view of a component for a vehicle interior according to an exemplary embodiment.

FIG. 39 is a schematic perspective view of a component for a vehicle interior according to an exemplary embodiment.

FIG. 40A is a schematic perspective view of a component for a vehicle interior according to an exemplary embodiment.

FIG. 40B is a schematic partial side elevation view of a component for a vehicle interior according to an exemplary embodiment.

FIG. 41A is a schematic side elevation view of a component for a vehicle interior according to an exemplary embodiment.

FIG. 41B is a schematic partial section view of a component for a vehicle interior according to an exemplary embodiment.

FIG. 41C is a schematic side elevation section view of a component for a vehicle interior according to an exemplary embodiment.

FIG. 42A is a schematic side elevation view of a component for a vehicle interior according to an exemplary embodiment.

FIG. 42B is a schematic partial section view of a component for a vehicle interior according to an exemplary embodiment.

FIG. 42C is a schematic side elevation section view of a component for a vehicle interior according to an exemplary embodiment.

FIG. 43A is a schematic side elevation view of a component for a vehicle interior according to an exemplary embodiment.

FIG. 43B is a schematic partial section view of a component for a vehicle interior according to an exemplary embodiment.

FIG. 43C is a schematic side elevation section view of a component for a vehicle interior according to an exemplary embodiment.

FIG. 44A is a schematic side elevation view of a component for a vehicle interior according to an exemplary embodiment.

FIG. 44B is a schematic partial section view of a component for a vehicle interior according to an exemplary embodiment.

FIG. 44C is a schematic side elevation section view of a component for a vehicle interior according to an exemplary embodiment.

FIG. 45 is a schematic perspective partial section view of a component for a vehicle interior according to an exemplary embodiment.

FIGS. 46A and 46B are schematic side elevation views of a component for a vehicle interior according to an exemplary embodiment.

FIG. 47 is a schematic side elevation view of a component for a vehicle interior according to an exemplary embodiment.

FIGS. 48A through 48D are schematic partial cross-section views of a forming process for a vehicle interior trim component according to an exemplary embodiment.

FIG. 48E is a schematic partial side elevation view of a component for a vehicle interior according to an exemplary embodiment.

FIGS. 49A through 49E are schematic partial cross-section views of a forming process for a vehicle interior trim component according to an exemplary embodiment.

FIG. 49F is a schematic partial side elevation view of a component for a vehicle interior according to an exemplary embodiment.

FIG. 50A is a schematic partial perspective view of a component for a vehicle interior according to an exemplary embodiment.

FIG. 50B is a schematic side elevation view of a component for a vehicle interior according to an exemplary embodiment.

FIGS. 51A and 51B are schematic partial side elevation views of a component for a vehicle interior according to an exemplary embodiment.

FIG. 51C is a schematic partial side elevation view of a component for a vehicle interior according to an exemplary embodiment.

### DESCRIPTION

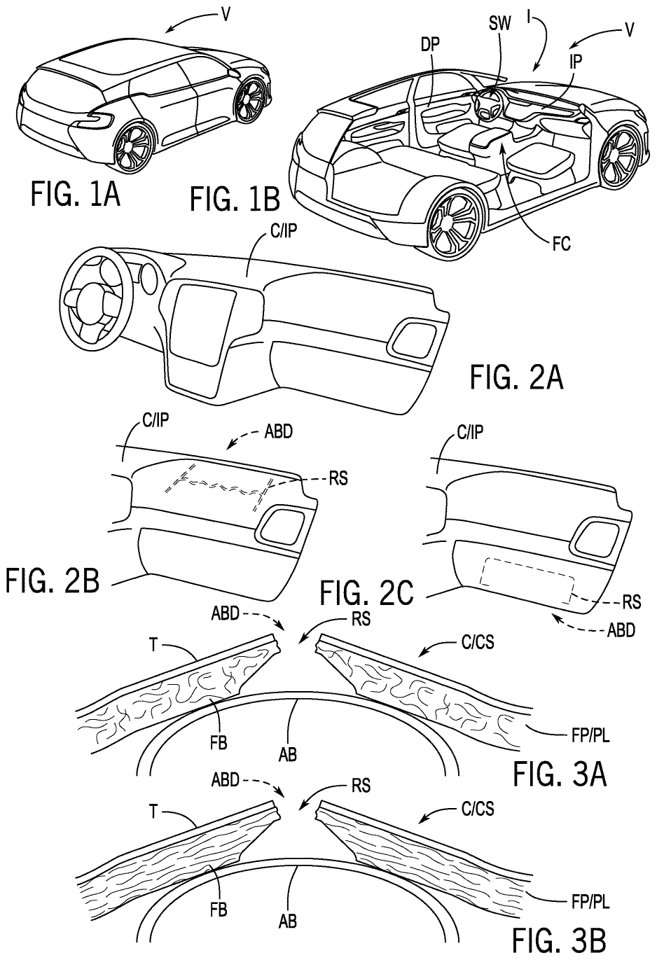

Referring to FIGS. 1A-1B and 2A-2C, a vehicle V comprising a vehicle interior I is shown according to an exemplary embodiment; interior I of vehicle V comprises seats for vehicle occupants and components C shown schematically as an instrument panel IP, a door panel DP, a floor console FC, a steering wheel SW and other trim/panels.

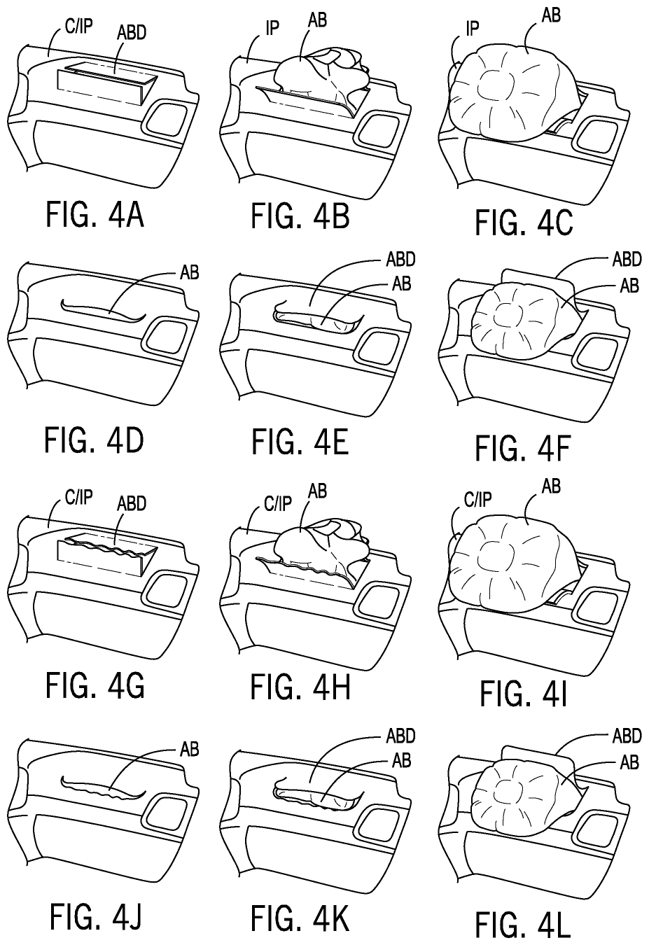

As shown schematically according to an exemplary embodiment in FIGS. 1B, 2A-2C and 3A-3B, component C comprises a panel PL comprising a cover T providing an exterior surface and a weakened area shown as recess RS configured to facilitate formation of an airbag door ABD upon deployment of an airbag AB (e.g. from an airbag module/inflator) into the interior of the vehicle. See also FIGS. 4A-4L. As indicated schematically according to an exemplary embodiment in FIG. 2A, the weakened area shown as recess RS provided in panel PL with cover T may be configured not to be readily visible at the exterior of the component C shown as instrument panel IP (e.g. not readily visible at the exterior surface). See also FIGS. 2B-2C and 3. As indicated schematically according to an exemplary embodiment in FIGS. 3A-3B, the weakened area shown as recess RS provided in panel PL with cover T may be configured to facilitate deployment of the airbag through an airbag door ABD formed in a directed location on/in the component C shown as instrument panel IP. See also FIGS. 2B-2C.

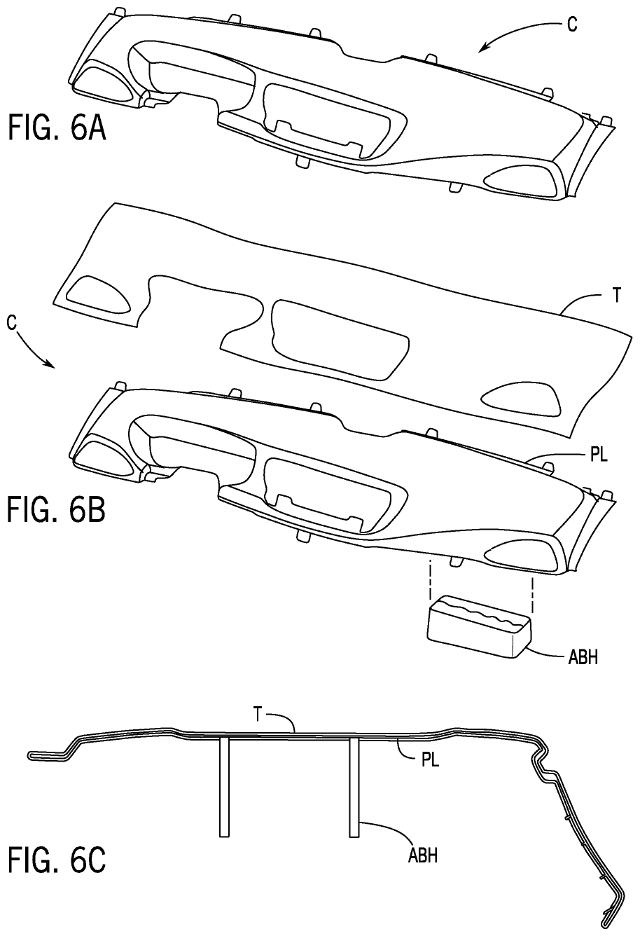

As indicated schematically according to an exemplary embodiment in FIG. 2B, the weakened area shown as recess RS may be provided in panel PL with cover T for deployment of the airbag at an upper area of the component C shown as instrument panel IP (e.g. toward the head/body of seated occupant of the vehicle). See also FIGS. 4A-4L and 6A.

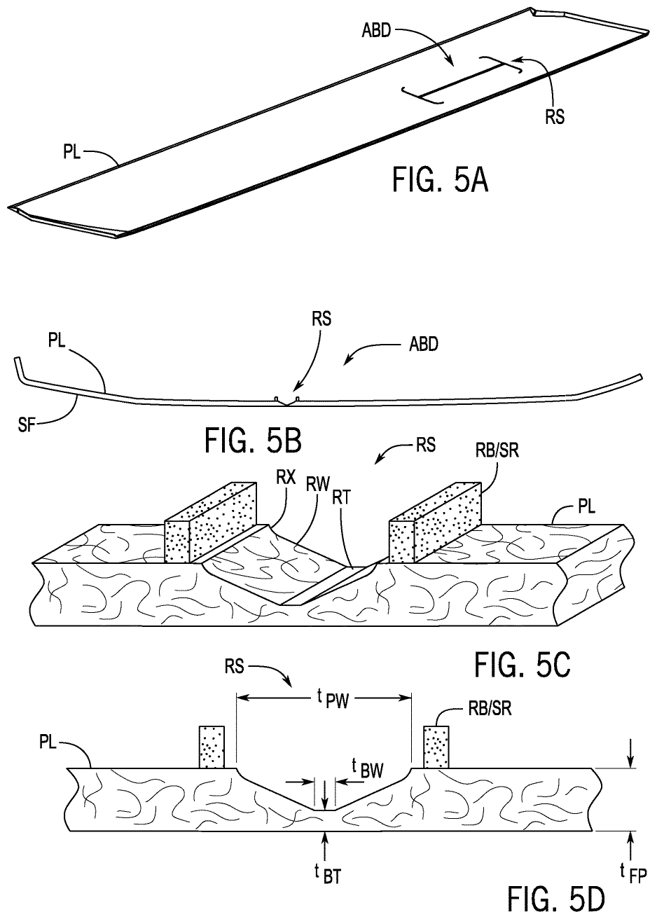

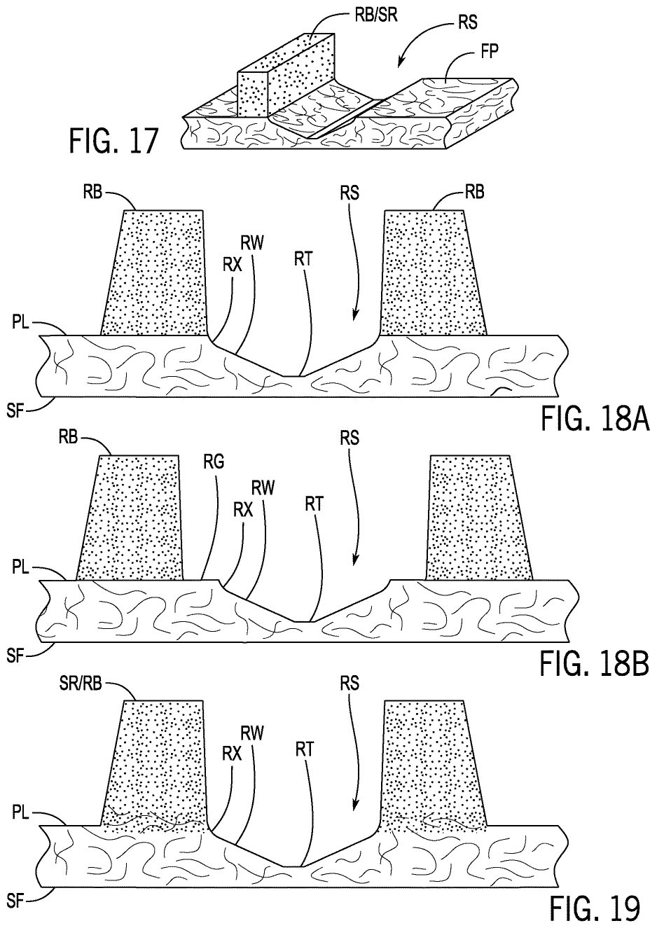

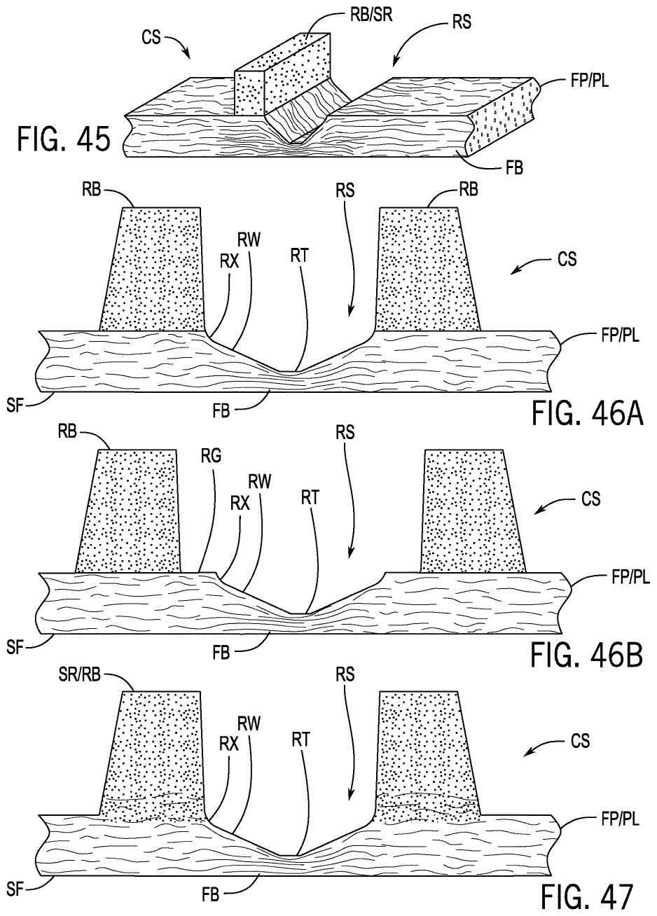

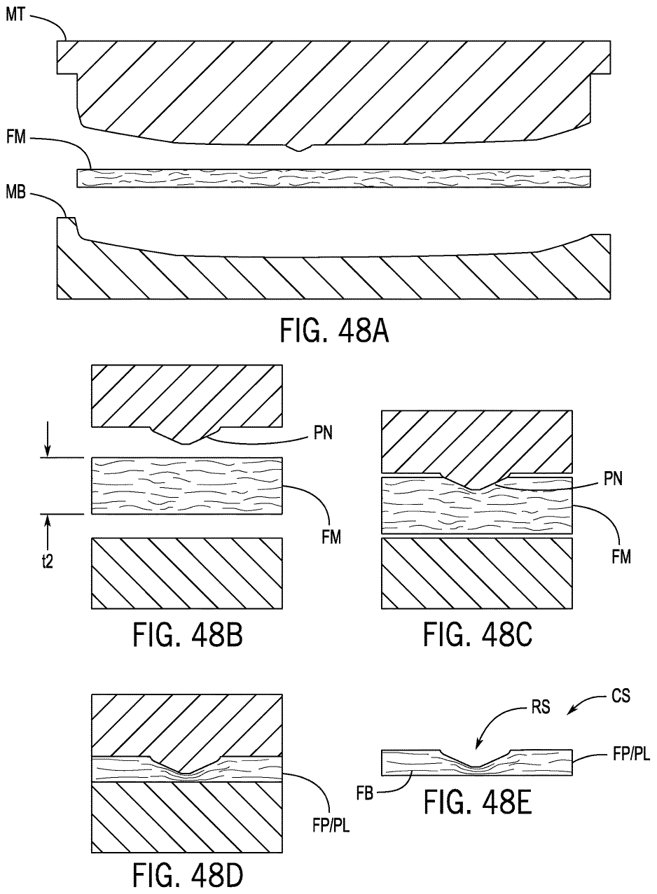

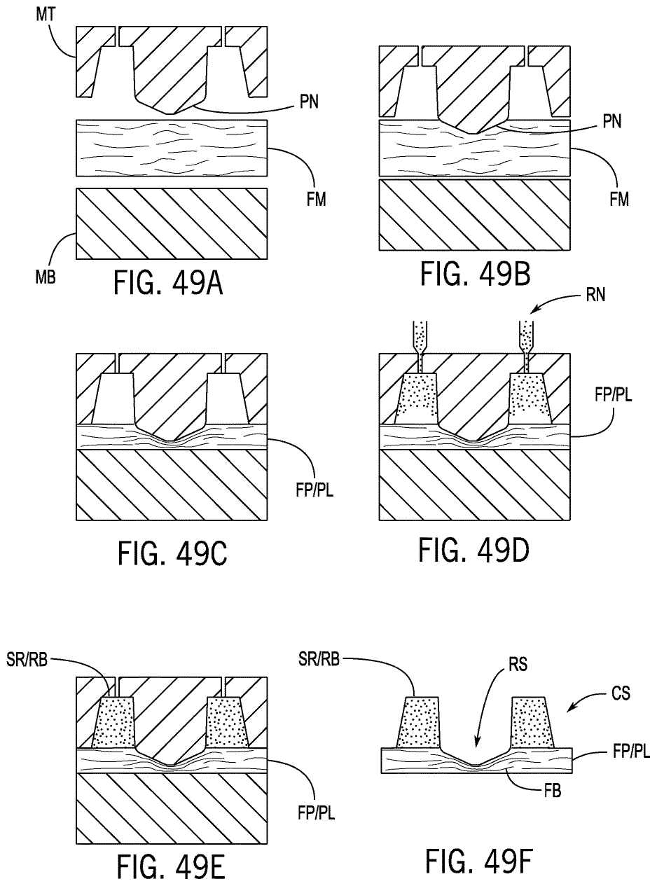

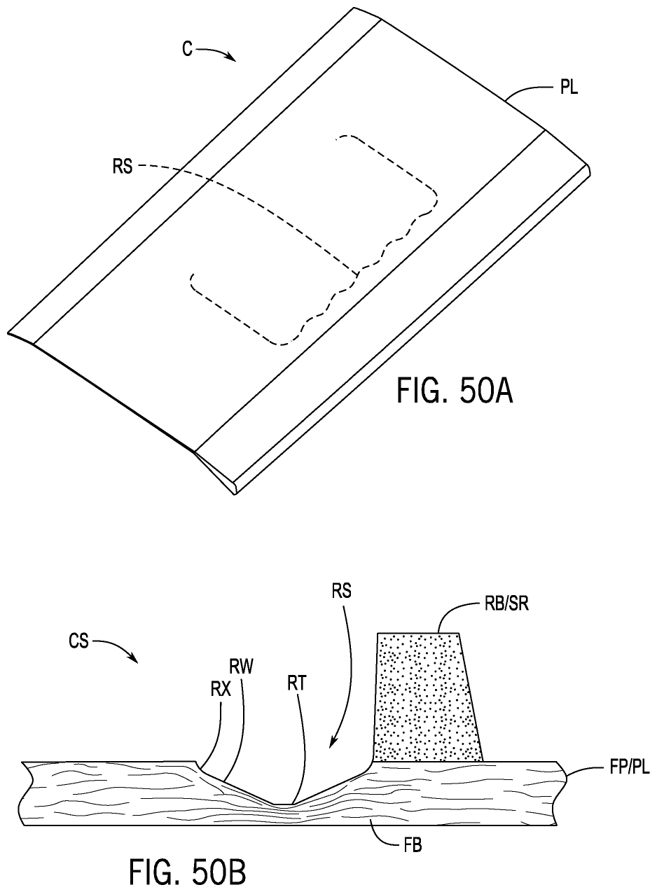

As indicated schematically according to an exemplary embodiment in FIGS. 2A-2C and 3A-3B, the weakened area shown as recess RS may be provided in compression-formed panel PL comprising fiber panel FP comprising a body/arrangement of fibers FB for the structural substrate of composite structure CS for component C. See also FIGS. 5A-5D, 13A-13C, 14A-14C, 15A-15C, 16A-16C, 17, 18A-18B, 19, 30A-30E, 31A-31F, 34A-34B, 36A-36D, 37A-37D, 41A-41C, 42A-42C, 43A-43C, 44A-44C, 45, 46A-46B, 47, 48A-48E, 49A-49F and 50A-50B.

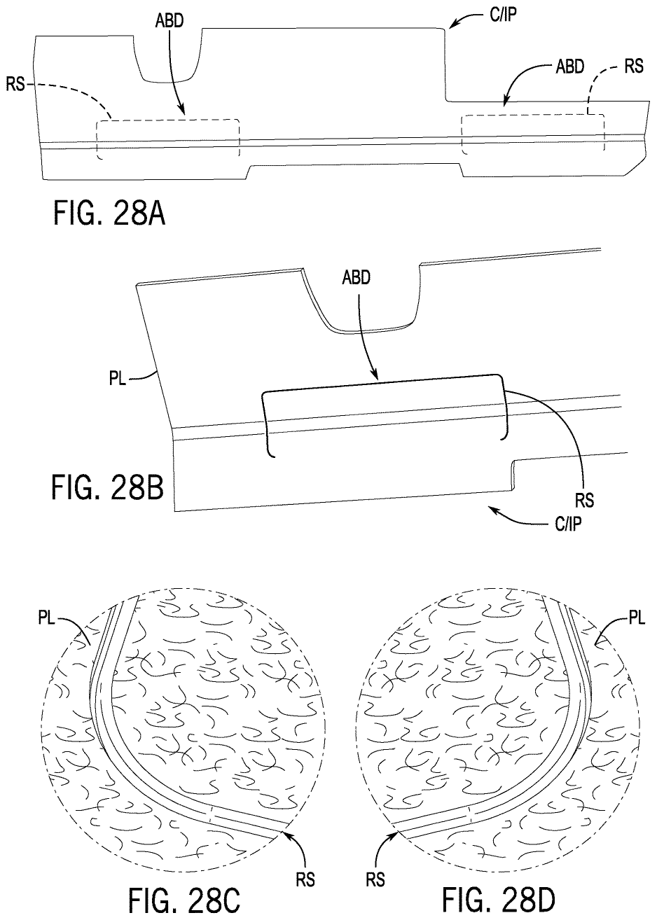

As indicated schematically according to an exemplary embodiment in FIG. 2C, the weakened area shown as recess RS may be provided in panel PL with cover T for deployment of the airbag at a lower area of the component C shown as instrument panel IP (e.g. at knee level for a seated occupant of the vehicle). See also FIGS. 28A-28B.

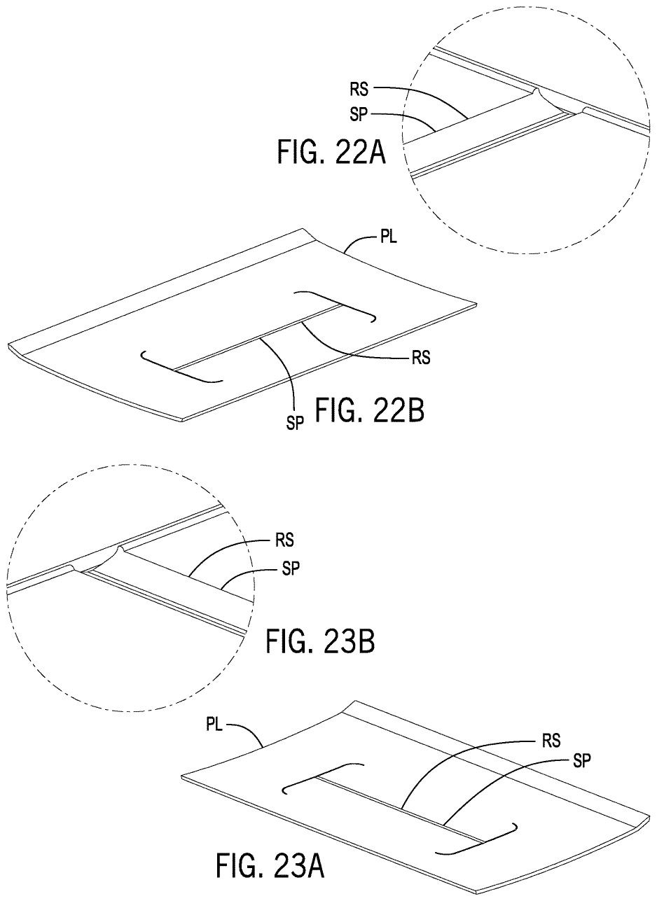

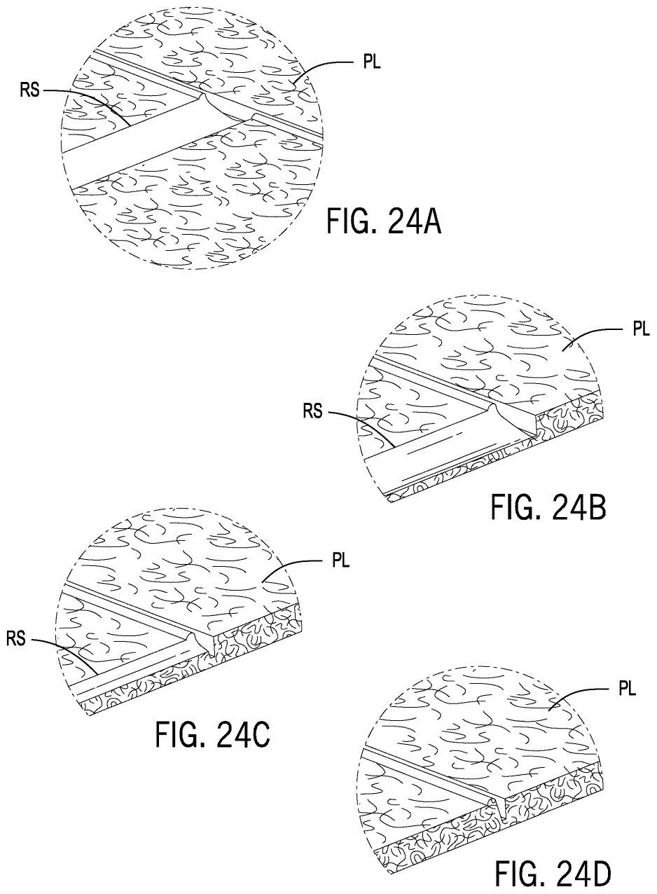

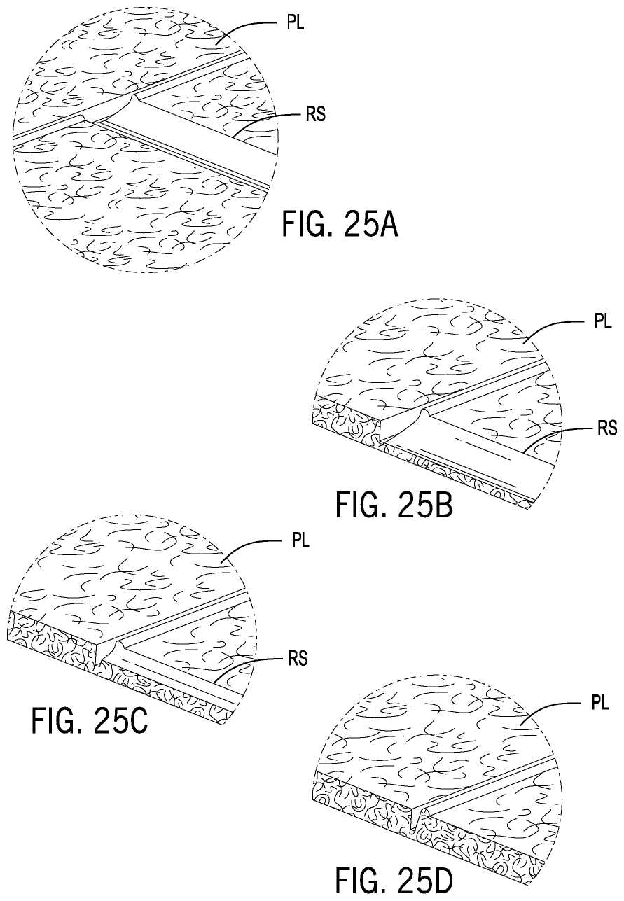

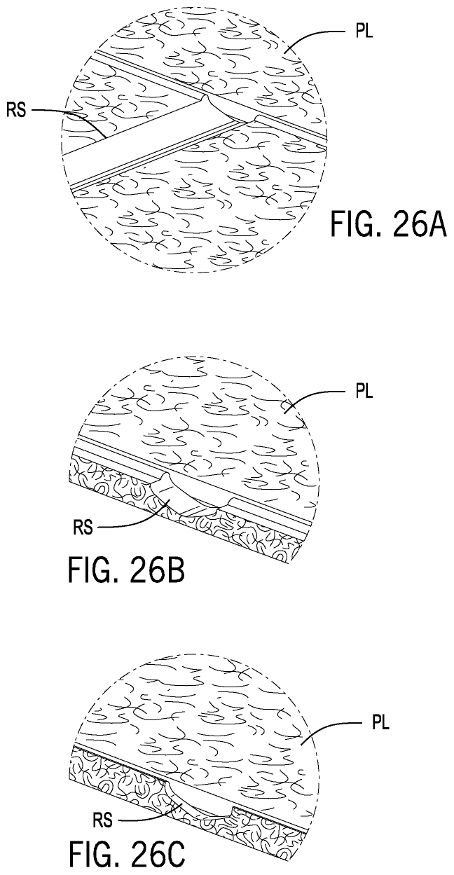

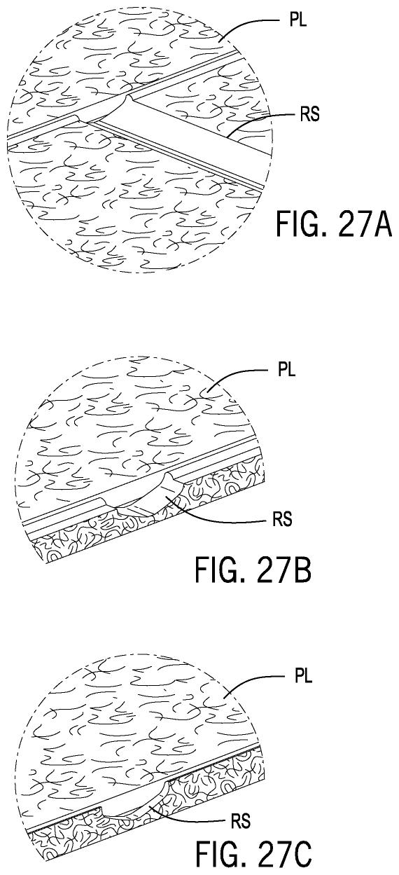

As indicated schematically according to an exemplary embodiment in FIGS. 2B, 4A-4C and 4G-4I, the weakened area shown as recess RS configured for formation of the airbag door ABD upon deployment of the airbag AB may be provided in a generally H-shaped form in panel PL of the component C shown as instrument panel IP. See also FIGS. 22A-22B, 23A-23B, 24A-24D, 25A-25D, 26A-26C, and 27A-27C.

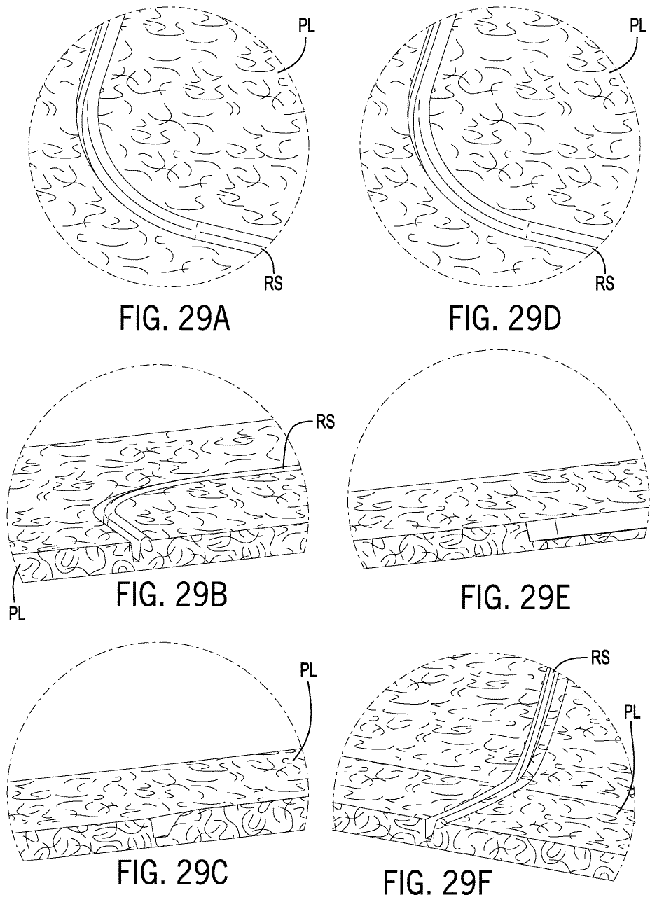

As indicated schematically according to an exemplary embodiment in FIGS. 2C, 4D-4F and 4J-4L, the weakened area shown as recess RS configured for formation of the airbag door ABD upon deployment of the airbag AB may be provided in a generally U-shaped form in panel PL of the component C shown as instrument panel IP. See also FIGS. 28A-28D and 29A-29F.

As indicated schematically according to an exemplary embodiment in FIGS. 2B and 4G-4L, the weakened area shown as recess RS configured for formation of the airbag door ABD upon deployment of the airbag AB may be provided in a generally linear form in panel PL of the component C shown as instrument panel IP. See also FIGS. 5A, 11A, 22A-22B, 23A-23B and 28A-28B.

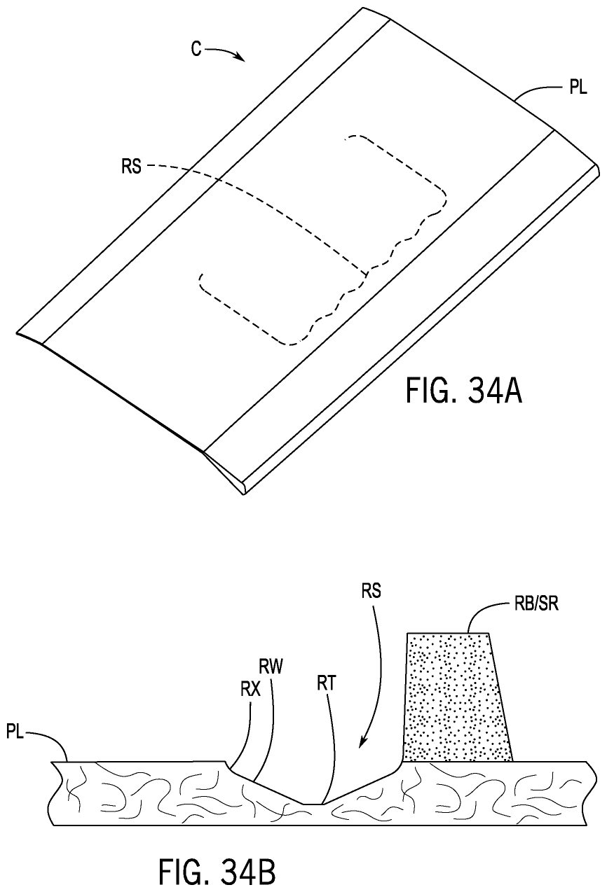

As indicated schematically according to an exemplary embodiment in FIGS. 2C and 4A-4F, the weakened area shown as recess RS configured for formation of the airbag door ABD upon deployment of the airbag AB may be provided in a generally varying form (shown as a wavy line form) in panel PL of the component C shown as instrument panel IP. See also FIGS. 12A and 34A.

As indicated schematically according to an exemplary embodiment in FIGS. 2A, 3A-3B and 4A-4L, the weakened area shown as recess RS provided in panel PL with cover T may be configured not to be readily visible at the exterior of the component C (e.g. not readily visible at the exterior surface) and may be configured to facilitate deployment of the airbag through an airbag door ABD formed in a directed location on/in the component C (e.g. formed to deploy in the directed location). See also FIGS. 1B and 2B-2C.

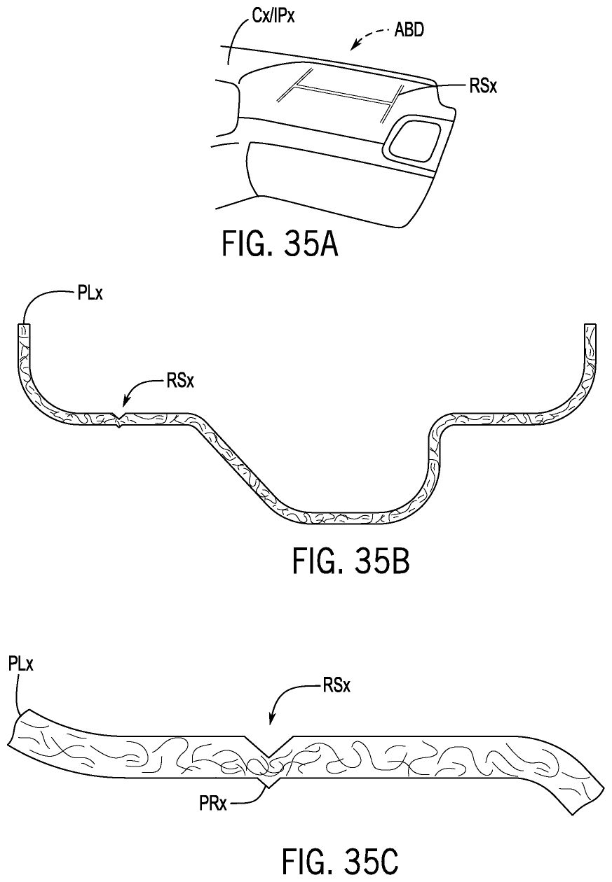

As indicated according to an exemplary embodiment in FIG. 2A, component C may be produced with a configuration of a panel PL with a recess RS that does not produce a visible indication of the weakened area at the exterior of the component C. As indicated schematically in FIGS. 35A-35C, configuration of a panel PLx with a recess RSx that produces a projection PRx at the surface may produce a visible indication of the weakened area at the exterior of the component Cx; such as visible indication of the weakened area is generally undesirable.

As shown schematically according to an exemplary embodiment in FIGS. 5A-5D and 6A-6C, the structural substrate (e.g. form/structure) of panel PL with cover T of component C may be configured to provide the weakened area shown as recess RS in a form configured not to be readily visible at the exterior of the component and to facilitate deployment of the airbag from an airbag chute ABH through an airbag door ABD formed in a directed location on/in the component. See also FIGS. 3A-3B and 4A-4L.

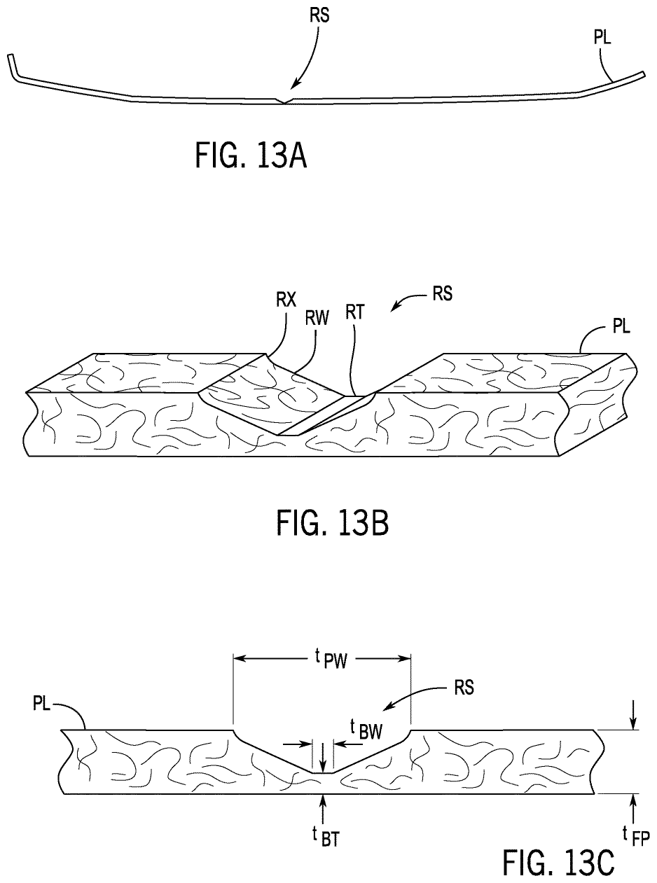

As indicated schematically in FIGS. 5B-5D, the weakened area shown as recess RS of panel PL shown as a fiber panel may be configured to provide a profile shown as comprising a shape/form. See also FIGS. 13A-13C, 14A-14C, 15A-15C, 16A-16C, 17, 18A-18B, 19 and 34B.

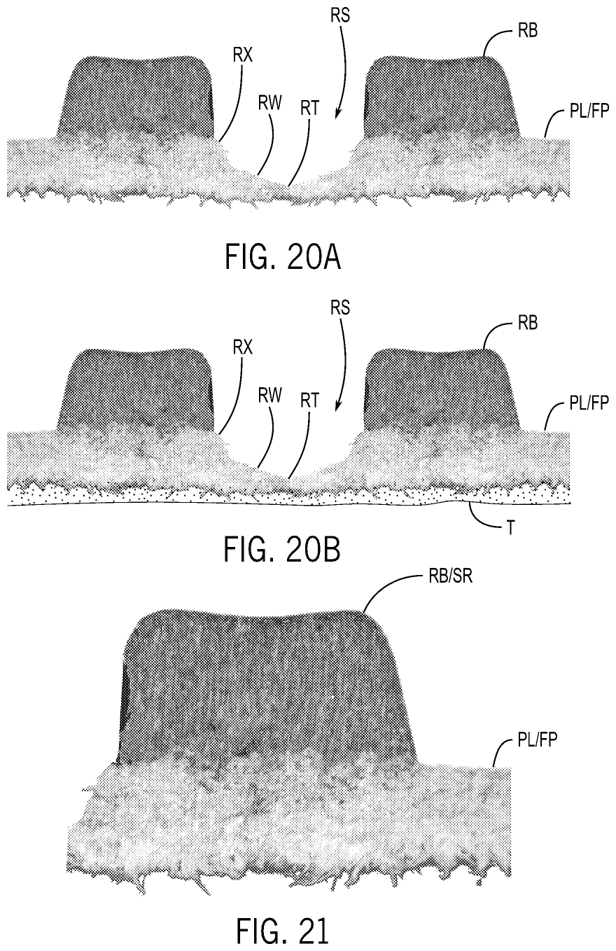

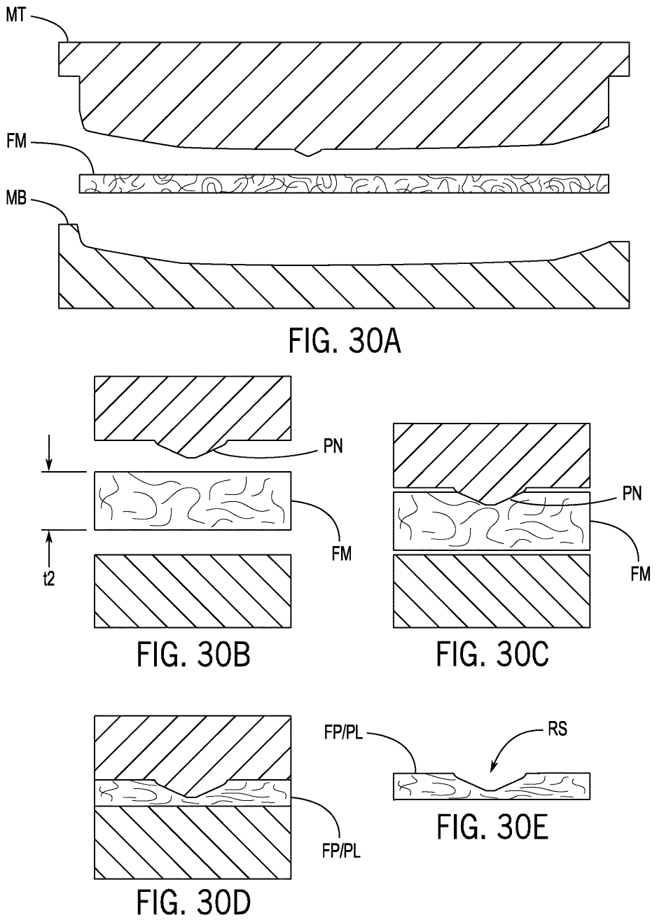

As indicated in FIGS. 5B-5D and 13A-13C, the shape/form of the profile of the recess RS in the panel PL may comprise a bottom RT and sidewalls RW and a transition RX. See also FIGS. 20A-20B and 30A-30E.

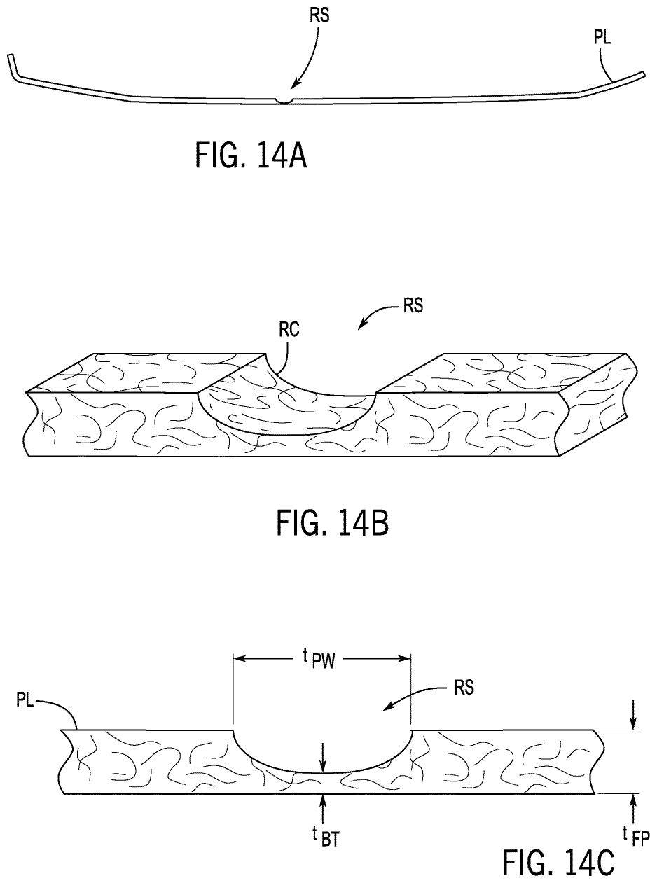

As indicated in FIGS. 14A-14C, the shape/form of the profile of the recess RS in the panel PL may comprise a generally continuous curved form RC.

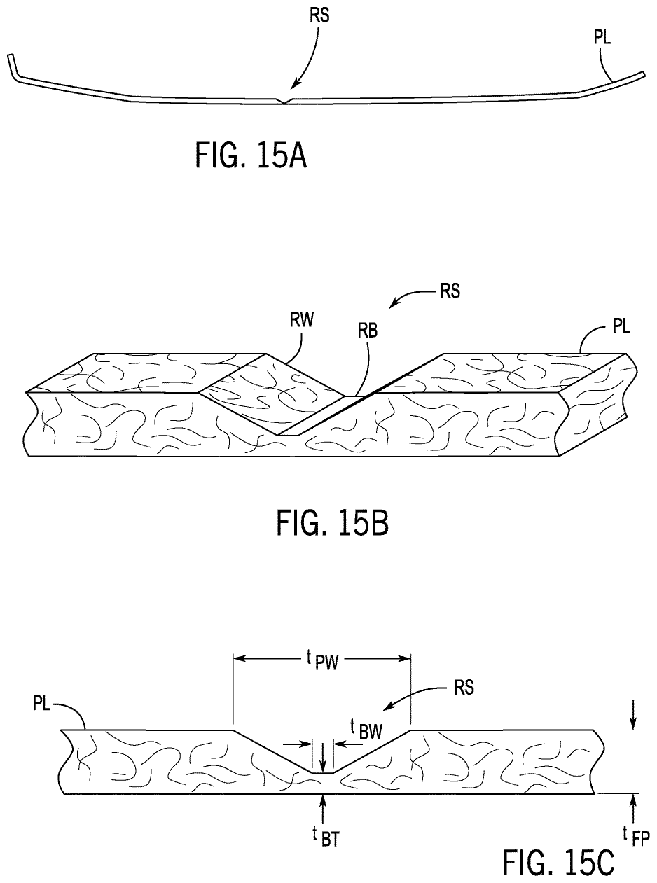

As indicated in FIGS. 15A-15C, the shape/form of the profile of the recess RS in the panel PL may comprise a bottom RT and sidewalls RW.

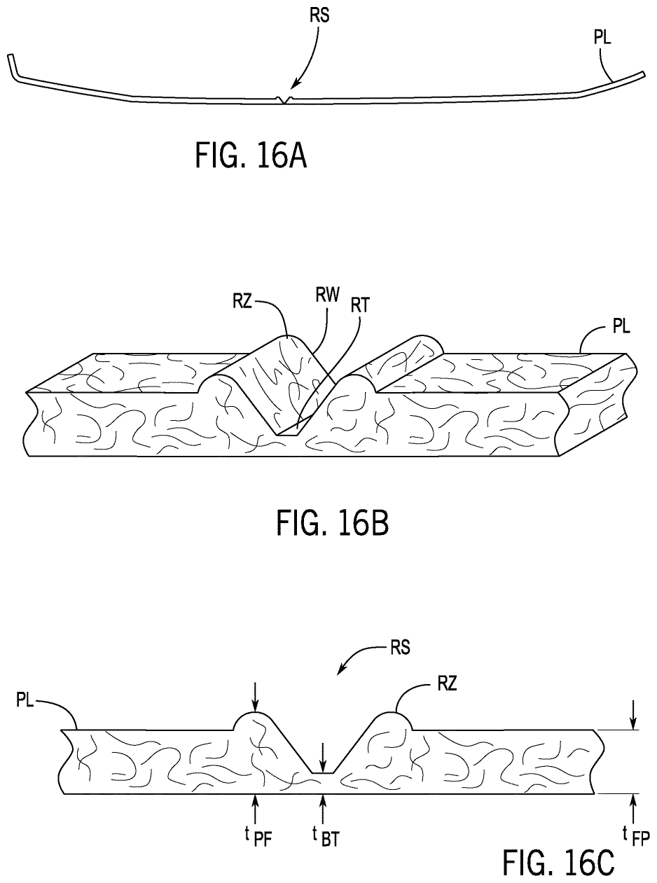

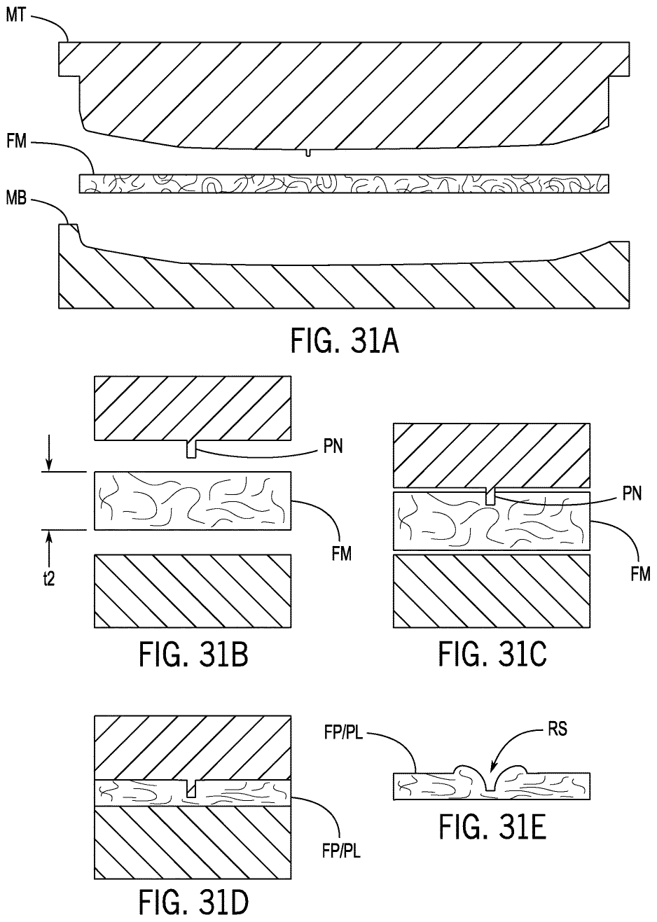

As indicated in FIGS. 16A-16C, the shape/form of the profile of the recess RS in the panel PL may comprise a bottom RT and sidewalls RW and a raised area shown as ridge RZ. See also FIGS. 31A-31E.

As indicated schematically in FIGS. 5D, 13C and 14C, 18A-18B, 19 and 34B, and shape/form of the profile of the recess RS in the panel PL may comprise forms such as a multi-sided/multi-segment form (e.g. flat forms) or a curved form or a composite form with sections of differing forms (e.g. flat, curved, etc.); the profile may include and transition section; the profile may comprise a generally symmetrical form or an asymmetrical form; the profile may comprise a generally constant depth or generally variable depth.

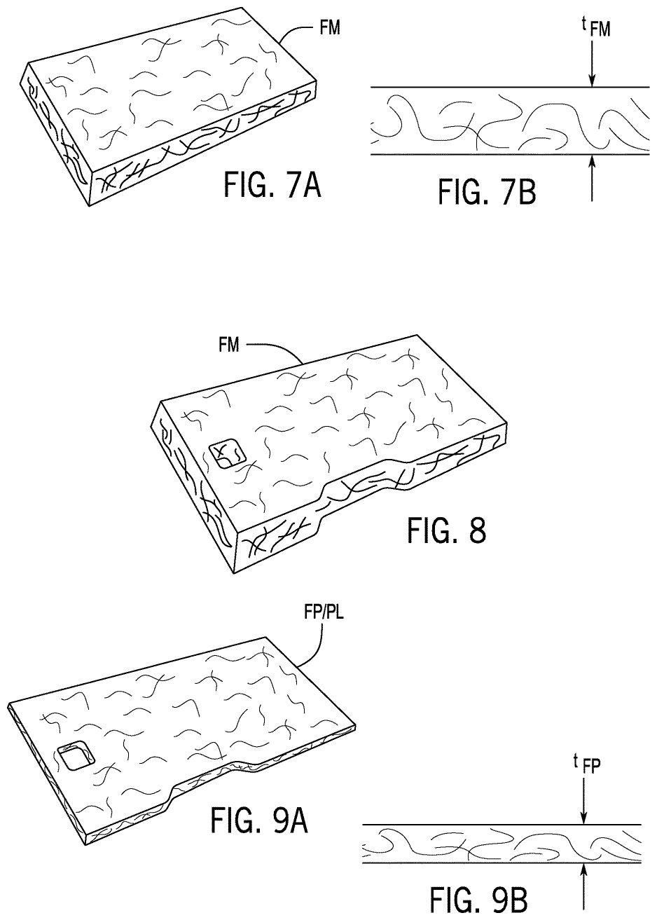

As indicated schematically in FIG. 5C and TABLE A, the shape/form of the profile of the recess RS for the panel PL may comprise general/nominal/effective dimensions for bottom RT and sidewalls RW and a transition RX relative to general nominal/effective dimensions of the panel PL shown as a fiber panel FP formed from a fiber mat FM. See also FIGS. 7A-7B, 8 and 9A-9B.

TABLE A
PROFILE OF PANEL WITH WEAKENED AREA/RECESS

| Parameter | Description | Example dimensions | Notes |
|---|---|---|---|
| tFM | Thickness of fiber mat (FM) | Greater than 2 mm | Uncompressed |
| tFP | Thickness of fiber panel (FP/PL) | 1.25 to 2 mm | Compressed |
| | at base area (nominal/effective) | | Nominal/may vary |
| tPW | Profile - width across profile of | 2 to 10 mm | Nominal/may vary |
| | recess (nominal/effective) | | |
| tBW | Profile - width of bottom of | Greater than 0.25 mm | Nominal/may vary |
| | recess (BT) (nominal/effective) | | |
| tBT | Profile - thickness at bottom of | 0.4 to 0.8 mm | Nominal/may vary |
| | recess (BT) (nominal/effective) | | |
| tPF | Thickness at feature/ridge | Greater than 0 mm | Optional |
| | adjacent to recess (RZ) | (if present) | Nominal/may vary |
| | (nominal/effective) | | |

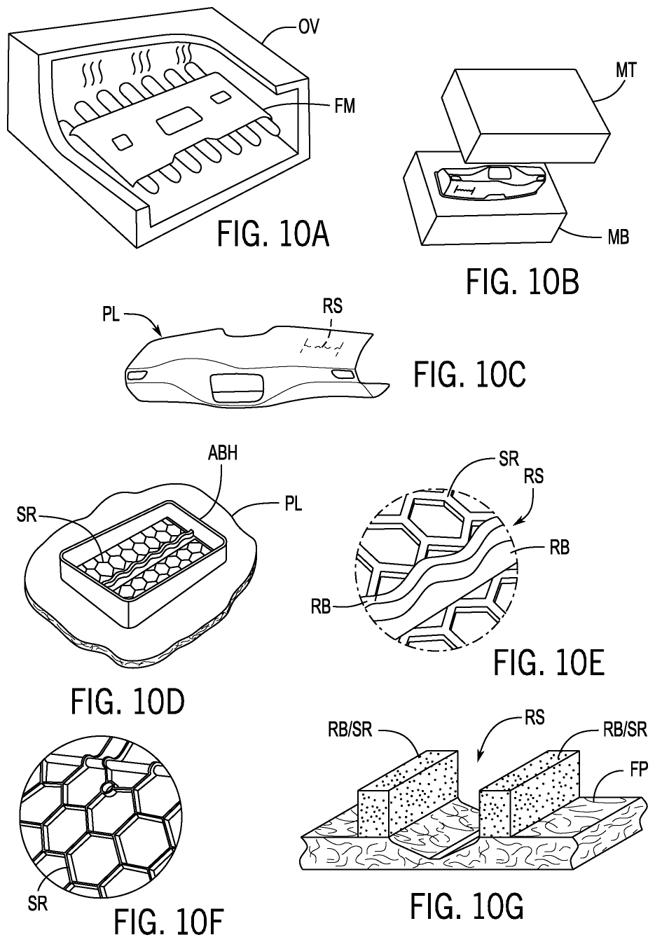

As indicated schematically in FIGS. 5B-5D, 13A-13C, 14A-14C, 15A-15C and 16A-16C, the configuration of the panel PL with weakened area for the recess RS may comprise the shape/form the profile of the recess RS in the panel PL with multi-segment form (e.g. such as with bottom RT and/or sidewalls RW) and/or with curved form RC (including with bottom/sides) and/or transition section RX and/or with formed structure such as a rib/ribs RB; the configuration of the panel PL with weakened area for the recess RS may comprise physical/proportional relationships relating to the shape/form of the panel PL and the shape/form of the profile of the recess RS in the panel PL such as with multi-segment form (e.g. such as with bottom RT and/or sidewalls RW) and/or curved form RC (including with bottom/sides) and/or transition section RX and/or with formed structure such as a rib/ribs RB. See also FIGS. 10G, 17, 18A-18B, 19, 20A-20B and 34B.

As indicated schematically in FIGS. 3A-3B and 4A-4L, the panel of the component C comprises a weakened area provided by recess RS; the weakened area may comprise a variety of shapes/forms provided by the shape/form of the recess; the configuration of the panel with weakened area/recess may be configured to direct formation of the airbag door at a location on the panel. As indicated schematically according to an exemplary embodiment in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, the weakened area may be provided along segments of recess RS in the panel PL including at center/primary segments and connection interface and lateral/side segments, See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL including at center/primary segments and connection interface and lateral/side segments).

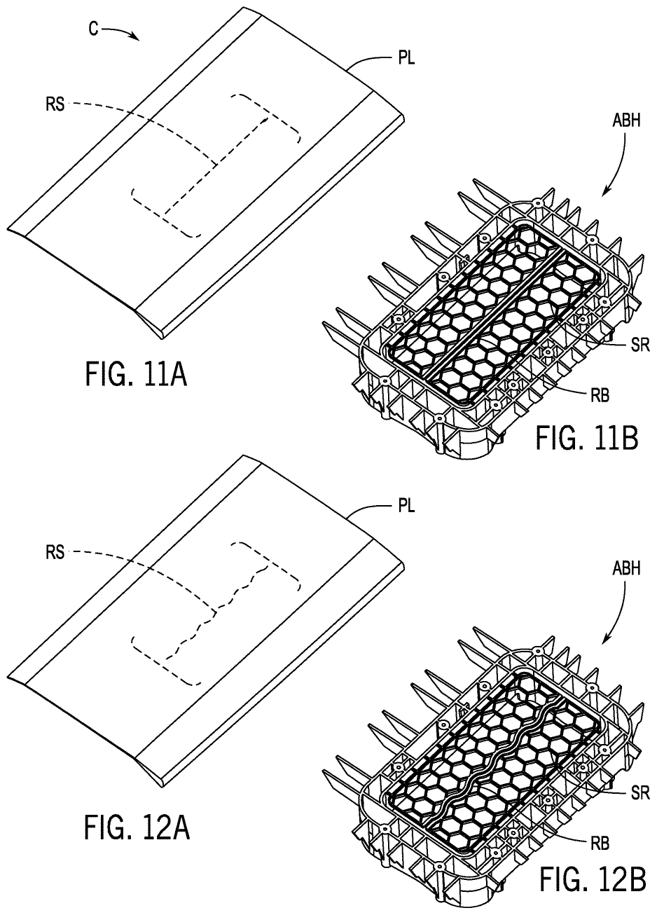

As indicated schematically according to an exemplary embodiment in FIGS. 4A-4C, 22A-22B, 23A-23B, 24A-24D, 25A-25D, 26A-26C, and 27A-27C, the recess RS may comprise a generally H-shaped groove with side/lateral segments and a center/connecting segment (e.g. intersecting/connecting to lateral segments); each segment/section of the recess/groove may comprise a profile with a shape/form. See also FIGS. 11A-11B and 12A-12B. The panel may be configured to direct formation of the opening at/along the recess for the weakened area in the generally H-shaped form (e.g. to provide an airbag door at a set of hinged flaps/doors). See FIGS. 4A-4C and 4G-4I.

As indicated schematically in FIGS. 4D-4F, 28A-28D and 29A-29F, the recess RS may comprise a generally U-shaped groove with a generally continuous form from a center segment to lateral segments; each segment/section of the recess/groove may comprise a profile with a shape/form. See also FIG. 34A. The panel may be configured to direct formation of the opening at/along the recess for the weakened area in the generally U-shaped form (e.g. to provide an airbag door as a single door or hinged flap). See FIGS. 4D-4F and 4J-4L.

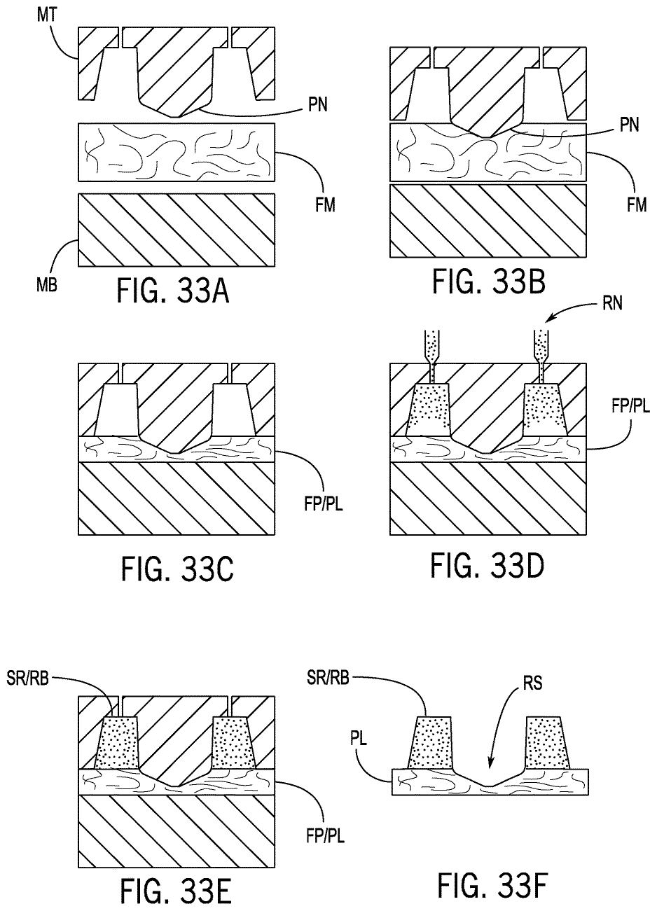

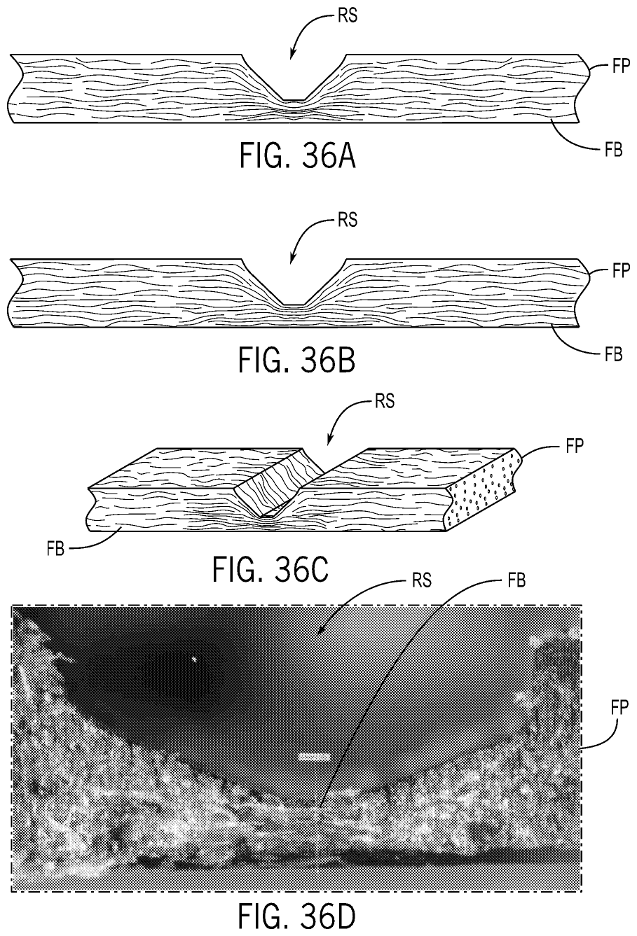

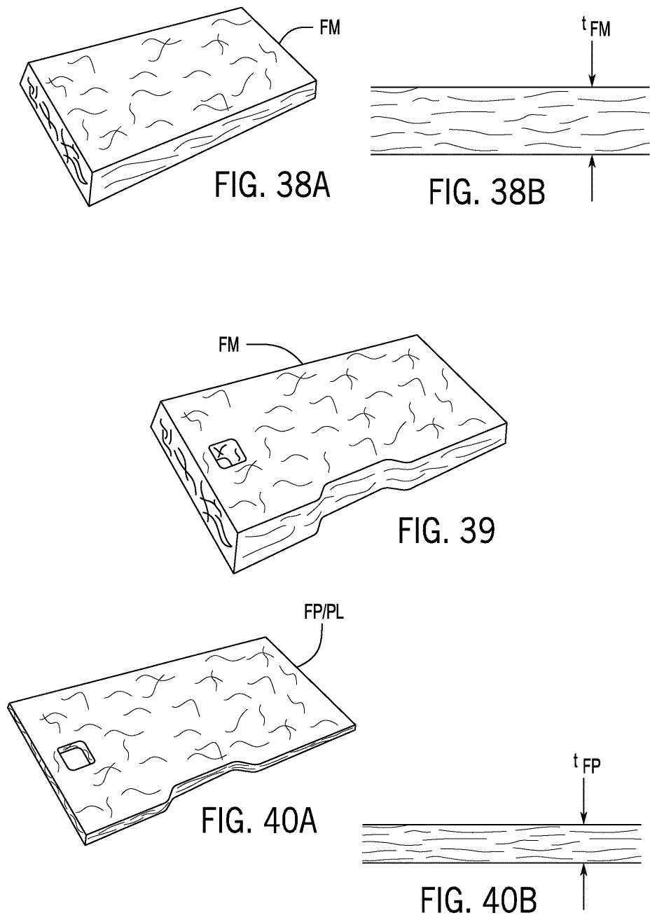

As indicated schematically in FIGS. 5B-5D, 10G, 17, 18A-18B, 19 and 34B, the panel PL may be provided with a structure such as a formed rib RB (e.g. injection molded rib) at/adjacent to the recess RS in the panel PL; as indicated schematically, the structure/rib RB may comprise a provided at the transition RX to the sidewalls RW and bottom RT of the profile of the recess RS. See also FIGS. 33A-33F. As indicated in FIG. 18B, the structure/rib RB by be separated from the recess RS in the panel PL; as indicated schematically, a gap/area RG may be provided between the structure/rib RB and the transition RX to the sidewalls RW and bottom RT of the profile of the recess RS. See also FIGS. 36A-36D, 37A-37D, 38A-38B, 39, 40A-40B, 41A-41C, 42A-42C, 43A-43C, 44A-44C, 45, 46A-46B, 47, 48A-48E, 49A-49F and 50A-50B (formed/compression-formed panel shown as a fiber panel with body/arrangement of aligned/laterally-aligned fibers formed/configured to provide/maintain enhanced rigidity for structural substrate of composite structure including across formed recess configured to provide a profile shown as comprising a shape/form).

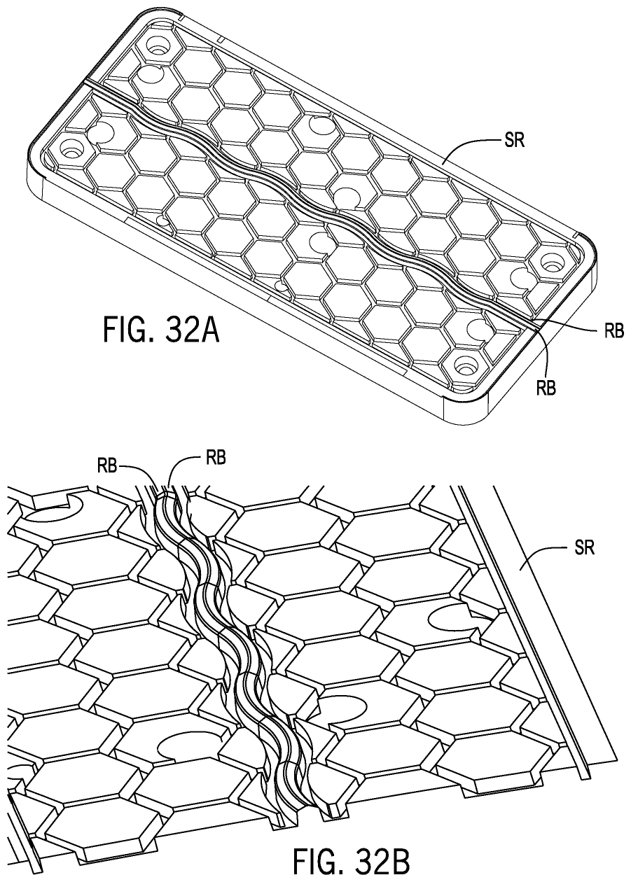

As indicated schematically in FIGS. 5B-5D, 10D-10G, 11A-11B, 12A-12B, 17, 18A-18B, 19, 20A-20B, 21, 32A-32B, 33A-33F and 34B, the component may comprise a structure SR shown as comprising rib/ribs RB at or adjacent to the recess RS in the panel PL. As indicated schematically in FIGS. 19, 20A-20B, 21 and 33A-33F, the structure may comprise a molded resin RB formed with the panel PL shown as fiber panel FP comprising fibers; the molded resin may comprise an injection molded resin; the injection molded resin may be configured to mix/intermingle with the fibers of the fiber panel. See also FIGS. 7A-7B, 8, 9A-9B, 10G, 17, 18A-18B, 19 and 34B.

According to an exemplary embodiment as shown in FIGS. 5B-5D, 10G, 17, 18A-18B, 19, 20A-20B, 21, 32A-32B, and 34B, the molded/plastic structure SR/RB on the fiber panel FP/PL may comprise any of a variety of forms/features with a variety of dimensions and variations in physical relationship to the panel PL and features such as recess RS on the panel PL. See also FIGS. 10D-10F, 11B and 12B. As indicated schematically in FIGS. 6A-6C, 10D-10G, 11B and 12B, the structure SR may comprise or be configured to assembly with an airbag chute ABH.

As indicated schematically in FIGS. 7A-7B, 8, 9A-9B, 10A-10B, 30A-30E, 31A-31E and 33A-33F, the method/process of forming the component may comprise heating a fiber mat (e.g. in an oven OV) and providing the fiber mat FM in a mold tool (shown as comprising a mold top/bottom arrangement MT/MB) to compression form a structural substrate as a compression-formed fiber panel FP shown as panel PL in the form of the component (and with features such as recesses, voids, ridges, etc.); a weakened area shown as recess RS may formed in the panel FP/PL by a tool such as comprising a projection PN; the shape/form of the projection PN may generally provide the shape/form of the recess RS in the panel FP/PL. See FIGS. 30A-30E, 31A-31E and 33A-33F.

As indicated schematically in FIGS. 16A-16C, 20A-20B, 21 and 31A-31E, the shape/form of the profile of the recess RS in the panel PL of the component C may not fully conform to the shape/form of the tool such as projection PN to form the profile of the recess RS in panel PL; as indicated in FIGS. 31D and 31E, material of the panel PL may after forming may flow into a form shown as a ridge and/or to provide a profile having a variation (shown as angled/tapered sidewalls for form) notwithstanding the shape/form of the tool (shown as vertical wall form). See also FIGS. 36A-36D, 37A-37D, 38A-38B, 39, 40A-40B, 41A-41C, 42A-42C, 43A-43C, 44A-44C, 45, 46A-46B, 47, 48A-48E, 49A-49F and 50A-50B (formed/compression-formed panel shown as a fiber panel with body/arrangement of aligned/laterally-aligned fibers formed/configured to provide/maintain enhanced rigidity for structural substrate of composite structure including across formed recess configured to provide a profile shown as comprising a shape/form).

As indicated schematically in FIGS. 7A-7B, 8 and 9A-9B, the fiber mat FM may comprise a generally nominal thickness (shown as thickness tFM); the fiber panel FP/PL formed from fiber mat FM may comprise may comprise a base area providing a generally nominal thickness (shown as thickness tFP) and features (e.g. recesses, voids, ridges, etc.) having variations in thickness from the nominal/effective thickness of the base area; features such as formed features providing the profile of recess RS in the fiber panel FP/PL may comprise intended shape/dimensions (e.g. nominal thickness/depth, width, angle, curvature, etc.) and variations at formation in the formed component/component. See also TABLE A and FIGS. 5B-5D, 13A-13C, 14A-14C, 15A-15C and 16A-16C.

As indicated schematically in FIGS. 33A-33F, the method/process of forming the component may comprise forming a molded structure SR such as rib/ribs RB on the panel FP/PL formed from a resin RN (e.g. by molding, injection molding, etc.). See also FIGS. 5B-5D, 10G, 17, 18A-18B, 19, 20A-20B, 21 and 34B. As indicated in FIGS. 19, 20A-20B and 21, material of the structure SR/RB and material of the panel FP/PL may form an interface comprising an intermixing of the materials. Features such structures SR/RB formed on the fiber panel FP/PL may comprise intended shape/dimensions (e.g. nominal width, height, angle, curvature, etc.) and variations. See also FIGS. 5B-5D, 10G, 13A-13C, 14A-14C, 15A-15C, 16A-16C, 17, 18A-18B, 19, 20A-20B, 21 and 34AB.

As indicated schematically in FIGS. 19, 20A-20B and 21, forming of the panel PL with structure SR may produce irregularities of shape/form as a result of processing and material properties.

As shown schematically in FIGS. 6A-6C and 20A-20B, a cover T may be applied to the panel PL to form the component C; cover T may be provided in a form/configuration to provide the external surface of the component C. As indicated in FIGS. 2A and 6A-6C, the cover T may be configured to provide an intended visual effect at the external surface of the component C (e.g. to ensure that the separation area provided by recess RS is not readily visible at the exterior of the component).

### Exemplary Embodiments-A

As indicated schematically in FIGS. 1A-1B, a vehicle V is shown to comprise an interior I with components C such as an instrument panel, door/door panels and a floor console; components of vehicle such as instrument panel and door panels may include trim components/panels comprised of fiber and plastic; instrument panel and door panels may provide visible surfaces in the vehicle interior of vehicle; vehicle interior/trim components such as instrument panel and/or door panels may provide at least one airbag behind the visible surfaces; instrument panel and/or door panels may provide a weakened area to aid the airbag in breaking through the trim component/panel during airbag deployment. See FIGS. 2A-2C, 3A-3B and 4A-4L.

As indicated schematically according to an exemplary embodiment in FIGS. 2A-2C and 3A-3B, the weakened area shown as recess RS may be provided in compression-formed panel PL comprising fiber panel FP comprising a body/arrangement of fibers FB to provide a structural substrate for composite structure CS of component C. See also FIGS. 5A-5D, 13A-13C, 14A-14C, 15A-15C, 16A-16C, 17, 18A-18B, 19, 30A-30E, 31A-31F, 34A-34B, 36A-36D, 37A-37D, 41A-41C, 42A-42C, 44A-44C, 45, 46A-46B, 47, 48A-48E, 49A-49F, 50A-50B and 51A-51C.

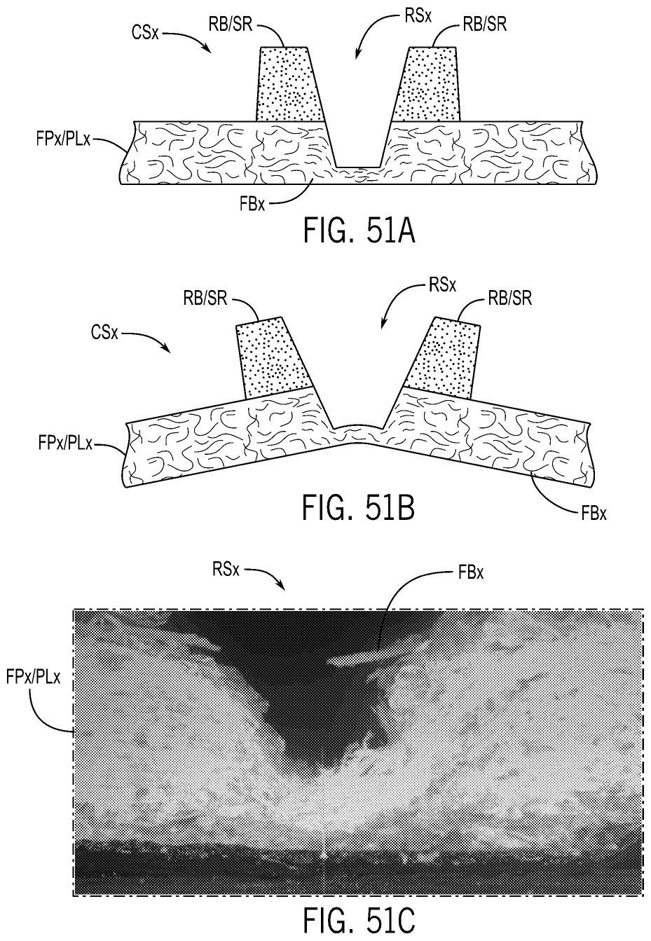

According to an exemplary embodiment shown schematically in FIGS. 3B and 36A-36D, a composite structure CS comprising a trim panel PL may comprise a substrate shown as a fiber panel FP with an aligned arrangement of fibers FB (e.g. body of fibers with generally lateral alignment/arrangement within panel) with an indentation/recess RS formed in the fibers FB and fiber panel FP. See also FIGS. 38A-38B, 39 and 40A-40B. As indicated schematically in FIGS. 2C, 3B and 36A-36D, the recess RS in the substrate shown as fiber panel FP may provide a weakened area for formation of a door/opening for deployment of an airbag; as indicated schematically in FIG. 36C, composite structure CS with structural substrate shown as fiber panel FP retains structural strength at the area of recess RS due generally to alignment of the fibers FB of the fiber panel FP. See also FIGS. 36A-36D, 37A-37D, 41A-41C, 42A-42C, 44A-44C, 45, 46A-46B, 47, 48A-48E, 49A-49F and 50A-50B. Compare FIGS. 51A-51C (structure of the substrate shown as fiber panel FPx may be weakened unintentionally by reduction of structural strength at the area of recess RSx due generally to a lack of alignment of the body of fibers FBx of the fiber panel FPx).

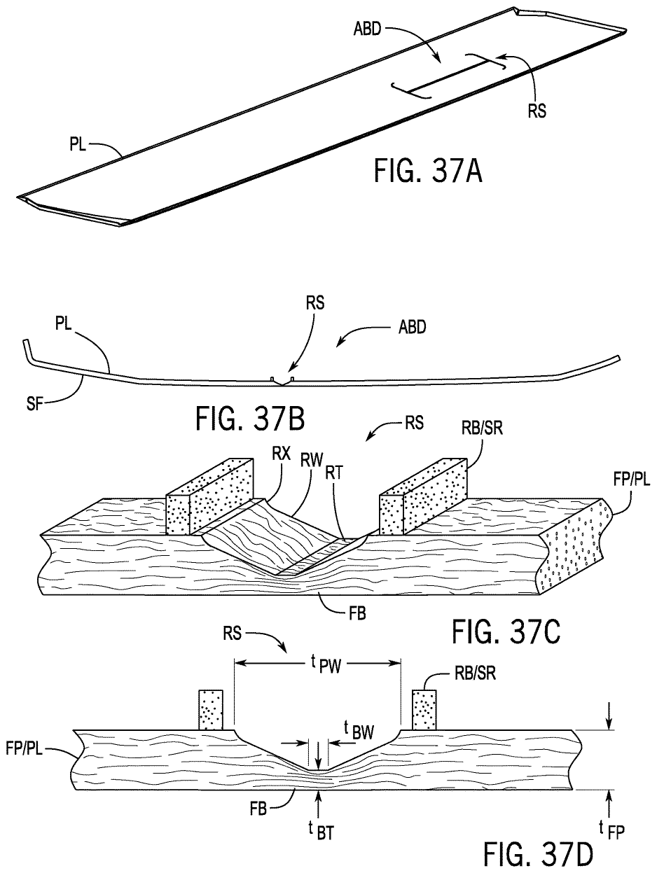

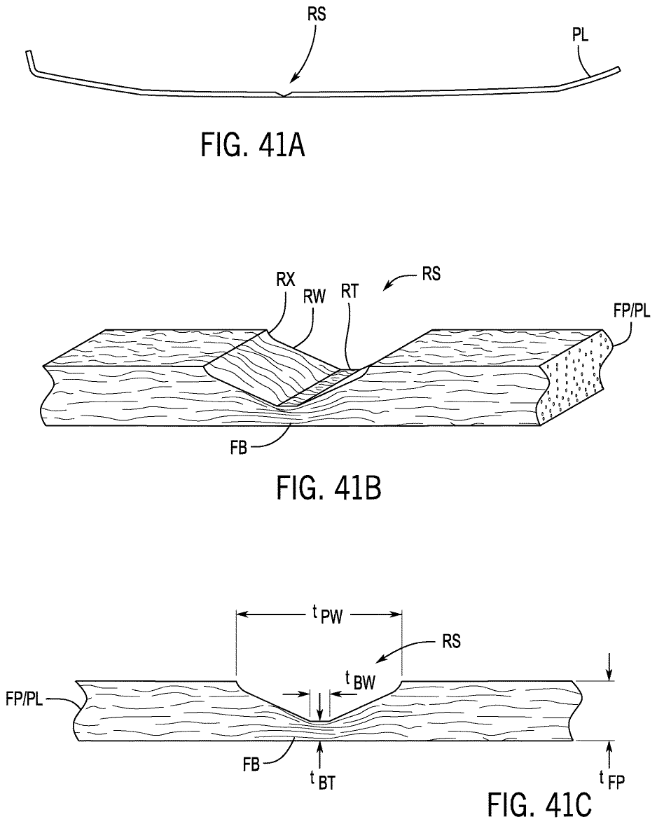

As indicated schematically in FIGS. 3B, 36A-36D, 37A-37D, 38A-38B, 39 and 40A-40B, the structural substrate of composite structure CS provided by fiber panel FP formed into compression formed panel PL is provided with a weakened area at recess RS; the weakened area at recess RS for the structural substrate provided by fiber panel FP for panel PL is configured to facilitate formation of an opening for deployment of an airbag AB through the composite structure CS of the component C; the weakened area at recess RS for the structural substrate provided by fiber panel FP for panel PL is formed with general alignment of the body/arrangement of fibers FB to facilitate structural strength to retain the shape/form of the composite structure CS of the component C (e.g. rigidification to resist bending, deflection at weakened area at recess RS). See FIGS. 41A-41C, 42A-42C, 44A-44C, 45, 46A-46B, 47, 48A-48E, 49A-49F and 50A-50B. Compare FIGS. 3A and 51A-51C (lack of alignment of the body of fibers at weakened area/recess reduces ability of structural substrate to resist bending/deflection and/or to retain the shape/form of the composite structure). As indicated schematically in FIGS. 3B, 36A-36D, 38A-38B, 39 and 40A-40B, the fiber mat MT with a body of generally aligned/laterally aligned fibers FB provides a fiber panel FP with the body of generally aligned/laterally aligned fibers FB and is compression-formed into panel PL with formed recess RS maintaining the body of generally aligned/laterally aligned fibers FB; the compression-formed panel PL with recess RS formed in the fiber panel FP maintains/compresses the body of generally aligned/laterally aligned fibers FB to provide/maintain enhanced rigidity for structural substrate of composite structure CS. See also FIGS. 37A-37D, 41A-41C, 42A-42C, 43A-43C, 44A-44C, 45, 46A-46B, 47, 48A-48E, 49A-49F and 50A-50B. Compare FIGS. 51A-51C (formed recess with variation of fiber arrangement/alignment in structural substrate).

As indicated schematically in FIGS. 36A-36D and 37A-37D, the weakened area shown as recess RS of formed/compression-formed panel PL shown as a fiber panel FP with body/arrangement of aligned fibers FB formed/configured to provide/maintain enhanced rigidity for structural substrate of composite structure CS may be configured to provide a profile shown as comprising a shape/form. See also FIGS. 3B, 41A-41C, 42A-42C, 43A-43C, 44A-44C, 45, 46A-46B, 47, 48A-48E, 49A-49F and 50A-50B.

As indicated in FIGS. 37A-37D and 41A-41C, the shape/form of the profile of the recess RS in the formed panel PL shown as a fiber panel FP with body/arrangement of aligned fibers FB formed/configured to provide/maintain enhanced rigidity for structural substrate of composite structure CS may comprise a bottom RT and sidewalls RW and a transition RX. See also FIGS. 3B, 36A-36D, 42A-42C, 43A-43C, 44A-44C, 45, 46A-46B, 47, 48A-48E, 49A-49F and 50A-50B.

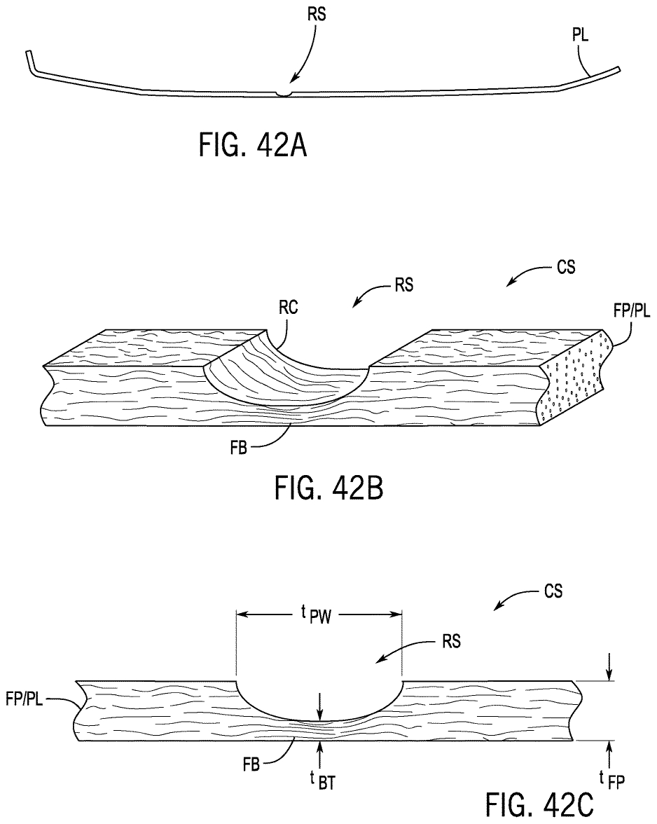

As indicated in FIGS. 42A-42C, the shape/form of the profile of the recess RS in the formed panel PL shown as a fiber panel FP with body/arrangement of aligned fibers FB formed/configured to provide/maintain enhanced rigidity for structural substrate of composite structure CS may comprise a generally continuous curved form RC.

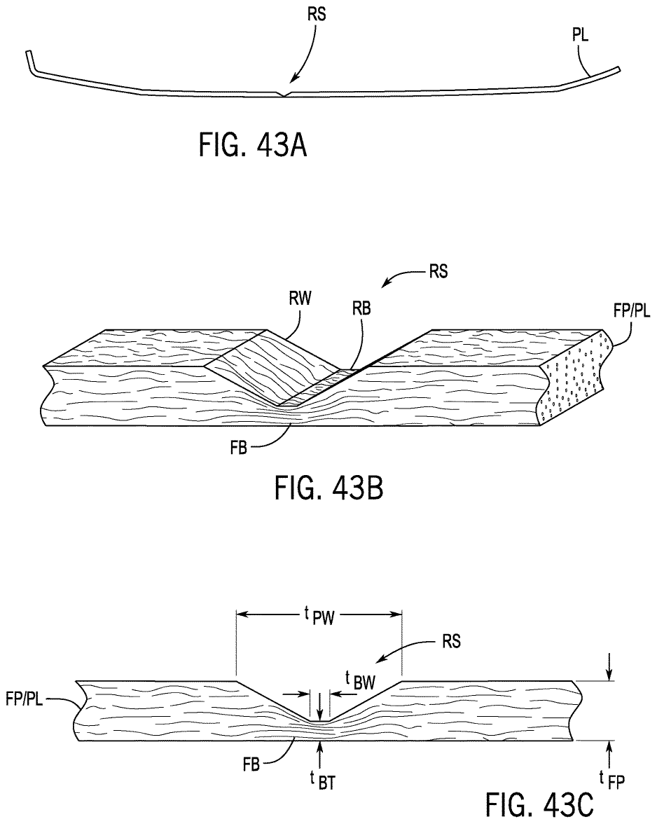

As indicated in FIGS. 43A-43C, the shape/form of the profile of the recess RS in the formed panel PL shown as a fiber panel FP with body/arrangement of aligned fibers FB formed/configured to provide/maintain enhanced rigidity for structural substrate of composite structure CS may comprise a bottom RT and sidewalls RW.

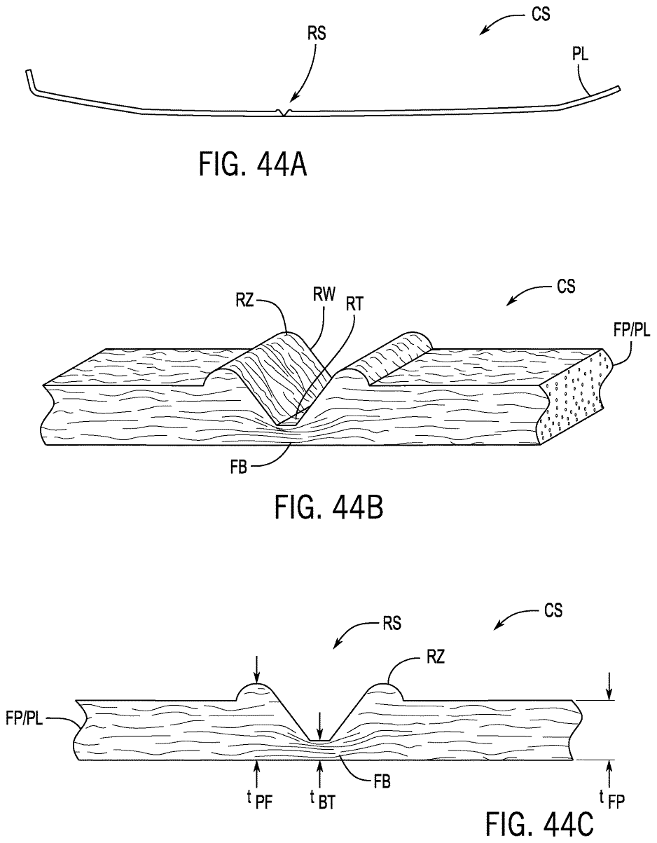

As indicated in FIGS. 44A-44C, the shape/form of the profile of the recess RS in the formed panel PL shown as a fiber panel FP with body/arrangement of aligned fibers FB formed/configured to provide/maintain enhanced rigidity for structural substrate of composite structure CS may comprise a bottom RT and sidewalls RW and a raised area shown as ridge RZ.

As indicated schematically in FIGS. 37C, 41C, 42C, 46A-46B, 47 and 50B, and shape/form of the profile of the recess RS in the formed panel PL shown as a fiber panel FP with body/arrangement of aligned fibers FB formed/configured to provide/maintain enhanced rigidity for structural substrate of composite structure CS may comprise forms such as a multi-sided/multi-segment form (e.g. flat forms) or a curved form or a composite form with sections of differing forms (e.g. flat, curved, etc.); the profile may include and transition section; the profile may comprise a generally symmetrical form or an asymmetrical form; the profile may comprise a generally constant depth or generally variable depth. See also FIGS. 3B, 36A-36D, 37A-37B, 37D, 41A-41B, 41D, 42A-42B, 43A-43C, 44A-44C, 45, 48A-48E, 49A-49F and 50A-50B.

As indicated schematically in FIGS. 36A-36D and 37A-37D and TABLE A, the shape/form of the profile of the recess RS for the formed panel PL shown as a fiber panel FP with body/arrangement of aligned fibers FB formed/configured to provide/maintain enhanced rigidity for structural substrate of composite structure CS may comprise general/nominal/effective dimensions for bottom RT and sidewalls RW and a transition RX relative to general nominal/effective dimensions of the panel PL shown as a fiber panel FP formed from a fiber mat FM. See also FIGS. 3B, 36A-36D, 38A-38B, 39 and 40A-40B.

As indicated schematically in FIGS. 38A-38B, 39 and 40A-40B, the fiber mat FM may comprise a generally nominal thickness (shown as thickness tFM); the fiber panel FP/PL formed from fiber mat FM with body/arrangement of aligned fibers FB formed/configured to provide/maintain enhanced rigidity for structural substrate of composite structure CS may comprise may comprise a base area providing a generally nominal thickness (shown as thickness tFP) and features (e.g. recesses, voids, ridges, etc.) having variations in thickness from the nominal/effective thickness of the base area; features such as formed features providing the profile of recess RS in the fiber panel FP/PL may comprise intended shape/dimensions (e.g. nominal thickness/depth, width, angle, curvature, etc.) and variations at formation in the formed component/component. See also TABLE A and FIGS. 37A-37D, 41A-41D, 42A-42C, 43A-43C and 44A-44C.

According to an exemplary embodiment as shown schematically in FIGS. 2A-2C, 3B, 36A-36D, 37A-37D, 41A-41C, 42A-42C, 43A-43C, 44A-44C, 45, 46A-46B, 47, 48A-48E, 49A-49F and 50A-50B, a component for a vehicle interior configured to facilitate deployment of an airbag through an airbag door may comprise a structural substrate comprising a fiber panel FP/PL with body/arrangement of aligned fibers FB formed/configured to provide/maintain enhanced rigidity for composite structure CS; the fiber panel FP/PL may comprise a base area and weakened area; the weakened area may comprise a recess RS comprising a profile; the profile of the recess may comprise a bottom and a set of walls; the fiber panel has a reduced thickness in the recess at the bottom of the profile; the profile of the recess may be configured to direct the formation of the airbag door at the weakened area of the fiber panel during deployment of the airbag. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL shown as a fiber panel FP with body/arrangement of aligned fibers FB including at center/primary segments and connection interface and lateral/side segments). The weakened area may comprise a generally H-shaped area. The weakened area may comprise a generally U-shaped area. The fiber panel FP/PL may comprise an inner surface and an outer surface; the recess RS comprising the profile may be formed into the inner surface of the fiber panel FP/PL. The recess may be configured to form a seam for an opening through the weakened area of the fiber panel for the airbag door.

According to an exemplary embodiment as shown schematically in FIGS. 3B, 36A-36D, 37A-37D, 41A-41C, 42A-42C, 43A-43C, 44A-44C, 45, 46A-46B, 47, 48A-48E, 49A-49F and 50A-50B, the panel PL formed from fiber panel FP with body/arrangement of aligned fibers FB configured to provide/maintain enhanced rigidity for structural substrate of composite structure CS may comprise a profile; the profile may comprise a multi-side form; the multi-side form may comprise the bottom and the set of side walls; the multi-side form may comprise a generally trapezoidal form; the profile may comprise a variable depth; the profile may comprise a transition section/area; the transition area may comprise a transition into the profile; the transition area may comprise a transition into a generally trapezoidal section of the profile; the transition area may comprise a generally curved form; the transition area may comprise a feature formed adjacent to the recess; the feature may comprise a ridge segment; the transition area may comprise a thickness less than a nominal thickness of the base area of the fiber panel; the transition area may comprise a thickness greater than a nominal thickness of the base area of the fiber panel. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL shown as a fiber panel FP with body/arrangement of aligned fibers FB including at center/primary segments and connection interface and lateral/side segments).

As indicated schematically in FIGS. 36A-36D, 37A-37D, 38A-38B, 39 and 40A-40B, the fiber panel FP/PL with body/arrangement of aligned fibers FB configured to provide/maintain enhanced rigidity for structural substrate of composite structure CS may have a nominal average thickness in the base area and the reduced thickness at the weakened area. See also TABLE A.

According to an exemplary embodiment as shown schematically in FIGS. 3B, 36A-36D, 37A-37D, 41A-41C, 42A-42C, 43A-43C, 44A-44C, 45, 46A-46B, 47, 48A-48E, 49A-49F and 50A-50B, the recess RS for the weakened area in compression-formed panel PL shown as a fiber panel FP with body/arrangement of aligned fibers FB may comprise a center recess and a set of lateral recesses; the weakened area may comprise the set of lateral recesses connected by the center recess; the center recess may comprise a connector; the weakened area may comprise a set of segments; the set of segments may comprise a set of lateral segments connected by a center line; the recess RS may comprise a formed recess; the recess RS may comprise an indentation; the recess RS may comprise a groove; the groove may be formed in the fiber panel FP/PL; the groove may comprise a center groove and a set of lateral grooves; the weakened area may comprise the set of lateral grooves connected by the center groove; the center groove may comprise a connector; the profile may comprise a transition area into the groove; the groove may comprise a wavy line; the bottom may comprise a generally flat bottom; the set of walls may comprise a set of flat tapered walls adjacent to the bottom; the profile may comprise a generally curved form; the profile may comprise a rounded form comprising the bottom and a set of walls adjacent to the bottom; the profile may comprise a multi-segmented form; the profile may comprise a transition area from the base area into the weakened area; the profile may be formed to provide the weakened area in the fiber panel FP/PL. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL shown as a fiber panel FP with body/arrangement of aligned fibers FB including at center/primary segments and connection interface and lateral/side segments).

According to an exemplary embodiment as shown schematically in FIGS. 3B, 36A-36D, 37A-37D, 41A-41C, 42A-42C, 43A-43C, 44A-44C, 45, 46A-46B, 47, 48A-48E, 49A-49F and 50A-50B, the profile of the recess for formed/compression-formed panel PL shown as a fiber panel FP with body/arrangement of aligned fibers FB may have a shape/form provided by sections/segments having size/dimensions (e.g. width, thickness, reduced width, reduced thickness, etc.). See also FIGS. 22A-22B, 23A-23B, 24A-24D, 25A-25C, 26A-26C, 27A-27C, 28A-28B and 29A-29F. The reduced thickness at the bottom of the profile of the recess may comprise between above 0.4 mm and below 0.85 mm. A nominal width of the bottom of the profile of the recess may comprise between about 0.4 mm and 0.6 mm. A nominal width of the bottom of the profile of the recess may comprise between about 0.2 mm and 2.0 mm. The recess may comprise a width across the profile; the width across the profile may comprise between about 5 mm and about 6 mm. The recess may comprise a width across the profile; the width across the profile may comprise greater than 2 mm. The fiber panel may comprise a nominal thickness at the base area of between about 1.5 mm and 1.7 mm. The component may comprise a structure formed onto the fiber panel; the structure may comprise at least one rib; the at least one rib may comprise a set of ribs at the weakened area of the fiber panel. The at least one rib may comprise a nominal height of between about 2.5 mm and about 3.5 mm. The at least one rib may comprise a nominal width of between about 1.5 mm and about 2.0 mm. A distance between the set of ribs may comprise a nominal width of between about 5 mm and about 7 mm. A proportional relationship between a nominal reduced thickness at the bottom of the profile of the recess and a nominal width across the profile may be in a range of between about 5 and about 12. A proportional relationship between a nominal reduced thickness at the bottom of the profile of the recess and a nominal thickness at the base area may be in a range of between about 1.5 and 4. A proportional relationship between a nominal width at the bottom of the profile of the recess and a nominal width across the profile of the recess may be in a range of between about 1.5 and about 12. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be greater than 2. A proportional relationship of a nominal reduced thickness at the bottom of the profile of the recess divided by a nominal thickness at the base area may be in a range of between about 1.5 and 4. A proportional relationship between a nominal width at the bottom of the profile of the recess and a nominal width across the profile of the recess may be in a range of between about 1.5 and about 12. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be greater than 2. A proportional relationship between a nominal width at the bottom of the profile of the recess and a nominal thickness at the bottom of the recess may be in a range of about 1 to 2. A proportional relationship between a nominal width at the bottom of the profile of the recess and a nominal thickness at the bottom of the recess may be in a range of about 0.5 to 3. A nominal width at the bottom of the profile of the recess may be in a range of between about 0.5 and 3 times greater than a nominal thickness at the bottom of the recess. A nominal width across the profile of the recess may be in a range of about 1 to 5 times greater than a nominal thickness of the base area of the fiber panel. A nominal thickness of the base area of the fiber panel may be in a range of between about 1.5 and 3.5 times greater than a nominal thickness of the bottom of the recess. A nominal thickness of the base area of the fiber panel may be in a range of between about 2 and 4 times greater than a nominal width of the bottom of the recess. A nominal width across the profile of the recess may be in a range of about 1 to 12 times greater than a nominal thickness of the bottom of the recess. A nominal width of the bottom of the profile of the recess may comprise between about 0.2 mm and 2.0 mm.

As indicated schematically in FIGS. 2A-2C, 3B and 4A-4L, the recess RS at weakened area in panel FP/PL of composite structure CS of component C may comprise a variety of types of forms of opening/airbag door ABD formed by airbag AB at deployment such as provided by a generally U-shaped groove and/or a generally H-shaped groove; each form of door/opening may comprise a generally continuous form from recess/groove RS at weakened area from a center segment to lateral segments; each segment/section of the recess/groove RS may comprise a profile with a shape/form; the panel may be configured to direct formation of the opening at/along the recess for the weakened area in the shaped form (e.g. to provide an airbag door as a single door or hinged flap/flaps).

As indicated schematically in FIGS. 3B, 36A-36D, 37A-37D, 45, 46A-46B, 47 and 50A-50B, the panel PL may be provided with a structure such as a formed reinforcement/rib RB (e.g. injection molded structure/rib) at/adjacent to the recess RS in the panel PL; as indicated schematically, the structure/rib RB may comprise a provided at the transition RX to the sidewalls RW and bottom RT of the profile of the recess RS. As indicated in FIG. 46B, the structure/rib RB by be separated from the recess RS in the panel PL; as indicated schematically, a gap/area RG may be provided between the structure/rib RB and the transition RX to the sidewalls RW and bottom RT of the profile of the recess RS. See generally FIGS. 36A-36D, 37A-37D, 38A-38B, 39, 40A-40B, 41A-41C, 42A-42C, 43A-43C, 44A-44C, 45, 46A-46B, 47, 48A-48E, 49A-49F and 50A-50B (formed/compression-formed panel shown as a fiber panel with body/arrangement of aligned/laterally-aligned fibers formed/configured to provide/maintain enhanced rigidity for structural substrate of composite structure including across formed recess configured to provide a profile shown as comprising a shape/form with or without formed resin reinforcement/structure on composite structure).

According to an exemplary embodiment as shown schematically in FIGS. 3B, 36A-36D, 37A-37D, 38A-38B, 39, 40A-40B, 41A-41C, 42A-42C, 43A-43C, 44A-44C, 45, 46A-46B, 47, 48A-48E, 49A-49F and 50A-50B, the fiber panel FP may by is formed from a fiber mat FM comprising the body of generally aligned fibers FB to provide the fiber panel FP with the body of generally aligned fibers FB; the fiber panel FP may be compression-formed into a compression-formed panel PL with the recess RS comprising a formed recess maintaining the body of generally aligned fibers FB in the compression-formed panel PL; the structural substrate of the composite structure CS may comprise the compression-formed panel PL of the fiber panel FP with the recess RS and the body of generally aligned fibers FP across the compression-formed panel PL including at the recess RS to provide enhanced rigidity for the structural substrate of the composite structure CS.

According to an exemplary embodiment shown schematically in FIGS. 51A-51C, a composite structure CSx comprising a trim panel PLx may comprise a substrate shown as a fiber panel FPx with a conventional body of fibers FBx (e.g. without alignment/arrangement) with a conventional notch/recess RSx formed in the fibers FBx and fiber panel FPx; as indicated schematically in FIGS. 51A-51C, the recess RSx in the substrate shown as fiber panel FPx may provide a weakened area for formation of a door/opening for deployment of an airbag; as indicated schematically in FIG. 51B, the structure of the substrate shown as fiber panel FPx may be weakened unintentionally by reduction of structural strength at the area of recess RSx due generally to a lack of alignment of the fibers FBx of the fiber panel FPx. Compare FIGS. 36A-36C (composite structure CS with structural substrate shown as fiber panel FP retains structural strength at the area of recess RS due generally to lateral alignment of the fibers FB of the fiber panel FP).

As shown schematically in FIGS. 2A-2C and 3A-3B, the component may comprise at least one of a trim panel, an instrument panel, a door panel, a pillar, a console, etc.

### Exemplary Embodiments-B

As indicated schematically in FIGS. 1A-1B, a vehicle V is shown to comprise an interior I with components C such as an instrument panel, door/door panels and a floor console; components of vehicle such as instrument panel and door panels may include trim components/panels comprised of fiber and plastic; instrument panel and door panels may provide visible surfaces in the vehicle interior of vehicle; vehicle interior/trim components such as instrument panel and/or door panels may provide at least one airbag behind the visible surfaces; instrument panel and/or door panels may provide a weakened area to aid the airbag in breaking through the trim component/panel during airbag deployment. See FIGS. 2A-2C, 3A-3B and 4A-4L.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, a component for a vehicle interior configured to facilitate deployment of an airbag through an airbag door may comprise a structural substrate comprising a fiber panel FP/PL; the fiber panel FP/PL may comprise a base area and weakened area; the weakened area may comprise a recess RS comprising a profile; the profile of the recess may comprise a bottom and a set of walls; the fiber panel has a reduced thickness in the recess at the bottom of the profile; the profile of the recess may be configured to direct the formation of the airbag door at the weakened area of the fiber panel during deployment of the airbag. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL including at center/primary segments and connection interface and lateral/side segments). The weakened area may comprise a generally H-shaped area. The weakened area may comprise a generally U-shaped area. The fiber panel FP/PL may comprise an inner surface and an outer surface; the recess RS comprising the profile may be formed into the inner surface of the fiber panel FP/PL. The recess may be configured to form a seam for an opening through the weakened area of the fiber panel for the airbag door.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, the profile may comprise a multi-side form; the multi-side form may comprise the bottom and the set of side walls; the multi-side form may comprise a generally trapezoidal form; the profile may comprise a variable depth; the profile may comprise a transition section/area; the transition area may comprise a transition into the profile; the transition area may comprise a transition into a generally trapezoidal section of the profile; the transition area may comprise a generally curved form; the transition area may comprise a feature formed adjacent to the recess; the feature may comprise a ridge segment; the transition area may comprise a thickness less than a nominal thickness of the base area of the fiber panel; the transition area may comprise a thickness greater than a nominal thickness of the base area of the fiber panel. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL including at center/primary segments and connection interface and lateral/side segments).

As indicated schematically in FIGS. 9A-9B, the fiber panel FP/PL may have a nominal average thickness in the base area and the reduced thickness at the weakened area. See also TABLE A.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, the recess RS for the weakened area may comprise a center recess and a set of lateral recesses; the weakened area may comprise the set of lateral recesses connected by the center recess; the center recess may comprise a connector; the weakened area may comprise a set of segments; the set of segments may comprise a set of lateral segments connected by a center line; the recess RS may comprise a formed recess; the recess RS may comprise an indentation; the recess RS may comprise a groove; the groove may be formed in the fiber panel FP/PL; the groove may comprise a center groove and a set of lateral grooves; the weakened area may comprise the set of lateral grooves connected by the center groove; the center groove may comprise a connector; the profile may comprise a transition area into the groove; the groove may comprise a wavy line; the bottom may comprise a generally flat bottom; the set of walls may comprise a set of flat tapered walls adjacent to the bottom; the profile may comprise a generally curved form; the profile may comprise a rounded form comprising the bottom and a set of walls adjacent to the bottom; the profile may comprise a multi-segmented form; the profile may comprise a transition area from the base area into the weakened area; the profile may be formed to provide the weakened area in the fiber panel FP/PL. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL including at center/primary segments and connection interface and lateral/side segments).

As indicated schematically in FIGS. 5B-5D, 10G, 17, 18A-18B, 19 and 34B, the component may comprise a structure formed on the fiber panel FP/PL; the structure may comprise an injection-molded resin; the structure may comprise a set of ribs at the weakened area of the fiber panel FP/PL; the set of ribs may be configured to direct the formation of the airbag door. Fiber of the fiber panel FP/PL may be at least partially intermingled with the resin of the structure.

The fiber panel FP/PL may comprise a compression-formed fiber panel. The component may comprise a panel comprising the fiber panel; the panel may comprise at least one of (a) a resin; (b) a thermoplastic resin; (c) polypropylene; (d) acrylonitrile butadiene styrene; (e) polycarbonate.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, the recess RS may comprise at least one of (a) a tear line configured to establish an opening for deployment of the airbag; (b) a weakened/weakening line configured to establish an opening for deployment of the airbag. The component may comprise a cover on the fiber panel; the weakened area may not be generally visible at the cover. See also FIGS. 2A-2C.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, the profile of the recess may have a shape/form provided by sections/segments having size/dimensions (e.g. width, thickness, reduced width, reduced thickness, etc.). See also FIGS. 22A-22B, 23A-23B, 24A-24D, 25A-25C, 26A-26C, 27A-27C, 28A-28B and 29A-29F. The reduced thickness at the bottom of the profile of the recess may comprise between above 0.4 mm and below 0.85 mm. A nominal width of the bottom of the profile of the recess may comprise between about 0.4 mm and 0.6 mm. A nominal width of the bottom of the profile of the recess may comprise between about 0.2 mm and 2.0 mm. The recess may comprise a width across the profile; the width across the profile may comprise between about 5 mm and about 6 mm. The recess may comprise a width across the profile; the width across the profile may comprise greater than 2 mm. The fiber panel may comprise a nominal thickness at the base area of between about 1.5 mm and 1.7 mm. The component may comprise a structure formed onto the fiber panel; the structure may comprise at least one rib; the at least one rib may comprise a set of ribs at the weakened area of the fiber panel. The at least one rib may comprise a nominal height of between about 2.5 mm and about 3.5 mm. The at least one rib may comprise a nominal width of between about 1.5 mm and about 2.0 mm. A distance between the set of ribs may comprise a nominal width of between about 5 mm and about 7 mm. A proportional relationship between a nominal reduced thickness at the bottom of the profile of the recess and a nominal width across the profile may be in a range of between about 5 and about 12. A proportional relationship between a nominal reduced thickness at the bottom of the profile of the recess and a nominal thickness at the base area may be in a range of between about 1.5 and 4. A proportional relationship between a nominal width at the bottom of the profile of the recess and a nominal width across the profile of the recess may be in a range of between about 1.5 and about 12. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be greater than 2. A proportional relationship of a nominal reduced thickness at the bottom of the profile of the recess divided by a nominal thickness at the base area may be in a range of between about 1.5 and 4. A proportional relationship between a nominal width at the bottom of the profile of the recess and a nominal width across the profile of the recess may be in a range of between about 1.5 and about 12. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be greater than 2. A proportional relationship between a nominal width at the bottom of the profile of the recess and a nominal thickness at the bottom of the recess may be in a range of about 1 to 2. A proportional relationship between a nominal width at the bottom of the profile of the recess and a nominal thickness at the bottom of the recess may be in a range of about 0.5 to 3. A nominal width at the bottom of the profile of the recess may be in a range of between about 0.5 and 3 times greater than a nominal thickness at the bottom of the recess. A nominal width across the profile of the recess may be in a range of about 1 to 5 times greater than a nominal thickness of the base area of the fiber panel. A nominal thickness of the base area of the fiber panel may be in a range of between about 1.5 and 3.5 times greater than a nominal thickness of the bottom of the recess. A nominal thickness of the base area of the fiber panel may be in a range of between about 2 and 4 times greater than a nominal width of the bottom of the recess. A nominal width across the profile of the recess may be in a range of about 1 to 12 times greater than a nominal thickness of the bottom of the recess. A nominal width of the bottom of the profile of the recess may comprise between about 0.2 mm and 2.0 mm. The component may comprise at least one of (a) a trim panel; (b) an instrument panel; (c) a door panel; (d) a pillar.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, a component for a vehicle interior configured to facilitate deployment of an airbag through an airbag door may comprise a fiber panel comprising a base area and weakened area; the weakened area may comprise a recess comprising a multi-sided profile; the multi-sided profile of the recess may comprise a bottom and a set of walls; the fiber panel may have a reduced thickness in the recess at the bottom of the profile; the profile of the recess may be configured to direct the formation of the airbag door at the weakened area of the fiber panel during deployment of the airbag through the fiber panel; the component may comprise a cover on the fiber panel. As indicated schematically in FIGS. 5B-5D, 10G, 17, 18A-18B, 19 and 34B, the component may comprise a structure formed onto the fiber panel; the structure may comprise an injection-molded resin; the structure may comprise a set of ribs at the weakened area of the fiber panel; the set of ribs may be configured to direct the formation of the airbag door.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, a component for a vehicle interior configured to facilitate deployment of an airbag may comprise a panel comprising fibers; the panel may comprise a front side providing a surface and a rear side configured for contact from the airbag to establish an opening for deployment of the airbag; the panel may comprise a recess in the rear side of the panel to establish the opening for deployment of the airbag and direct deployment of the airbag through the panel; the front side of the panel may comprise a substantially planar surface opposite the recess; the panel comprising fibers may comprise a compressed fiber panel; the recess may be formed as a depression in the rear side of the panel or an indentation in the rear side of the panel. According to an exemplary embodiment shown schematically in FIGS. 30A-30E, 31A-31E and 33A-33F, the recess may be formed in a mold by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side. The recess may comprise a path comprising at least one of (a) a continuous wave portion comprising a periodic function; (b) a sinusoidal shape. The panel may comprise at least one of (a) a resin; (b) a thermoplastic resin; (c) polypropylene; (d) acrylonitrile butadiene styrene; (e) polycarbonate.

As indicated in FIGS. 5B-5D, 10G, 17, 18A-18B, 19 and 34B, the panel may comprise a resin rib formed on the panel adjacent the recess at the rear side of the panel; the resin rib may be configured to direct deployment of the airbag through the panel. The resin rib may extend from the recess below the rear side of the panel.

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, the recess may comprise a path comprising a connector between generally parallel segments; the connector may comprise a generally sinusoidal shape; the panel may comprise a rib adjacent the connector of the recess at the rear side of the panel; the rib may comprise a generally sinusoidal shape; the rib may comprise a first rib on a side of the connector and a second rib on an opposite side of the connector; the recess may comprise a cavity comprising a cross-sectional profile; the cross-sectional profile of the cavity may comprise a depth within the panel; the cross-sectional profile of the cavity may comprise a set of facets; the set of facets may comprise a first set of connected facets opposite a second set of connected facets; the set of facets may comprise a floor facet connecting the first set of connected facets and the second set of connected facets; the floor facet may comprise a surface generally parallel to the front side of the panel; the cross-sectional profile of cavity may comprise at least one of (a) a bevel; (b) a fillet; (c) a chamfer; the cross-sectional profile of the cavity may comprise a wall and a floor; the floor may be generally parallel to the surface of the front side of the panel; the cross-sectional profile of cavity may comprise at least one angled surface connecting the wall and the floor; the wall may comprise at least two generally planar surfaces; the wall may comprise a first surface and a second surface; the second surface may extend from the floor to the first surface; the first surface may extend from the second surface to the rear side of the panel; the wall may comprise a first generally planar wall connected to a second generally planar wall at a radius; the recess may comprise a width at the rear side of the panel; the floor may comprise a width less than the width of the recess at the rear side of the panel. See also FIGS. 22A-22B, 23A-23B, 24A-24D, 25A-25C, 26A-26C, 27A-27C, 28A-28B and 29A-29F (schematic diagrams of variation of the weakened area along segments of recess RS in the panel PL including at center/primary segments and connection interface and lateral/side segments).

According to an exemplary embodiment as shown schematically in FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, a component for a vehicle interior configured to facilitate deployment of an airbag may comprise a panel comprising fibers; the panel may comprise a front side providing a surface and a rear side configured for contact from the airbag to establish an opening for deployment of the airbag; the panel may comprise a recess formed as a depression in the rear side of the panel to establish the opening for deployment of the airbag and direct deployment of the airbag through the panel; the front side of the panel may comprise a substantially planar surface opposite the recess; the recess may be formed as an indentation in the rear side of the panel; the recess may comprise a depth within the panel; the recess may comprise a set of facets; the set of facets may comprise a floor facet connecting a first set of connected facets and a second set of connected facets; the floor facet may comprise a surface generally parallel to the front side of the panel; the recess may comprise a wall and a floor and at least one angled surface connecting the wall and the floor. See also FIGS. 22A-22B, 23A-23B, 24A-24D, 25A-25C, 26A-26C, 27A-27C, 28A-28B and 29A-29F (schematic diagrams of variation of the weakened area along segments of recess in the panel including at center/primary segments and connection interface and lateral/side segments).

According to an exemplary embodiment shown schematically in FIGS. 30A-30E, 31A-31E and 33A-33F, a vehicle interior component formed in a mold and configured to facilitate deployment of an airbag from an airbag module may comprise a panel comprising a fiber panel. See also FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B. The fiber panel may comprise a base area and weakened area; the weakened area may comprise a recess; the recess may comprise a multi-sided profile; the multi-sided profile of the recess may comprise a bottom and a set of walls; the fiber panel has a reduced thickness in the recess at the bottom of the profile; the profile of the recess may be configured to direct the formation of the airbag door at the weakened area of the fiber panel during deployment of the airbag through the fiber panel. The recess may be formed by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side; and (c) filling a depression of the mold with material of the fiber panel to form a protrusion at the rear side. The panel may comprise at least one of (a) a resin; (b) a thermoplastic resin; (c) polypropylene; (d) acrylonitrile butadiene styrene; (e) polycarbonate. The recess may comprise a notch configured to direct deployment of the airbag through the panel. The feature may comprise a protrusion configured to provide a relief for the notch.

According to an exemplary embodiment shown schematically in FIGS. 30A-30E, 31A-31E and 33A-33F, a method of manufacturing a vehicle interior component may comprise (a) providing a mold comprising a first surface and a second surface comprising a protrusion and a depression; (b) disposing a fiber panel comprising a first side and a second side onto the first surface of a mold; (c) compressing at least a first portion of the fiber panel between the first surface and the second surface of the mold; (d) penetrating material of the fiber panel at the first side of the panel with the protrusion of the second surface of the mold to push material of the fiber panel aside to form a notch in the first side of the fiber panel and maintain a continuous surface at the second side of the fiber panel; and (e) filling the depression of the second surface of the mold with material of the fiber panel to form a protrusion at the first side of the fiber panel. The fiber panel may comprise a base area and weakened area; the weakened area may comprise the notch; the notch may comprise a recess; the recess may comprise a multi-sided profile; the multi-sided profile of the recess may comprise a bottom and a set of walls; the fiber panel has a reduced thickness in the recess at the bottom of the profile; the profile of the recess may be configured to direct the formation of the airbag door at the weakened area of the fiber panel during deployment of the airbag through the fiber panel. See also FIGS. 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B. The method may comprise a step of injecting resin into the mold at the depression of the second surface of the mold to form a rib.

### Exemplary Embodiments-C

As indicated schematically in FIGS. 1A-1B, a vehicle may include an interior with vehicle interior components shown as an instrument panel, door/door panels and a floor console. According to an exemplary embodiment, components of vehicles such as instrument panel and door panels may include trim components/panels comprised of fiber and plastic. According to an exemplary embodiment, instrument panel and door panels may provide visible surfaces in the vehicle interior of vehicle. According to an exemplary embodiment, vehicle interior/trim components such as instrument panel and/or door panels may provide at least one airbag behind the visible surfaces; instrument panel and/or door panels may provide a weakened area to aid the airbag in breaking through the trim component/panel during airbag deployment. See FIGS. 2A-2C, 3A-3B and 4A-4L.

According to an exemplary embodiment as shown schematically in 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, a component for a vehicle interior configured to facilitate deployment of an airbag through an airbag door may comprise a structural substrate comprising a fiber panel. The fiber panel may comprise a base area and weakened area. The weakened area may comprise a recess comprising a profile. The profile of the recess may comprise a bottom and a set of walls. The fiber panel may have a reduced thickness in the recess at the bottom of the profile. The profile of the recess may be configured to direct the formation of the airbag door at the weakened area of the fiber panel during deployment of the airbag. The weakened area may comprise a generally H-shaped area. The weakened area may comprise a generally U-shaped area. The fiber panel may comprise an inner surface and an outer surface. The recess may be formed into the inner surface of the fiber panel. The recess comprising the profile may be formed into the inner surface of the fiber panel. The recess may be configured to form a seam for an opening for the airbag door. The seam may be configured to form a tear line for an opening for the airbag door. The recess may be configured to form a seam for an opening through the weakened area of the fiber panel for the airbag door. The profile may comprise a generally trapezoidal form. The profile may comprise a multi-feature form. The profile may comprise a multi-faceted form. The profile may comprise a multi-side form. The multi-side form may comprise the bottom and the set of side walls. The multi-side form may comprise a generally trapezoidal form. The multi-side form may comprise a generally symmetrical form. The profile may comprise a variable profile. The profile may comprise a variable depth. The weakened area may comprise a transition area. The weakened area may comprise a transition section. The profile may comprise a transition section. The profile may comprise a transition area. The transition area may comprise a transition into the profile. The transition area may comprise a transition into a generally trapezoidal section of the profile. The transition area may comprise a generally curved form. The transition area may comprise a feature formed adjacent to the recess. The transition area may comprise a thickness less than a nominal thickness of the base area of the fiber panel. The transition area may comprise a thickness greater than a nominal thickness of the base area of the fiber panel. The transition area may comprise a reduced thickness segment. The transition area may comprise a ridge segment. The transition area may comprise a ridge adjacent to the profile of the recess. The recess may comprise a width. The recess may comprise a width across the profile. The fiber panel may have a nominal average thickness in the base area and the reduced thickness at the weakened area. The recess for the weakened area may comprise a center recess and a set of lateral recesses. The weakened area may comprise the set of lateral recesses connected by the center recess. The center recess may comprise a connector. The weakened area may comprise a set of segments. The set of segments may comprise a set of lateral segments. The set of segments may comprise a center segment. The set of segments may comprise a set of lateral segments connected by the segment line. The set of segments may comprise a set of lines. The weakened area may comprise a set of lines. The set of lines may comprise a set of lateral lines. The set of lines may comprise a center line. The set of lines may comprise a set of lateral lines connected by the center line. The recess may comprise a formed recess. The recess may comprise an indentation. The indentation may comprise a groove. The recess may comprise a cavity. The recess may comprise a notch. The recess may comprise a groove. The groove may comprise a line. The groove may comprise a wavy line. The groove may comprise a set of grooves. The groove may comprise a set of lateral grooves. The groove may comprise a center groove. The groove may comprise a center groove and a set of lateral grooves. The weakened area may comprise the set of lateral grooves connected by the center groove. The center groove may comprise a connector. The bottom may comprise a generally flat bottom. The bottom may comprise a generally curved bottom. The set of walls may comprise a set of angled walls. The set of walls may comprise a set of flat walls. The set of walls may comprise a set of flat angled walls. The set of walls may comprise a set of flat tapered walls. The set of walls may comprise a set of flat tapered walls adjacent to the bottom. The profile may comprise a generally curved form. The profile may comprise a rounded form. The profile may comprise a rounded form comprising the bottom and the set of walls adjacent to the bottom. The profile may comprise a segmented form. The profile may comprise a multi-segmented form. The profile may comprise a generally continuous form. The profile may comprise a transition area into the groove. The profile may comprise a transition area from the base area into the weakened area. The groove may be formed in the fiber panel. The profile may be formed in the fiber panel. The profile may be formed to provide the weakened area in the fiber panel. The component may comprise a structure formed onto the fiber panel. The structure may comprise a resin. The resin may comprise an injection-molded resin. The structure may comprise a set of ribs at the weakened area of the fiber panel. The set of ribs may be configured to direct the formation of the airbag door. The set of ribs may comprise a resin material; the fiber panel may comprise fibers. The set of ribs may comprise a resin material; the fiber panel may comprise fibers; the set of ribs may be formed on the fiber panel. The set of ribs may comprise a resin material; the fiber panel may comprise fibers; the set of ribs may be formed on the fiber panel; the resin material of the set of ribs may be at least partially mixed with fiber of the fiber panel. The set of ribs may comprise a resin material; the fiber panel may comprise fibers; the set of ribs may be formed on the fiber panel; fiber of the fiber panel may be at least partially mixed into the resin material of the set of ribs. The set of ribs may comprise a resin material; the fiber panel may comprise fibers; the set of ribs may be formed on the fiber panel; fiber of the fiber panel may be at least partially intermingled with the resin material of the set of ribs. The component may comprise an airbag chute for deployment of the airbag. The airbag chute may be disconnected from the structure. The fiber panel may comprise a compression-formed fiber panel. The component may comprise a panel comprising the fiber panel; the panel may comprise at least one of (a) a resin; (b) a thermoplastic resin; (c) at least one of (a) a tear line configured to establish an opening for deployment of the airbag; (b) a weakened/weakening line configured to establish an opening for deployment of the airbag. The airbag door may be formed as an opening in the fiber panel. The component may comprise a cover on the fiber panel. The weakened area may not be generally visible at the cover. The airbag may be configured to deploy through an airbag door formed at the front of a trim panel. The airbag may be configured to deploy through an airbag door formed at the bottom of a trim panel. The nominal reduced thickness at the bottom of the profile of the recess may comprise between 0.4 mm and 0.8 mm. The reduced thickness at the bottom of the profile of the recess may comprise between above 0.4 mm and below 0.85 mm. The reduced thickness at the bottom of the profile of the recess may comprise between above 0.45 mm and below 0.65 mm. The reduced thickness at the bottom of the profile of the recess may comprise between about 0.45 mm and 0.65 mm. The reduced thickness at the bottom of the profile of the recess may comprise between above about 0.45 mm and below about 0.75 mm. The nominal reduced thickness at the bottom of the profile of the recess may comprise about 0.5 mm. The nominal reduced thickness at the bottom of the profile of the recess may comprise about 0.55 mm. A nominal width of the bottom of the profile of the recess may comprise between about 0.4 mm and 0.6 mm. A nominal width of the bottom of the profile of the recess may comprise between about 0.2 mm and 2.0 mm. The recess may comprise a width. The recess may comprise a width across the profile; the width across the profile may comprise between about 5 mm and about 6 mm. The recess may comprise a width across the profile; the width across the profile may comprise greater than 2 mm. The recess may comprise a width across the profile; the width across the profile may comprise greater than 3 mm. The fiber panel may comprise a nominal thickness at the base area of at least about 1.5 mm. The fiber panel may comprise an effective nominal thickness at the base area of at least about 1.5 mm. The fiber panel may comprise a nominal thickness at the base area of between about 1.5 mm and 1.7 mm. The fiber panel may comprise a nominal thickness at the base area of about 1.7 mm. The fiber panel may comprise a nominal thickness at the base area of about 1.5 mm. The fiber panel may comprise a nominal thickness at the base area of less than about 2.0 mm. The component may comprise a structure formed onto the fiber panel; the structure may comprise at least one rib. The at least one rib may comprise an injection-molded resin. The at least one rib may comprise a set of ribs at the weakened area of the fiber panel. The at least one rib may comprise a nominal height of between about 2.5 mm and about 3.5 mm. The at least one rib may comprise a nominal width of between about 1.5 mm and about 2.0 mm. A distance between the set of ribs may comprise a nominal width of between about 5 mm and about 7 mm. A distance across the set of ribs may comprise a nominal width of between about 8 mm and about 9 mm. A distance across the set of ribs may comprise a nominal width varying between about 8 mm and about 9 mm. A proportional relationship between a nominal reduced thickness at the bottom of the profile of the recess and a nominal width across the profile may be in a range of between about 5 and about 12. A proportional relationship between a nominal reduced thickness at the bottom of the profile of the recess and a nominal width across the profile may be in a range of between about 8 and about 12. A proportional relationship between a nominal reduced thickness at the bottom of the profile of the recess and a nominal width across the profile may be about 10. A proportional relationship between a nominal reduced thickness at the bottom of the profile of the recess and a nominal thickness at the base area may be in a range of between about 2 and 3. A proportional relationship between a nominal reduced thickness at the bottom of the profile of the recess and a nominal thickness at the base area may be in a range of between about 1.5 and 4. A proportional relationship between a nominal reduced thickness at the bottom of the profile of the recess and a nominal thickness at the base area may be about 2. A proportional relationship between a nominal reduced thickness at the bottom of the profile of the recess and a nominal thickness at the base area may be about 3. A proportional relationship between a nominal width at the bottom of the profile of the recess and a nominal width across the profile of the recess may be in a range of between about 1.5 and about 12. A proportional relationship between a nominal width at the bottom of the profile of the recess and a nominal width across the profile of the recess may be about 10. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be in a range of between about 3 and 4. A proportional relationship between a nominal thickness of the base area of the fiber panel and a nominal width across the profile of the recess may be greater than 2. A proportional relationship of a nominal reduced thickness at the bottom of the profile of the recess divided by a nominal thickness at the base area may be in a range of between about 1.5 and 4. A proportional relationship of a nominal reduced thickness at the bottom of the profile of the recess divided a nominal thickness at the base area may be about 2. A proportional relationship of a nominal reduced thickness at the bottom of the profile of the recess divided by a nominal thickness at the base area may be about 3. A proportional relationship between a nominal width at the bottom of the profile of the recess and a nominal width across the profile of the recess may be in a range of between about 1.5 and about 12. A proportional relationship between a nominal width at the bottom of the profile of the recess and a nominal width across the profile of the recess may be about 10. A proportional relationship between a nominal thickness of the base area of the fiber panel and a nominal width across the profile of the recess may be in a range of between about 1 and 5. A proportional relationship between a nominal thickness of the base area of the fiber panel and a nominal width across the profile of the recess may be in a range of between about 3 and 4. A proportional relationship between a nominal thickness of the base area of the fiber panel and a nominal width across the profile of the recess may be greater than 2. A proportional relationship between a nominal width at the bottom of the profile of the recess and a nominal thickness at the bottom of the recess may be in a range of about 1 to 2. A proportional relationship between a nominal width at the bottom of the profile of the recess and a nominal thickness at the bottom of the recess may be in a range of about 0.5 to 3. A proportional relationship between a nominal width at the bottom of the profile of the recess and a nominal thickness at the bottom of the recess may be about 1. A nominal width at the bottom of the profile of the recess may be in a range of between about 0.5 and 3 times greater than a nominal thickness at the bottom of the recess. A nominal width at the bottom of the profile of the recess may be substantially equal to a nominal thickness at the bottom of the recess. A nominal width at the bottom of the profile of the recess may be greater than a nominal thickness at the bottom of the recess. A nominal width at the bottom of the profile of the recess may be less than a nominal thickness at the bottom of the recess. A nominal width at the bottom of the profile of the recess may be no more than 0.5 mm less than a nominal thickness at the bottom of the recess. A nominal width across the profile of the recess may be in a range of about 1 to 5 times greater than a nominal thickness of the base area of the fiber panel. A nominal width across the profile of the recess may be in a range of about 1 to 5 times greater than a nominal thickness of the base area of the fiber panel. A nominal width across the profile of the recess may be less than a nominal thickness of the base area of the fiber panel. A nominal width across the profile of the recess may be greater than a nominal thickness of the base area of the fiber panel. A nominal thickness of the base area of the fiber panel may be in a range of between about 1.5 and 3.5 times greater than a nominal thickness of the bottom of the recess. A nominal thickness of the base area of the fiber panel may be in a range of between about 2 and 3 times greater than a nominal thickness of the bottom of the recess. A nominal thickness of the base area of the fiber panel may be greater than a nominal thickness of the bottom of the recess. A nominal thickness of the base area of the fiber panel may be at least 1 mm greater than a nominal thickness of the bottom of the recess. A nominal thickness of the base area of the fiber panel may be in a range of between about 1 and 3 times greater than a nominal width of the bottom of the recess. A nominal thickness of the base area of the fiber panel may be in a range of between about 2 and 4 times greater than a nominal width of the bottom of the recess. A nominal thickness of the base area of the fiber panel may be greater than a nominal width of the bottom of the recess. A nominal thickness of the base area of the fiber panel may be at least 1 mm greater than a nominal width of the bottom of the recess. A nominal width across the profile of the recess may be in a range of about 1 to 12 times greater than a nominal thickness of the bottom of the recess. A nominal width across the profile of the recess may be in a range of about 2 to 10 times greater than a nominal thickness of the bottom of the recess. A nominal width across the profile of the recess may be less than a nominal thickness of the bottom of the recess. A nominal width across the profile of the recess may be greater than a nominal thickness of the bottom of the recess. A nominal width across the profile of the recess may be in a range of about 1.5 to 12 times greater than a nominal width of the bottom of the recess. A nominal width across the profile of the recess may be in a range of about 2 to 10 times greater than a nominal width of the bottom of the recess. A nominal width across the profile of the recess may be at least 1 mm greater than a nominal width of the bottom of the recess. A nominal width of the bottom of the profile of the recess may comprise between about 0.2 mm and 2.0 mm. The component may comprise an airbag chute; the airbag chute may be disconnected from the structure. The component may comprise at least one of (a) a trim panel; (b) an instrument panel; (c) a door panel; (d) a pillar.

According to an exemplary embodiment as shown schematically in the FIGURES, a component for a vehicle interior configured to facilitate deployment of an airbag through an airbag door may comprise a fiber panel comprising a base area and weakened area. The weakened area may comprise a recess comprising a multi-sided profile. The multi-sided profile of the recess may comprise a bottom and a set of walls. The fiber panel may have a reduced thickness in the recess at the bottom of the profile. The profile of the recess may be configured to direct the formation of the airbag door at the weakened area of the fiber panel during deployment of the airbag through the fiber panel. The component may comprise a cover on the fiber panel. The component may comprise a structure formed onto the fiber panel. The structure may comprise an injection-molded resin. The structure may comprise a set of ribs at the weakened area of the fiber panel. The set of ribs may be configured to direct the formation of the airbag door.

According to an exemplary embodiment as shown schematically in the FIGURES, a component for a vehicle interior configured to facilitate deployment of an airbag may comprise a panel comprising fibers. The panel may comprise a front side providing a surface and a rear side configured for contact from the airbag to establish an opening for deployment of the airbag. The panel may comprise a recess in the rear side of the panel to establish the opening for deployment of the airbag and direct deployment of the airbag through the panel. The front side of the panel may comprise a substantially planar surface opposite the recess. The panel comprising fibers may comprise a compressed fiber panel. The recess may be formed as a depression in the rear side of the panel. The recess may be formed as an indentation in the rear side of the panel. The recess may be formed in a mold by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side. The recess may comprise a generally H-shaped arrangement comprising a connector between generally parallel segments; the connector may comprise a generally sinusoidal shape. The recess may comprise a generally U-shaped arrangement comprising a connector between generally parallel segments; the connector may comprise a generally sinusoidal shape. The recess may comprise a path comprising a continuous wave portion comprising a periodic function. The recess may comprise a path comprising a sinusoidal shape. The panel may comprise at least one of (a) a resin; (b) a thermoplastic resin; (c) polypropylene; (d) acrylonitrile butadiene styrene; (e) polycarbonate. The panel may comprise a rib adjacent the recess at the rear side of the panel. The rib may be configured to direct deployment of the airbag through the panel. The rib may be formed on the panel. The rib may comprise a resin material. The rib may extend from the recess. The rib may comprise a height below the rear side of the panel; the recess may comprise a cavity in the panel comprising a depth. The recess may comprise a path comprising a connector between generally parallel segments; the connector may comprise a generally sinusoidal shape; the panel may comprise a rib adjacent the connector of the recess at the rear side of the panel; the rib may comprise a generally sinusoidal shape. The rib may comprise a first rib on a side of the connector and a second rib on an opposite side of the connector. The rib may comprise a resin material and the rib may extend from the recess. The recess may comprise a cavity comprising a cross-sectional profile. The profile of the cavity may comprise a depth within the panel. The profile of the cavity may comprise a set of facets. The set of facets may comprise a first set of connected facets opposite a second set of connected facets. The set of facets may comprise a floor facet connecting the first set of connected facets and the second set of connected facets. The floor facet may comprise a surface generally parallel to the front side of the panel. The profile of the cavity may comprise an angled surface. The profile of the cavity may comprise a multi-faceted shape. The profile of cavity may comprise at least one of (a) a bevel; (b) a fillet; (c) a chamfer. The profile of the cavity may comprise a wall and a floor. The profile of cavity may comprise at least one angled surface connecting the wall and the floor. The floor may be generally parallel to the surface of the front side of the panel. The wall may comprise at least two generally planar surfaces. The wall may comprise a first surface and a second surface; the second surface may extend from the floor to the first surface. The first surface may extend from the second surface to the rear side of the panel. The wall may comprise a first generally planar wall connected to a second generally planar wall. The recess may comprise a width at the rear side of the panel; the floor may comprise a width less than the width of the recess at the rear side of the panel. The recess may comprise at least one of (a) a tear line configured to establish an opening for deployment of the airbag; (b) a weakening line configured to establish an opening for deployment of the airbag. The component may comprise at least one of (a) a trim panel; (b) an instrument panel; (c) a door panel; (d) a pillar.

According to an exemplary embodiment as shown schematically in the FIGURES, a component for a vehicle interior configured to facilitate deployment of an airbag may comprise a panel comprising fibers. The panel may comprise a front side providing a surface and a rear side configured for contact from the airbag to establish an opening for deployment of the airbag. The panel may comprise a recess formed as a depression in the rear side of the panel to establish the opening for deployment of the airbag and direct deployment of the airbag through the panel. The front side of the panel may comprise a substantially planar surface opposite the recess. The recess may be formed as an indentation in the rear side of the panel. The recess may be formed in a mold by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side. The recess may comprise a generally H-shaped arrangement comprising a connector between generally parallel segments; the connector may comprise a generally sinusoidal shape. The recess may comprise a generally U-shaped arrangement comprising a connector between generally parallel segments; the connector may comprise a generally sinusoidal shape. The recess may comprise a path comprising a continuous wave portion comprising a periodic function. The recess may comprise a path comprising a sinusoidal shape. The panel may comprise at least one of (a) a resin; (b) a thermoplastic resin; (c) polypropylene; (d) acrylonitrile butadiene styrene; (e) polycarbonate. The panel may comprise a rib adjacent the recess at the rear side of the panel. The rib may be configured to direct deployment of the airbag through the panel. The rib may be formed on the panel. The rib may comprise a resin material. The rib may extend from the recess. The rib may comprise a height below the rear side of the panel; the recess may comprise a cavity in the panel comprising a depth. The recess may comprise a path comprising a connector between generally parallel segments; the connector may comprise a generally sinusoidal shape; the panel may comprise a rib adjacent the connector of the recess at the rear side of the panel; the rib may comprise a generally sinusoidal shape. The rib may comprise a first rib on a side of the connector and a second rib on an opposite side of the connector. The rib may comprise a resin material. The rib may extend from the recess. The recess may comprise a cavity comprising a cross-sectional profile. The profile of the cavity may comprise a depth within the panel. The profile of the cavity may comprise a set of facets. The set of facets may comprise a first set of connected facets opposite a second set of connected facets. The set of facets may comprise a floor facet connecting the first set of connected facets and the second set of connected facets. The floor facet may comprise a surface generally parallel to the front side of the panel. The profile of the cavity may comprise an angled surface. The profile of the cavity may comprise a multi-faceted shape. The profile of cavity may comprise at least one of (a) a bevel; (b) a fillet; (c) a chamfer. The profile of the cavity may comprise a wall and a floor. The profile of the cavity may comprise at least one angled surface connecting the wall and the floor. The floor may be generally parallel to the surface of the front side of the panel. The wall may comprise at least two generally planar surfaces. The wall may comprise a first surface and a second surface; the second surface may extend from the floor to the first surface. The first surface may extend from the second surface to the rear side of the panel. The wall may comprise a first generally planar wall connected to a second generally planar wall. The recess may comprise a width at the rear side of the panel; the floor may comprise a width less than the width of the recess at the rear side of the panel. The recess may comprise at least one of (a) a tear line configured to establish an opening for deployment of the airbag; (b) a weakening line configured to establish an opening for deployment of the airbag. The component may comprise at least one of (a) a trim panel; (b) an instrument panel; (c) a door panel; (d) a pillar.

According to an exemplary embodiment as shown schematically in the FIGURES, a method of manufacturing a component for a vehicle interior configured to facilitate deployment of an airbag through an airbag door may comprise (a) providing a mold comprising a first surface and a second surface comprising a protrusion; (b) disposing a fiber panel comprising a first side and a second side onto the first surface of a mold; (c) compressing at least a first portion of the fiber panel between the first surface and the second surface of the mold; (d) penetrating material of the fiber panel at the first side of the panel with the protrusion of the second surface of the mold to push material of the fiber panel aside to form a recess in the first side of the fiber panel and maintain a continuous surface at the second side of the fiber panel. The fiber panel may comprise a base area and weakened area. The weakened area may comprise the recess. The recess may comprise a multi-sided profile. The multi-sided profile of the recess may comprise a bottom and a set of walls. The fiber panel may have a reduced thickness in the recess at the bottom of the profile. The profile of the recess may be configured to direct the formation of the airbag door at the weakened area of the fiber panel during deployment of the airbag through the fiber panel. The method may comprise a step of injecting resin into the mold at a depression of the second surface of the mold to form a rib. The recess may be configured to establish an opening in the vehicle interior component for deployment of an airbag through the vehicle interior component.

According to an exemplary embodiment as shown schematically in the FIGURES, a vehicle interior component formed in a mold and configured to facilitate deployment of an airbag from an airbag module may comprise a panel comprising a fiber panel. The fiber panel may comprise a base area and weakened area. The weakened area may comprise a recess. The recess may comprise a multi-sided profile. The multi-sided profile of the recess may comprise a bottom and a set of walls. The fiber panel may have a reduced thickness in the recess at the bottom of the profile. The profile of the recess may be configured to direct the formation of the airbag door at the weakened area of the fiber panel during deployment of the airbag through the fiber panel. The recess may be formed by (a) compressing at least a first portion of the fiber panel between a first surface and a second surface of the mold; (b) penetrating material of the fiber panel at the rear side with a protrusion of the mold to push material of the fiber panel aside to form the recess in the rear side and maintain a continuous surface at the front side; and (c) filling a depression of the mold with material of the fiber panel to form a protrusion at the rear side. The fiber panel may comprise at least one of (a) a resin; (b) a thermoplastic resin; (c) polypropylene; (d) acrylonitrile butadiene styrene; (e) polycarbonate. The recess may comprise a notch configured to direct deployment of the airbag through the panel. The feature may comprise a protrusion configured to provide a relief for the notch. The component may comprise a rib adjacent the notch. The rib may be configured to direct deployment of the airbag through the panel. The front side of the panel may comprise a substantially non-planar surface. The feature may comprise a rib configured to direct deployment of the airbag through the panel. The rib may be formed on the panel. The rib may comprise a resin portion comprising resin and a fiber portion comprising fibers of the panel.

According to an exemplary embodiment as shown schematically in the FIGURES, a vehicle interior component formed in a mold and configured to facilitate deployment of an airbag from an airbag module may comprise a panel comprising fibers. The panel may comprise a front side and a rear side. The panel may comprise a first portion comprising a first thickness, a second portion comprising a second thickness less than the first thickness and a third portion comprising a third thickness greater than the first thickness. The rear side of the panel may be configured to support the airbag module. The front side of the panel may be configured to provide a surface. The first portion of the panel may be separated from the second portion of the panel by the third portion of the panel. The second portion of the panel may comprise a notch formed as a depression in the rear side of the panel and configured to direct deployment of the airbag through the panel. The third portion of the panel may comprise at least one feature at the rear side of the panel adjacent the notch: The panel comprising fibers may comprise a fiber panel. The notch may be formed by (a) compressing the fiber panel in the mold; (b) penetrating material of the fiber panel at the rear side with a protrusion of the mold to push material of the fiber panel aside to form the notch in the rear side and maintain a continuous surface at the front side; and (c) filling a depression of the mold with material of the fiber panel to form a protrusion at the rear side. The fiber panel may comprise a base area and weakened area. The notch may comprise a recess. The weakened area may comprise the recess. The recess may comprise a multi-sided profile. The multi-sided profile of the recess may comprise a bottom and a set of walls. The fiber panel may have a reduced thickness in the recess at the bottom of the profile. The profile of the recess may be configured to direct the formation of the airbag door at the weakened area of the fiber panel during deployment of the airbag through the fiber panel. The first portion, the second portion and the third portion comprise a substantially constant density. The first portion, the second portion and the third portion comprise a substantially continuous surface at the front side of the panel. The third portion may extend from the second portion and/or may be adjacent the second portion. The second portion and the third portion may be formed concurrently; the third portion may be formed in response to formation of the second portion. The component may comprise a rib formed on the panel adjacent the notch.

According to an exemplary embodiment as shown schematically in the FIGURES, a method of manufacturing a vehicle interior component may comprise (a) providing a mold comprising a first surface and a second surface comprising a protrusion and a depression; (b) disposing a fiber panel comprising a first side and a second side onto the first surface of a mold; (c) compressing at least a first portion of the fiber panel between the first surface and the second surface of the mold; (d) penetrating material of the fiber panel at the first side of the panel with the protrusion of the second surface of the mold to push material of the fiber panel aside to form a notch in the first side of the fiber panel and maintain a continuous surface at the second side of the fiber panel; and (e) filling the depression of the second surface of the mold with material of the fiber panel to form a protrusion at the first side of the fiber panel. The fiber panel may comprise a base area and weakened area. The weakened area may comprise the notch. The notch may comprise a recess. The recess may comprise a multi-sided profile. The multi-sided profile of the recess may comprise a bottom and a set of walls. The fiber panel may have a reduced thickness in the recess at the bottom of the profile. The profile of the recess may be configured to direct the formation of the airbag door at the weakened area of the fiber panel during deployment of the airbag through the fiber panel. The method may comprise a step of injecting resin into the mold at the depression of the second surface of the mold to form a rib. The step of injecting resin into the mold may comprise moving material of the fiber panel toward the second surface of the fiber panel. The notch may be configured to establish an opening in the vehicle interior component for deployment of an airbag through the vehicle interior component.

As indicated schematically according to an exemplary embodiment in FIGS. 2A-2C, 3A-3B, 4A-4L, 5A-5D, 6A-6C, 9A-9B, 10C-10G, 11A-11B, 12A-12B, 13A-13C, 14A-14C, 15A-15C, 16A-16C, 17, 18A-18B, 10, 20A-20B, 21 and 34A-34B, a component for a vehicle interior configured to facilitate deployment of an airbag through an airbag door may comprise a structural substrate comprising a fiber panel; the fiber panel may comprise a base area with nominal thickness and weakened area comprising a recess formed in the fiber panel; the weakened area may comprise a reduced thickness; a profile of the weakened area/recess may comprise a shape/form such as with a bottom and a set of walls; the profile may comprise parameters such as width and thickness of material; the recess may be configured to direct the formation of the airbag door at the weakened area and to reduce visibility at the exterior of the component. Structure such as molded resin members may be provided adjacent the recess; the profile may comprise a variable shape/form (e.g. depth, width, etc.). See also FIGS. 22A-22B, 23A-23B, 24A-24D, 25A-25C, 26A-26C, 27A-27C, 28A-28B and 29A-29F. The component may comprise a trim panel, instrument panel, door panel, or pillar.

### Exemplary Embodiment-D

According to an exemplary embodiment as shown schematically in FIGS. 2B-2C, component C shown as instrument panel IP may provide a weakened shape/zone shown as a recess RS (e.g. a line, score line, cut, notch, groove, discontinuity, interruption, etc.) to facilitate an airbag AB deployment through an airbag door ABD. According to an exemplary embodiment, the weakened shape/zone may comprise at least one of a recess or a score line behind the visible surface of component C shown as instrument panel IP; as shown schematically, the weakened shape/zone may comprise an “H” shape pattern (e.g. corresponding to a door, double-door, etc. for the airbag to comprise the airbag door in the panel). According to an exemplary embodiment, the weakened shape/zone may comprise a “U” shape pattern, a “bow tie” shape pattern, or any pattern suitable for airbag deployment.

According to an exemplary embodiment as shown schematically in the FIGURES, a component C for a vehicle interior configured to facilitate deployment of an airbag may comprise a panel PL comprising fibers. Panel PL may comprise a front side providing a surface SF and a rear side configured for contact from the airbag to establish an opening for deployment of the airbag. Panel PL may comprise a recess RS formed as a depression in the rear side of panel PL to establish the opening for deployment of the airbag and direct deployment of the airbag through panel PL. The front side of panel PL may comprise a substantially continuous surface opposite recess RS. Recess RS may be formed as an indentation in the rear side of panel PL. Recess RS may be formed in a mold by compressing at least a first portion of the panel PL between a first surface and a second surface of the mold, and penetrating material of panel PL at the rear side with a protrusion PN of the mold to push material of panel PL aside to form recess RS in the rear side and maintain a continuous surface at the front side. Recess RS may comprise a generally H-shaped arrangement comprising a connector between generally parallel segments; the connector may comprise a generally sinusoidal shape. Recess RS may comprise a generally U-shaped arrangement comprising a connector between generally parallel segments; the connector may comprise a generally sinusoidal shape. Recess RS may comprise a path comprising a continuous wave portion comprising a periodic function. Recess RS may comprise a path comprising a sinusoidal shape. Panel PL may comprise at least one of a resin; a thermoplastic resin; polypropylene; acrylonitrile butadiene styrene; polycarbonate. Panel PL may comprise a rib RB adjacent recess RS at the rear side of panel PL. Rib RB may be configured to direct deployment of the airbag through panel PL. Rib RB may be formed on panel PL. Rib RB may comprise a resin material. Rib RB may extend from recess RS. Rib RB may comprise a height below the rear side of panel PL; recess RS may comprise a cavity in panel PL comprising a depth. Recess RS may comprise a path comprising a connector between generally parallel segments; the connector may comprise a generally sinusoidal shape; panel PL may comprise a rib RB adjacent the connector at the rear side of panel PL; rib RB may comprise a generally sinusoidal shape. The component may comprise a first rib on a side of the connector and a second rib on an opposite side of the connector. Rib RB may comprise a resin material and rib RB may extend from recess RS. Recess RS may comprise a cavity comprising a cross-sectional profile. The profile of the cavity may comprise a depth within panel PL. The profile of the cavity may comprise a set of facets. The set of facets may comprise a first set of connected facets opposite a second set of connected facets. The set of facets may comprise a floor facet connecting the first set of connected facets and the second set of connected facets. The floor facet may comprise a surface generally parallel to the front side of panel PL. The profile of the cavity may comprise a wall and a floor. The profile of cavity may comprise at least one angled surface connecting the wall and the floor. The floor may be generally parallel to a surface of the front side of panel PL. The wall may comprise at least two generally planar surfaces. The wall may comprise a first surface and a second surface; the second surface may extend from the floor to the first surface. The first surface may extend from the second surface to the rear side of panel PL. The wall may comprise a first generally planar wall connected to a second generally planar wall. Recess RS may comprise a width at the rear side of panel PL; the floor may comprise a width less than the width of recess RS at the rear side of panel PL. Recess RS may comprise at least one of (a) a tear line configured to establish an opening for deployment of the airbag; (b) a weakening line configured to establish an opening for deployment of the airbag. The component may comprise at least one of (a) a trim panel; (b) an instrument panel; (c) a door panel; (d) a pillar.

According to an exemplary embodiment as shown schematically in the FIGURES, a vehicle interior component C configured to facilitate deployment of an airbag from an airbag module may comprise a panel PL comprising fibers. Panel PL may comprise a structural substrate for the component. Component C may comprise a panel PL comprising a recess RS; panel PL may comprise a recess RS and a rib RB. The panel may comprise a rear side and a front/facing side and a recess RS formed in the rear side as a depression, a notch, or an indentation; the front/facing side of the panel may comprise a substantially planar surface opposite the recess on the rear side of the panel. The panel may comprise at least one of a resin, a thermoplastic resin, polypropylene, acrylonitrile butadiene styrene, polycarbonate. As shown schematically in FIGS. 3A-3B and 4A-4L, recess RS may be configured to direct deployment of an airbag through the panel. The panel may comprise a rib RB adjacent to recess RS configured to facilitate/direct deployment of the airbag through the panel (e.g. directed through an opening established by the recess in the panel). Rib RB may comprise resin.

According to an exemplary embodiment as shown schematically in FIG. 7A, a fiber mat FM may include a combination of fibers (e.g. natural and/or synthetic fibers) and thermoplastic resin (e.g. polypropylene (PP), acrylonitrile butadiene styrene (ABS), polycarbonate (PC), etc.). According to an exemplary embodiment as shown schematically in FIG. 8, fiber mat FM may be trimmed. According to an exemplary embodiment, fiber mat FM may have a thickness tFM. According to an exemplary embodiment, fiber mat MA may be heated to induce the thermoplastic resin to liquefy. According to an exemplary embodiment as shown schematically in FIG. 9A, fiber mat FM may be heated and partially compressed into a compressed fiber mat FP having a thickness tFP, which may be smaller than thickness tFM. According to an exemplary embodiment, fiber mat FM may be placed into a low-temperature mold and compression molded into a desired shape. According to an exemplary embodiment, as compressed fiber mat FM cools, the thermoplastic within fiber mat FM may solidify to establish a substantially rigid composite panel.

According to an exemplary embodiment, fiber mat FM may include a combination of structural fibers and thermoset resin (e.g. epoxy, polyester, etc.). According to an exemplary embodiment, fiber mat FM may be compressed within a heated mold to form a partially compressed fiber mat FM with a desired shape and to induce curing of the thermoset resin. According to an exemplary embodiment, a substantially rigid composite panel may be formed after the thermoset resin is cured.

According to an exemplary embodiment as shown schematically in FIG. 10A, a compressed fiber mat FM may be heated in an oven OV. As shown schematically in FIG. 10B, the hot compressed fiber mat FM may be transferred into a mold having a mold top MT and mold bottom MB. According to an exemplary embodiment as shown schematically in FIG. 5C, a panel PL may be produced by a process of compression forming or concurrent compression forming and injection molding. According to an exemplary embodiment, the heated compressed fiber mat FM may be further compressed into a fiber panel PL; plastic resin may be injected on the back side of fiber panel PL to form an ancillary feature shown as an airbag chute ABH. According to an exemplary embodiment as shown schematically in FIG. 10D, panel PL may comprise an airbag chute ABH configured to facilitate airbag deployment. According to an exemplary embodiment, airbag chute ABH may be welded to panel PL. According to an exemplary embodiment, airbag chute ABH may be injection molded on panel PL during a process comprising compression forming a mat FM into a panel PL and injection molding airbag chute ABH onto panel PL in a single tool. According to an exemplary embodiment as shown schematically in FIGS. 10D through 10G, panel PL may provide ancillary features shown as plastic reinforcements SR on the backside of panel PL to improve structural integrity and rigidity. According to an exemplary embodiment, panel PL may comprise an airbag chute ABH and/or an airbag module and/or an airbag. As shown schematically in FIGS. 10D though 10G, plastic reinforcements SR may be placed on the backside of panel PL to provide structural support for panel PL. According to an exemplary embodiment, a plastic reinforcement SR may be placed at any location on the backside of panel PL (e.g. along the edge of the panel PL, in the middle of panel PL, etc.). According to an exemplary embodiment, multiple reinforcements SR may be placed at various different locations on the backside of panel PL.

According to an exemplary embodiment, reinforcements SR may improve structural integrity of panel PL. According to an exemplary embodiment, panel PL may be able to maintain structural integrity during an airbag deployment; the position/placement of reinforcements SR may be intended to create a strength differential between different areas of panel PL; energy needed for an airbag to break through panel PL may be directed to recess RS of panel PL; reinforcements SR on the backside of panel PL may help prevent or minimize panel PL from ripping or tearing at any location other than recess RS (i.e. score line) during an airbag deployment. According to an exemplary embodiment as shown schematically in FIG. 10F, reinforcements SR on the backside of panel PL may form a honeycomb shaped pattern to improve structural integrity and rigidity. According to an exemplary embodiment, reinforcements SR may be formed in any configuration according to the specific application (e.g. ancillary features for attaching air vents, speakers or infotainment system, etc.).

According to an exemplary embodiment, panel PL may comprise a compressed fiber mat FM and a visible surface. According to an exemplary embodiment, the visible surface may include a cover, such as leather or other aesthetically-pleasing material.

According to an exemplary embodiment, panel PL may comprise a recess RS. According to an exemplary embodiment, recess RS may be configured to provide a weakened area within panel PL; the weakened area at recess RS may aid airbag deployment. As shown schematically in FIG. 5D, panel PL may have a smaller thickness at recess RS than a thickness at positions of panel PL other than at recess RS. According to an exemplary embodiment, the smaller thickness at recess RS may reduce the strength of the local area at recess RS; the strength differential between recess RS and the adjacent areas may help direct the breakthrough of an airbag towards recess RS during airbag deployment.

According to an exemplary embodiment, recess RS may comprise a cross-sectional profile. The profile of recess RS may comprise a depth within panel PL. The profile of recess RS may comprise a set of facets. The set of facets may comprise a first set of connected facets opposite a second set of connected facets. The set of facets may comprise a floor facet connecting the first set of connected facets and the second set of connected facets. The floor facet may comprise a surface generally parallel to the visible surface of panel PL. The profile of recess RS may comprise an angled surface. The profile of recess RS may comprise a multi-faceted shape. The profile of recess RS may comprise at least one of (a) a bevel; (b) a fillet; (c) a chamfer. Recess RS may comprise a wall and a floor. The profile of recess RS may comprise at least one angled surface connecting the wall and the floor. The floor may be generally parallel to the visible surface of panel PL. The wall may comprise at least two generally planar surfaces. The wall may comprise a first surface and a second surface; the second surface may extend from the floor to the first surface. The first surface may extend from the second surface to a rear surface/rear side of panel PL.

According to an exemplary embodiment, recess RS may comprise at least one of (a) a notch, (b) a recess, (c) an indentation, (d) a depression, (e) a cavity.

According to an exemplary embodiment, panel PL may provide a smooth visible surface; additional material may not be required to cover the visible surface of panel PL.

According to an exemplary embodiment, panel PL may comprise a rib RB formed on panel PL behind a visible surface of panel PL and adjacent to a recess RS. According to an exemplary embodiment, resin may be injection molded onto the backside of panel PL to form rib RB. According to an exemplary embodiment, panel PL may have a smaller thickness at recess RS than a thickness at positions on panel PL other than at recess RS. Rib RB may comprise a height greater than the thickness of panel PL.

According to an exemplary embodiment as shown schematically in FIG. 30A, a mold apparatus may comprise a mold top MT and a mold bottom MB; a compressed fiber mat FM may be placed between mold top MT and mold bottom MB. See also FIG. 30B.

According to an exemplary embodiment as shown schematically in FIGS. 30B to 30D, compressed fiber mat FM may be placed between mold top MT and mold bottom MB; at least one of mold top MT and mold bottom MB may move between an open position to a closed position; compressed fiber mat FM may be further compressed and shaped between mold top MT and mold bottom MB. According to an exemplary embodiment, compressed fiber mat FM may be heated prior to compression and forming. According to an exemplary embodiment as shown schematically in FIGS. 30A to 30D, mold top MT may include a protrusion. As compressed fiber mat FM is being further compressed, the protrusion may push material of compressed fiber mat FM aside to form a recess RS in panel PL. See FIG. 30E. According to an exemplary embodiment as shown schematically in FIG. 30E, panel PL may be formed with recess RS.

As shown schematically in FIG. 33A, a mold apparatus may comprise mold top MT and mold bottom MB; mold top MT may comprise at least one nozzle NZ to inject plastic resin into a mold cavity; a compressed fiber mat FM may be placed between mold top MT and mold bottom MB.

According to an exemplary embodiment as shown schematically in FIGS. 33A to 33C, compressed fiber mat MF may be placed between mold top MT and mold bottom MB; at least one of mold top MT and mold bottom MB may move between an open position and a closed position; compressed fiber mat FM may be further compressed between mold top MT and mold bottom MB. According to an exemplary embodiment, compressed fiber mat FM may be heated prior to compression and forming. According to an exemplary embodiment as shown schematically in FIGS. 33A to 33F, mold top MT may include a protrusion PN and at least one depression DP adjacent to protrusion PN. As compressed fiber mat FM is further compressed within the mold cavity, protrusion PN may push material of compressed fiber mat FM aside. See also FIG. 33F. According to an exemplary embodiment as shown schematically in FIG. 33D, resin RN may be injected onto the backside of panel PL through nozzle(s) NZ. According to an exemplary embodiment as shown schematically in FIG. 33E, resin RN may cure and harden. As shown schematically in FIG. 33F, panel PL may be formed with recess RS and two ribs RB adjacent to recess RS. See also FIG. 33C. According to an exemplary embodiment, the smaller thickness at recess RS may reduce the strength of the local area at recess RS; rib(s) RB may increase the strength of the local area adjacent to recess RS; the strength differential between recess RS and adjacent rib(s) RB may help direct the breakthrough energy of an airbag toward recess RS (i.e. score line) during an airbag deployment process. According to an exemplary embodiment as shown schematically in FIG. 33F, panel PL may provide a smooth visible surface; additional material may not be required to cover the visible surface of panel PL.

According to a conventional embodiment, a conventional trim panel PLx is shown schematically as a conventional instrument panel Cx/IPx in FIG. 35A. According to the conventional embodiment as shown schematically in FIG. 35B, the conventional instrument panel provides a conventional notch RSx. As shown schematically in FIG. 35B, the conventional instrument panel also provides a protrusion PRx on the visible surface of the conventional instrument panel opposite of the conventional notch. According to the conventional embodiment, additional layers of material are required to cover and hide the protrusion on the visible surface of the conventional instrument panel for aesthetic reasons (e.g. to provide a smooth visible surface in the vehicle interior).

According to an exemplary embodiment shown schematically in FIGS. 51A-51C, a composite structure CSx comprising a trim panel PLx may comprise a substrate shown as a fiber panel FPx with a conventional body of fibers FBx (e.g. without alignment/arrangement) with a conventional notch/recess RSx formed in the fibers FBx and fiber panel FPx; as indicated schematically in FIGS. 51A-51C, the recess RSx in the substrate shown as fiber panel FPx may provide a weakened area for formation of a door/opening for deployment of an airbag; as indicated schematically in FIG. 51B, the structure of the substrate shown as fiber panel FPx may be weakened unintentionally by reduction of structural strength at the area of recess RSx due generally to a lack of alignment of the fibers FBx of the fiber panel FPx. Compare FIGS. 36A-36C (composite structure with structural substrate shown as fiber panel retains structural strength at area of recess due generally to alignment of fibers of fiber panel).

### Exemplary Embodiments-E

As indicated schematically in FIGS. 2A-2C, 3B, 4A-4L, 36A-36D, 37A-37D, 38A-38B, 39, 40A-40B, 41A-41C, 42A-42C, 43A-43C, 44A-44C, 45, 46A-46B, 47, 48A-48E, 49A-49F and 50A-50B, a component for a vehicle interior configured to facilitate deployment of an airbag through an airbag door may comprise a structural substrate comprising a fiber panel comprising a body of fibers; the fiber panel may comprise a base area and weakened area for the structural substrate; the weakened area may comprise a recess comprising a profile configured to direct the formation of the airbag door in the structural substrate; the body of fibers of the fiber panel may comprise a generally aligned arrangement of fibers provided at the weakened area of the structural substrate. The generally aligned arrangement of fibers may comprise a generally laterally aligned arrangement of fibers across the weakened area of the structural substrate. The generally aligned arrangement of fibers across the weakened area is configured to enhance structural rigidity for the composite structure at the weakened area. The structural substrate of the composite structure is formed by compression forming of the fiber panel; the generally laterally aligned arrangement of fibers across the weakened area is maintained during compression forming of the fiber panel into the structural substrate of the composite structure. The fiber panel is formed from a fiber mat with the body of generally aligned fibers to provide the fiber panel with the body of generally aligned fibers; wherein the fiber panel is compression-formed into a compression-formed panel with the recess comprising a formed recess maintaining the body of generally aligned fibers in the panel; the structural substrate comprises the compression-formed panel with the recess and the body of generally aligned fibers across the compression-formed panel including at the recess to provide enhanced rigidity for the structural substrate of the composite structure.

As indicated schematically in FIGS. 2A-2C, 3B, 4A-4L, 36A-36D, 37A-37D, 38A-38B, 39, 40A-40B, 41A-41C, 42A-42C, 43A-43C, 44A-44C, 45, 46A-46B, 47, 48A-48E, 49A-49F and 50A-50B, a component may be configured to facilitate deployment of an airbag through a composite structure and/or structural substrate; the component may comprise a composite structure and/or structural substrate comprising a fiber panel comprising a base area and weakened area; the weakened area may comprise a recess comprising a profile configured to direct the formation of an opening for deployment of the airbag door; the body of fibers of the fiber panel may comprise a generally aligned/laterally aligned arrangement of fibers at/across the weakened area. The generally aligned arrangement of fibers across the weakened area is configured to enhance structural rigidity for the composite structure at the weakened area. The structural substrate of the composite structure is formed by compression forming of the fiber panel; the generally laterally aligned arrangement of fibers across the weakened area is maintained during compression forming of the fiber panel into the structural substrate. The structural substrate comprises a panel formed from a fiber panel comprising a body of fibers and comprising a weakened area shown as a recess with a profile configured to direct formation of an opening for deployment of the airbag through the component; the body of fibers comprises a generally aligned arrangement of fibers configured to provide/maintain rigidity for the structural substrate at the weakened area. The profile may comprise a variable shape/form (e.g. depth, width, etc.).

According to an exemplary embodiment as shown schematically in the FIGURES, a component for a vehicle interior may be configured to facilitate deployment of an airbag through an airbag door comprising a structural substrate comprising a fiber panel comprising a body of fibers; the fiber panel may comprise a base area and weakened area for the structural substrate; the weakened area may comprise a recess comprising a profile; the profile of the recess may comprise a bottom and a set of walls; the structural substrate may comprise a reduced thickness in the recess at the bottom of the profile; the profile of the recess may be configured to direct the formation of the airbag door at the weakened area in the structural substrate during deployment of the airbag; the body of fibers of the fiber panel comprising the structural substrate may comprise a generally aligned arrangement of fibers; the generally aligned arrangement of fibers may be provided at the weakened area of the structural substrate. The generally aligned arrangement of fibers may comprise a generally laterally aligned arrangement of fibers across the weakened area of the structural substrate of the composite structure; the generally laterally aligned arrangement of fibers across the weakened area may be configured to enhance structural rigidity for the composite structure at the weakened area of the structural substrate of the composite structure; the structural substrate of the composite structure may be formed by compression forming of the fiber panel; the generally laterally aligned arrangement of fibers across the weakened area may be maintained during compression forming of the fiber panel into the structural substrate of the composite structure; the fiber panel may be formed from a fiber mat comprising the body of generally aligned fibers to provide the fiber panel with the body of generally aligned fibers; the fiber panel may be compression-formed into a compression-formed panel with the recess comprising a formed recess maintaining the body of generally aligned fibers in the compression-formed panel; the structural substrate may comprise the compression-formed panel with the recess and the body of generally aligned fibers across the compression-formed panel including at the recess to provide enhanced rigidity for the structural substrate; the structural substrate comprising the fiber panel may comprise an inner surface and an outer surface; the recess comprising the profile may be formed into the inner surface of the fiber panel; the recess may be configured to form a seam for an opening through the weakened area of the fiber panel for the airbag door; the profile may comprise a multi-side form; the multi-side form may comprise the bottom and the set of side walls; the multi-side form may comprise a generally trapezoidal form; the profile may comprise a variable depth and a transition area; the transition area may comprise a thickness greater than a nominal thickness of the base area of the fiber panel; the structural substrate may comprise a compression-formed fiber panel; the fiber panel of the structural substrate may comprise a nominal average thickness in the base area and the reduced thickness at the weakened area; the recess for the weakened area may comprise a center recess and a set of lateral recesses; the weakened area may comprise the set of lateral recesses connected by the center recess; the center recess may comprise a connector; the weakened area may comprise a set of segments; the recess may comprise a formed recess and/or an indentation and/or a groove and/or a groove formed in the fiber panel; the profile may comprise a multi-segmented form and/or the profile may be formed to provide the weakened area in the fiber panel; the component may further comprise a structure formed on the fiber panel of the structural substrate; the structure may comprise an injection-molded resin; the structure may comprise a reinforcement at the weakened area of the fiber panel.

According to an exemplary embodiment as shown schematically in the FIGURES, a component for a vehicle interior may be configured to facilitate deployment of an airbag through an airbag door comprising a structural substrate comprising a fiber panel comprising a base area and weakened area; the weakened area may comprise a recess comprising a multi-sided profile; the multi-sided profile of the recess may comprise a bottom and a set of walls; the fiber panel may have a reduced thickness in the recess at the bottom of the profile; the profile of the recess may be configured to direct the formation of the airbag door at the weakened area of the fiber panel during deployment of the airbag through the fiber panel; the structural substrate comprising the fiber panel may comprise a body of fibers; the body of fibers of the structural substrate may comprise a generally aligned arrangement of fibers; the generally aligned arrangement of fibers may be provided at the weakened area of the structural substrate. The component may further comprise a composite structure comprising the structural substrate and a cover on the structural substrate; the weakened area may comprise a generally H-shaped area and/or a generally U-shaped area; the composite structure may comprise a structure formed onto the fiber panel; the structure may comprise an injection-molded resin; the structure may be provided adjacent to the weakened area and configured to direct the formation of the airbag door.

According to an exemplary embodiment as shown schematically in the FIGURES, a component for a vehicle interior may be configured to facilitate deployment of an airbag through an airbag door comprising a composite structure comprising a structural substrate comprising a fiber panel comprising a body of fibers; the fiber panel may comprise a base area and weakened area for the structural substrate; the weakened area may comprise a recess comprising a profile; the profile of the recess may comprise a bottom and a set of walls; the structural substrate may comprise a reduced thickness in the recess at the bottom of the profile; the profile of the recess may be configured to direct the formation of the airbag door at the weakened area in the structural substrate during deployment of the airbag; the body of fibers of the fiber panel of the structural substrate of the composite structure may comprise a generally aligned arrangement of fibers; the generally aligned arrangement of fibers may be provided at the weakened area of the structural substrate of the composite structure. The generally aligned arrangement of fibers may comprise a generally laterally aligned arrangement of fibers across the weakened area of the structural substrate of the composite structure; the generally laterally aligned arrangement of fibers across the weakened area may be configured to enhance structural rigidity for the composite structure at the weakened area of the structural substrate of the composite structure; the structural substrate of the composite structure may be formed by compression forming of the fiber panel; the generally laterally aligned arrangement of fibers across the weakened area may be maintained during compression forming of the fiber panel into the structural substrate of the composite structure; the fiber panel may be formed from a fiber mat with the body of generally aligned fibers to provide the fiber panel with the body of generally aligned fibers; the fiber panel may be compression-formed into a compression-formed panel with the recess comprising a formed recess maintaining the body of generally aligned fibers in the panel; the structural substrate may comprise the compression-formed panel with the recess and the body of generally aligned fibers across the compression-formed panel including at the recess to provide enhanced rigidity for the structural substrate; the composite structure may comprise a cover on the structural substrate; the component may further comprise a structure formed on the fiber panel of the structural substrate; the structure may comprise an injection-molded resin; the structure may comprise a reinforcement at the weakened area of the fiber panel; the set of ribs may be configured to direct the formation of the airbag door; the component may further comprise at least one of a trim panel, an instrument panel, a door panel, a pillar, a panel, etc.

According to an exemplary embodiment as shown schematically in the FIGURES, a component for a vehicle interior may be configured to facilitate deployment of an airbag through an airbag door comprising a structural substrate comprising a fiber panel and a structure comprising an injection-molded resin formed on the fiber panel; the structural substrate comprising the fiber panel may comprise a base area and a weakened area; the weakened area may comprise a recess comprising a profile; the structural substrate comprising the fiber panel may have a reduced thickness in the recess of the profile; the profile of the recess may be configured to direct the formation of the airbag door at the weakened area of the structural substrate comprising the fiber panel during deployment of the airbag; the recess of the weakened area may comprise a generally varying form formed to provide the weakened area in the structural substrate comprising the fiber panel; the structure may be provided at the weakened area of the structural substrate comprising the fiber panel and configured to direct the formation of the airbag door; the structural substrate comprising the fiber panel may comprise an inner surface and an outer surface; the recess comprising the profile may be formed into the inner surface of the fiber panel and the structure may be formed onto the inner surface of the fiber panel; the recess may comprise a transition section and a sidewall and a bottom; material of the fiber panel may comprise a body of fibers; the body of fibers of the structural substrate may comprise a generally aligned arrangement of fibers; the generally aligned arrangement of fibers may be provided at the weakened area of the structural substrate; material of the structure may comprise resin; material of the structure and material of the fiber panel form an interface comprising intermixing of material of the structure with material of the fiber panel; forming of the structure on the fiber panel may comprise irregularities at the interface; irregularities at the interface may comprise intermixing of fibers of the fiber panel into resin of the structure at the interface. The structure may comprise a framework comprising a reinforcement formed on the fiber panel; the recess comprising the profile may be formed into the inner surface of the fiber panel as the structure comprising the set of ribs may be formed onto the inner surface of the fiber panel; the recess may be configured to form a seam for an opening through the weakened area of the fiber panel for the airbag door; the profile may comprise a curved form; injection-molded resin of the structure comprising injection-molded resin may be configured to mix with fibers of the fiber panel; injection-molded resin of the structure comprising injection-molded resin may be formed into the fiber panel; the profile may comprise a variable depth; the profile may comprise a transition area at the transition section of the recess; the transition area may comprise a thickness less than a nominal thickness of the base area of the fiber panel; the fiber panel may have a nominal average thickness in the base area and the reduced thickness at the weakened area; the recess for the weakened area may comprise a center recess; the weakened area may comprise the recess between the set of ribs comprising the structure comprising injection-molded resin on the fiber panel; the recess may comprise a formed recess and/or an indentation; the recess may comprise a groove; the groove may be formed in the fiber panel; the generally varying form of the recess of the weakened area of the fiber panel may comprise a wavy line; the set of ribs at the weakened area of the fiber panel may comprise a generally varying form comprising a wavy line; the weakened area may comprise a generally H-shaped area and/or a generally U-shaped area.

According to an exemplary embodiment as shown schematically in the FIGURES, a component for a vehicle interior may be configured to facilitate deployment of an airbag through an airbag door comprising a fiber panel comprising a base area and a weakened area, and a structure formed on the fiber panel; the structure may comprise a molded resin; the weakened area may comprise a recess; the fiber panel may have a reduced thickness in the recess at the bottom of the profile; the profile of the recess may be configured to direct the formation of the airbag door at the weakened area of the fiber panel during deployment of the airbag through the fiber panel; the recess of the weakened area may comprise a generally varying form formed to provide the weakened area in the fiber panel; the structure may comprise a set of ribs at the weakened area of the fiber panel configured to direct the formation of the airbag door; the fiber panel may comprise an inner surface and an outer surface; the recess comprising the profile may be formed into the inner surface of the fiber panel and the structure comprising the set of ribs may be formed onto the inner surface of the fiber panel; material of the fiber panel may comprise a body of fibers; the body of fibers of the fiber panel may comprise a generally aligned arrangement of fibers; the generally aligned arrangement of fibers may be provided at the weakened area of the fiber panel; material of the structure may comprise resin; material of the structure and material of the fiber panel form an interface comprising intermixing of material of the structure with material of the fiber panel; forming of the structure on the fiber panel may comprise irregularities at the interface; irregularities at the interface may comprise intermixing of fibers of the fiber panel into resin of the structure at the interface. The component may further comprise a cover on the fiber panel; the structure may comprise an injection-molded resin; the set of ribs at the weakened area of the fiber panel may comprise the varying form of the recess of the weakened area of the fiber panel; the component may further comprise a structure formed on the fiber panel; the structure may comprise an injection-molded resin; the structure may comprise a set of ribs at the weakened area of the fiber panel; the set of ribs may be configured to direct the formation of the airbag door.

TABLE B
REFERENCE SYMBOL LIST

| | REFERENCE |
|---|---|
| ELEMENT, PART OR COMPONENT | SYMBOL |
| Vehicle | V |
| Interior | I |
| Component | C |
| Instrument Panel | IP |
| Door panel | DP |
| Steering Wheel | SW |
| Floor Console | FC |
| Component | C |
| Airbag | AB |
| Airbag Door | ABD |
| Airbag Chute | ABH |
| Panel | PL |
| Fiber Panel | FP |
| Fiber Mat | FM |
| Cover | T |
| Exterior Surface | SF |
| Recess | RS |
| (weakened area having shape (e.g. H-shape/U-shape) | |
| and profile shown as depth/width, recess, groove, indentation, etc.) | |
| Bottom of recess (e.g. flat, curved, etc.) | RT |
| Curved form recess/curvature of recess | RC |
| Sidewall of recess (e.g. wall/area adjacent to bottom of recess) | RW |
| Transition section of recess | RX |
| (section/area from base area of panel into recess) | |
| Gap (along panel from recess to structure/rib) | RG |
| Ridge (e.g. segment formed in panel adjacent to recess) | RZ |
| Structure (e.g. resin/molded structure formed on panel) | SR |
| Rib (e.g. resin/molded rib, member, etc. of structure) | RB |
| Resin | RN |
| Mold/tool top | MT |
| Mold/tool bottom | MB |
| Projection/forming tool | PN |
| Oven | OV |
| Projection (with visible imperfection at surface) | PRx |
| (component Cx with panel PLx with recess RSx) | |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior configured to facilitate deployment of an airbag through an airbag door comprising:
a structural substrate comprising a fiber panel comprising a body of fibers;
wherein the fiber panel comprises a base area and weakened area for the structural substrate;
wherein the weakened area comprises a recess comprising a profile;
wherein the profile of the recess comprises a bottom and a set of walls;
wherein the structural substrate comprises a reduced thickness in the recess at the bottom of the profile;
wherein the profile of the recess is configured to direct the formation of the airbag door at the weakened area in the structural substrate during deployment of the airbag;
wherein the body of fibers of the fiber panel comprising the structural substrate comprises a generally aligned arrangement of fibers;
wherein the generally aligned arrangement of fibers is provided at the weakened area of the structural substrate.

2. The component of claim 1 wherein the generally aligned arrangement of fibers comprises a generally laterally aligned arrangement of fibers across the weakened area of the structural substrate of the composite structure.

3. The component of claim 1 wherein the generally laterally aligned arrangement of fibers across the weakened area is configured to enhance structural rigidity for the composite structure at the weakened area of the structural substrate of the composite structure.

4. The component of claim 1 wherein the structural substrate of the composite structure is formed by compression forming of the fiber panel; wherein the generally laterally aligned arrangement of fibers across the weakened area is maintained during compression forming of the fiber panel into the structural substrate of the composite structure.

5. The component of claim 1 wherein the fiber panel is formed from a fiber mat comprising the body of generally aligned fibers to provide the fiber panel with the body of generally aligned fibers; wherein the fiber panel is compression-formed into a compression-formed panel with the recess comprising a formed recess maintaining the body of generally aligned fibers in the compression-formed panel; wherein the structural substrate comprises the compression-formed panel with the recess and the body of generally aligned fibers across the compression-formed panel including at the recess to provide enhanced rigidity for the structural substrate.

6. The component of claim 1 wherein the structural substrate comprising the fiber panel comprises an inner surface and an outer surface; wherein the recess comprising the profile is formed into the inner surface of the fiber panel; wherein the recess is configured to form a seam for an opening through the weakened area of the fiber panel for the airbag door.

7. The component of claim 1 wherein the profile comprises a multi-side form; wherein the multi-side form comprises the bottom and the set of side walls.

8. The component of claim 7 wherein the multi-side form comprises a generally trapezoidal form.

9. The component of claim 1 wherein the profile comprises a variable depth and a transition area.

10. The component of claim 9 wherein the transition area comprises a thickness greater than a nominal thickness of the base area of the fiber panel.

11. The component of claim 1 wherein the structural substrate comprises a compression-formed fiber panel; wherein the fiber panel of the structural substrate comprises a nominal average thickness in the base area and the reduced thickness at the weakened area.

12. The component of claim 1 wherein the recess for the weakened area comprises a center recess and a set of lateral recesses; wherein the weakened area comprises the set of lateral recesses connected by the center recess; wherein the center recess comprises a connector.

13. The component of claim 1 wherein the weakened area comprises a set of segments.

14. The component of claim 1 wherein the recess comprises a formed recess and/or an indentation and/or a groove and/or a groove formed in the fiber panel.

15. The component of claim 1 wherein the profile comprises a multi-segmented form and/or wherein the profile is formed to provide the weakened area in the fiber panel.

16. The component of claim 1 further comprising a structure formed on the fiber panel of the structural substrate; wherein the structure comprises an injection-molded resin; wherein the structure comprises a reinforcement at the weakened area of the fiber panel.

17. A component for a vehicle interior configured to facilitate deployment of an airbag through an airbag door comprising:
a structural substrate comprising a fiber panel comprising a base area and weakened area;
wherein the weakened area comprises a recess comprising a multi-sided profile;
wherein the multi-sided profile of the recess comprises a bottom and a set of walls;
wherein the fiber panel has a reduced thickness in the recess at the bottom of the profile;
wherein the profile of the recess is configured to direct the formation of the airbag door at the weakened area of the fiber panel during deployment of the airbag through the fiber panel wherein the structural substrate comprising the fiber panel comprises a body of fibers;
wherein the body of fibers of the structural substrate comprises a generally aligned arrangement of fibers;
wherein the generally aligned arrangement of fibers is provided at the weakened area of the structural substrate.

18. The component of claim 17 further comprising a composite structure comprising the structural substrate and a cover on the structural substrate.

19. The component of claim 1 wherein the weakened area comprises a generally H-shaped area and/or a generally U-shaped area.

20. The component of claim 17 wherein the composite structure comprises a structure formed onto the fiber panel; wherein the structure comprises an injection-molded resin; wherein the structure is provided adjacent to the weakened area and configured to direct the formation of the airbag door.
